(19) United States
(12) Patent Application Publication
(10) Pub. No.: US 2015/0178861 A1
(43) Pub. Date: Jun. 25, 2015

(54) Systems and Methods for Quantitative Evaluation of a Property for Renovation

(71) Applicant: Homer TLC, Inc., Wilmington, DE (US)

(72) Inventors: John Gordon, Atlanta, GA (US); Jeff Krueger, Tampa, FL (US); Peter Slade, Tampa, FL (US)

(21) Appl. No.: 14/136,616

(22) Filed: Dec. 20, 2013

(51) Int. Cl. G06Q 50/08; G06Q 10/10

(52) U.S. Cl. CPC G06Q 50/08; G06Q 10/103

(57) ABSTRACT

This disclosure includes devices, systems, and methods for identifying and tracking products to be obtained and/or tasks to be performed for a structure (e.g., for repair and/or remodeling of the structure). For example, some embodiments of the present portable computing devices comprise: a processor; an input device; a display and memory storing instructions executable by the processor to: present via the display an input interface having a plurality of input portions each associated with a different portion of a structure; receive via the input device user selections of products that are available form a supplier, at least some of the selected products each associated with a different portion of the structure; and generate an output of information associated with the selected products, the output including for each of the selected products a unique identifier corresponding to a product record of the supplier. Some embodiments of the present systems comprise: an embodiment of the present devices; and a server configured to communicate with the device, the server comprising: a processor; and memory storing instructions executable by the processor to: receive user selections of at least one of: portions of a structure with which input portions are associated on the device; products that are available for selection on the device; and indications of labor costs associated with at least some of the products that are available for selection on the device.

### FIELD OF INVENTION

This disclosure relates generally to computer-based systems and methods for identifying and tracking products available from a supplier and, more particularly, but not by way of limitation, to computer-integrated methods and systems for identifying and tracking products needed for renovation of structures.

### BACKGROUND

A subset of property investors (individuals or companies owned by individuals) focus on purchasing residential dwellings for the purpose of generating investment income. The typical process of such property investors involves (a) obtaining investment capital, (b) finding and purchasing a property at a reasonable cost, (c) renovating the property, and (d) selling or renting the renovated property.

Property renovation can be a complex process involving the evaluation of certain areas of the property, the determination of the type of renovation needed, the identification of goods and amount of labor needed to complete the renovation, and the determination of cost of the renovation relative to a given budget. An individual may use a notepad, a writing implement, and a camera to walk through the property. After taking notes and photographs of the property, the individual may visit multiple home improvement stores to see the available inventory of goods and current pricing. The individual can then estimate a cost of the renovation and compare it to his or her budget. This process can be extremely inconsistent across different properties and time-consuming, even when performed by the same individual.

### SUMMARY

This disclosure includes embodiments of devices, systems, and methods for facilitating the evaluation of a property for renovation and/or repair. Some embodiments of the present systems include an end-user application and a back-end application (e.g., on a server configured to communicate with the portable computing device). The end-user application may, for example, be executed on a mobile or portable computing device configured to communicate with the server. The back-end application may, for example, be executed on server that is configured to communicate with the portable computing device (e.g., via the Internet and/or a cellular telephone network).

In some embodiments, the end-user application is configured to assist a user with a process for “walking” an investment property to identify and track desired renovation and/or repair activities and/or estimate the amount of money required to perform such activities (e.g., including product and/or labor costs). The end-user application can, for example, be configured to provide a list of groups or portions of a structure (structure portions) that the user may traverse and/or evaluate while walking the property, such as, for example, Exterior, Paint, Garage, HVAC, Kitchen, and Bedroom. Groups may also include or refer to portions of a property (e.g., plot of land) other than a primary structure. For example, there could be a Group for “Landscaping” or “Fencing.” These groups or structure portions may be organized in a particular sequence to facilitate or indicate to a user a desirable order in which to evaluate each group. Each group may include or be associated with multiple items (e.g., tasks or product categories) each of which may include or be associated with multiple products. For example, a Kitchen group may include product groups of: Interior Doors, Door Hardware, Kitchen Sink, Kitchen Plumbing, Kitchen Faucets, and/or the like. As with the groups, items or product categories may be organized in a particular sequence to facilitate or indicate to a user a desirable order in which to evaluate each group.

In one example for certain embodiments, when a user begins to walk an investment property, the user accesses the list of groups or structure portions. For example, the user can click on each group to access a list of items or tasks/product categories associated with a group, and then can click on each item to access a list of products associated with the item or product category. Each product in the list of products may, for example, include an image of the product, a description of the product, and/or a price of the product. The user can enter a quantity to purchase for each product. When the user is finished, the user can cause the end-user application to send the order to an office or supervisor for approval and/or to send the order directly to a supplier (e.g., a preferred or selected store or location of the supplier) for fulfillment.

In some embodiments, the availability and price of products can be provided via a substantially real-time data feed of a store or the supplier that is selected by the user or supervisor. In some embodiments, the data feed of product information can be downloaded onto the mobile computing device prior to the user walking the property (the property walk). In this way, the user can walk the property and access current availability and pricing information for selected products even without an Internet connection that is active during the property walk. Additionally, the list of products seen by (displayed to) a user can be controlled by an administrator to ensure specified products are used for each renovation.

In some embodiments, the end-user application is configured to keep a running total of the estimated costs of selected products and/or to compare the total against a pre-defined budget. The running total for the products may also be associated with a running total for labor (e.g., estimated labor costs associated with some or all of the selected products). Estimated labor costs (e.g., in time and/or dollars) may, for example, be entered using the “Back End” application. In some embodiments, for example, (1) a user can enter a number of hours of labor associated with each of at least some of the available products (e.g., 1 hour to install a toilet), and the end-user application can then compute the estimated labor cost based on a pre-defined labor rate ($60 per hour); and/or (2) a user can enter an estimated labor dollar cost associated with each of at least some of the available products (e.g., $60 to install a toilet).

In some embodiments, the end-user application can include various tools, such as, for example: a compass, a calculator, a level, and/or a roof pitch estimator. For example, a graphical roof pitch estimator can use a camera (e.g., rear-facing camera) of the mobile computing device and provides multiple pre-determined roof pitch overlays through an augmented reality function. The user can hold up the mobile computing device to the front of the property and identify the roof pitch overlay that most closely matches the pitch of the roof in an image captured by the camera.

In some embodiments, the back-end application may be a web-based application hosted by a server and accessible by a user via a web browser. The end-user application may also communicate with the back-end application (e.g., such that the back-end application controls or determines the groups, items, products, and/or orders of display available to a user of the end-user application) such as, for example, via a data connection between the front-end application (portable computing device) to the back-end application (server). In some embodiments, an end-user may have permission to access and modify settings in the back-end application. In other embodiments, end-users may be restricted from modifying and/or accessing settings in the back-end application. For example, a supervisor may have permission to access and modify settings in the back-end application, but an end user's permission may be limited to the end-user application such that the end user is cannot access or modify settings in the back-end application.

In some embodiments, the back-end application can control various features of the end-user application. For example, an administrator (user with administrative permissions, e.g., a supervisor) can use the back-end application to define the groups or structure portions, items or product categories, and/or products that are available to a user of the end-user application. In some embodiments, an administrator can also use the back-end application to define a process flow, which can include a sequence in which groups and/or items are presented to a user of the end-user application (e.g., a sequence that should be followed by the end user when walking a property).

In some embodiments, the back-end application can include a stock-keeping unit (SKU) validation tool, a bulk load tool, a SKU export tool, and a product catalog tool. For example, the SKU validation tool can be used to compare a list of SKUs that are available from one store (e.g., Atlanta, Ga.) against SKUs available from a second store (e.g., Charlotte, N.C.), and generate an exception report showing SKU numbers, description, and images of products that are not available from the second store. As discussed above, the back-end application can be configured to allow an administrator to customize the products that are shown for each item in the end-user application. The administrator can enter each product by SKU number manually or can upload a list of SKU numbers with the bulk load tool. The SKU export tool can be configured to generate a CSV file of the SKUs of the current list of products. The administrator can also use the product catalog tool to create a product catalog of the current products. In some embodiments, the back-end application can also be configured to receive and manage estimated labor hours and/or dollars such that estimated labor costs can be included in the calculations performed by the end-user application.

Embodiments of the present methods include the performance of various functions of the present end-user applications and/or back-end applications and described in this disclosure with reference to the implementation of the present devices and systems.

Some embodiments of the present devices comprise: a processor; an input device; a display; and memory storing an end-user application having instructions executable by the processor to: present via the display an input interface having a plurality of input portions each associated with a different portion of a structure; receive via the input device user selections of products from among available products that are available from a supplier, at least some of the available products associated with a portion of the structure; and generate an compilation of information associated with the selected products, the compilation including for each of the selected products a unique identifier corresponding to a product record of the supplier. In some embodiments, the instructions of the end-user application are further executable by the processor to: receive indications of labor costs and/or time associated with at least some of the products. In some embodiments, the instructions of the end-user application are further executable by the processor to: receive indications of labor costs and/or time associated with at least one task that can be performed on a portion of the structure.

In some embodiments of the present devices, the instructions of the end-user application are further executable by the processor to: receive in substantially real-time from a system of the supplier product information about each of the available products. In some embodiments, the product information includes for each of the available products two or more of: current availability from a selected location of the supplier, price, description, and/or an image associated with the product. In some embodiments, the instructions of the end-user application are further executable by the processor to: save the product information to the memory such that the processor can access the saved product information in the absence of a data connection to the system of the supplier.

In some embodiments of the present devices, the instructions of the end-user application are further executable by the processor to: receive via the input device a user selection of an input portion; and present via the display one or more product categories associated with the selected input portion. In some embodiments, the instructions of the end-user application are further executable by the processor to: receive via the input device a user selection of a product category associated with the selected input portion; and present via the display one or more of the available products that are associated with the selected product category.

In some embodiments of the present devices, the instructions of the end-user application are further executable by the processor to: receive via the input device a list of available products that are available from a single location of the supplier at the time the list is received. In some embodiments, the single location of the supplier includes a single location that is selected by a user or that is closest to the location of the structure. In some embodiments, the instructions of the end-user application are further executable by the processor to: transmit the compilation to the supplier.

Some embodiments of the present devices further comprise: a camera coupled to the processor; where the instructions of the end-user application are further executable by the processor to: receive a signal from the camera indicative of an image; present via the display the image; and present via the display simultaneously with the image one or more lines angled to correspond to possible roof pitches such that a user can identify the line most closely corresponding to the pitch of a roof, if any, depicted in the image.

Some embodiments of the present systems comprise: a first one of the present devices; and a server configured to communicate with the device, the server comprising: a processor; and memory storing a back-end application with instructions executable by the processor to: receive user selections of at least one of: portions of a structure with which input portions are associated on the device; available products that can be selected on the device from among the products that are available from a supplier; and/or indications of labor time and/or costs associated with at least some of the available products that can be selected on the device.

In some embodiments of the present systems, the instructions of the back-end application are further executable by the processor to: receive user selections of at least one of: associations of product categories with input portions; and/or associations of available products with product categories. In some embodiments, the instructions of the back-end application are further executable by the processor to: receive user selections of at least one of: the order in which input portions are presented in the input interface on the device; the order in which product categories associated with an input portion are presented in the input portion on the device; and/or the order in which available products associated with a product category are presented in the product category on the device.

In some embodiments of the present systems, a first user profile is authorized to modify user selections via the server, and a second user profile is authorized to modify user selections via the device but not via the server. Some embodiments of the present devices further comprise: a second one of the present devices; where user selections received by the server control the end-user applications of the first device and the second device.

In some embodiments of the present systems, the instructions of the back-end application are further executable by the processor to: receive indications of labor costs and/or time associated with at least one task that can be performed on a portion of the structure. In some embodiments, the instructions of the back-end application are further executable by the processor to: receive at least one of: an indication of a discount associated with a category of products; an indication of a discount associated with an individual product; and/or an indication of a custom price associated with an individual product.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), “include” (and any form of include, such as “includes” and “including”), and “contain” (and any form of contain, such as “contains” and “containing”) are open-ended linking verbs. As a result, an apparatus that “comprises,” “has,” “includes,” or “contains” one or more elements possesses those one or more elements, but is not limited to possessing only those elements. Likewise, a method that “comprises,” “has,” “includes,” or “contains” one or more steps possesses those one or more steps, but is not limited to possessing only those one or more steps.

Any embodiment of any of the apparatuses, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Details associated with the embodiments described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 is a schematic block diagram illustrating one of the present systems.

FIG. 2 is a schematic block diagram illustrating a database suitable for use in some of the present systems.

FIG. 3A is a schematic block diagram illustrating one embodiment of a computer suitable for use with or in at least some of the present systems.

FIG. 3B is a perspective view of a portable computing device suitable for use with or in at least some of the present systems and methods.

FIGS. 4-7 depict flowcharts conceptually illustrating an example of the function and use of one embodiment of the present systems.

FIG. 8 depicts a home screen of one embodiment of the present systems that can be presented to a user via the display of the device of FIG. 3B.

FIGS. 9A-9B depict a profile-management screen of one embodiment of the present systems that can be presented to a user via the display of the device of FIG. 3B.

FIGS. 10A-10B depict a profile-editing screen for a detailed walk flow of one embodiment of the present systems that can be presented to a user via the display of the device of FIG. 3B.

FIGS. 11A-11F depict a property-management screen of one embodiment of the present systems that can be presented to a user via the display of the device of FIG. 3B.

FIGS. 12A-12E depict a property-editing screen of one embodiment of the present systems that can be presented to a user via the display of the device of FIG. 3B.

FIGS. 13A-13E depict certain tool screens of one embodiment of the present systems that can be presented to a user via the display of the device of FIG. 3B.

FIGS. 14A-14B depict a photo-management screen of one embodiment of the present systems that can be presented to a user via the display of the device of FIG. 3B.

FIGS. 15A-15C depict a photo-editing screen of one embodiment of the present systems that can be presented to a user via the display of the device of FIG. 3B.

FIGS. 16A-16P depict various product-selection screens for a detailed walk flow of one embodiment of the present systems that can be presented to a user via the display of the device of FIG. 3B.

FIGS. 17A-17B depict a materials-list screen of one embodiment of the present systems that can be presented to a user via the display of the device of FIG. 3B.

FIGS. 18A-18B depict quote-submission features of the materials-list screen of FIGS. 17A-17B.

FIGS. 19A-19K depict profile-editing screens for a streamlined walk flow of one embodiment of the present systems that can be presented to a user via the display of the device of FIG. 3B.

FIGS. 20A-20M depict product-selection screens for the streamlined walk flow of one embodiment of the present systems that can be presented to a user via the display of the device of FIG. 3B.

FIGS. 21A-21E depict a materials-list screen for the streamlined walk flow of one embodiment of the present systems that can be presented to a user via the display of the device of FIG. 3B.

FIG. 22 depicts a homepage of a website through which a back-end application of the present systems can be accessed by a user via a computer of FIG. 3A or a device of FIG. 3B.

FIGS. 23A-23E depict utility webpages of a website through which back-end application settings of the present systems can be adjusted by a user via a computer of FIG. 3A or a device of FIG. 3B.

FIGS. 24A-24B depict an item or product webpage of a website through which back-end application settings of the present systems can be adjusted by a user via a computer of FIG. 3A or a device of FIG. 3B.

FIGS. 25A-25B depict a group or structure-portion webpage of a website through which back-end application settings of the present systems can be adjusted by a user via a computer of FIG. 3A or a device of FIG. 3B.

FIGS. 26A-26C depict a walk flow webpage of a website through which back-end application settings of the present systems can be adjusted by a user via a computer of FIG. 3A or a device of FIG. 3B.

FIGS. 27A-27E depict a discount webpage of a website through which back-end application settings of the present systems can be adjusted by a system-administrator user via a computer of FIG. 3A or a device of FIG. 3B.

FIGS. 28A-28B depict an office webpage of a website through which back-end application settings of the present systems can be adjusted by a system-administrator user via a computer of FIG. 3A or a device of FIG. 3B.

### DESCRIPTION OF ILLUSTRATIVE EMBODIMENTS

Various features and advantageous details are explained more fully with reference to the non-limiting embodiments that are illustrated in the accompanying drawings and detailed in the following description. Descriptions of well-known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Certain units described in this specification have been labeled as modules in order to more particularly emphasize their implementation independence. A module is “[a] self-contained hardware or software component that interacts with a larger system.” Alan Freedman, “The Computer Glossary” 268 (8th ed. 1998). A module comprises a machine- or machines-executable instructions. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also include software-defined units or instructions, that when executed by a processing machine or device, transform data stored on a data storage device from a first state to a second state. An identified module of executable code may, for instance, comprise one or more physical or logical blocks of computer instructions that may be organized as an object, procedure, or function. Nevertheless, the executables of an identified module need not be physically located together, but may comprise disparate instructions stored in different locations that, when joined logically together, comprise the module, and when executed by the processor, achieve the stated data transformation. A module of executable code may be a single instruction, or many instructions, and may even be distributed over several different code segments, among different programs, and/or across several memory devices. Similarly, operational data may be identified and illustrated herein within modules, and may be embodied in any suitable form and organized within any suitable type of data structure. The operational data may be collected as a single data set, or may be distributed over different locations including over different storage devices.

In the following description, numerous specific details are provided, such as examples of programming, software modules, user selections, network transactions, database queries, database structures, hardware modules, hardware circuits, hardware chips, etc., to provide a thorough understanding of the present embodiments. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

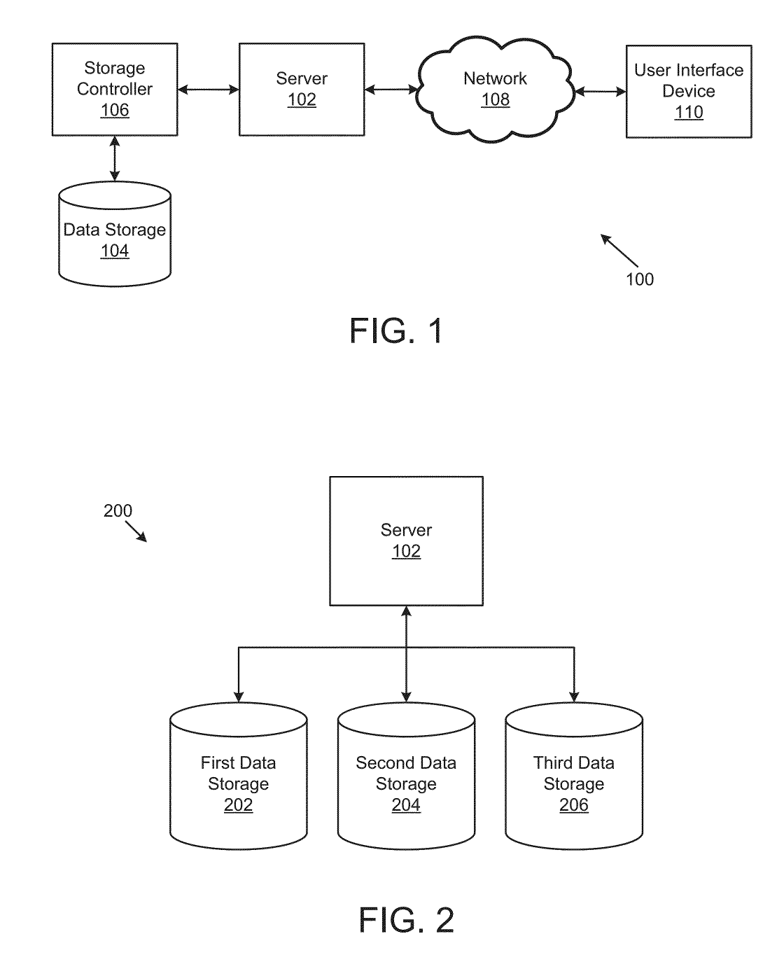

FIG. 1 illustrates one embodiment of a system 100 for identifying and/or tracking products to be obtained and/or tasks to be performed for a structure (e.g., for repair and/or remodeling of the structure). System 100 may include a server 102, a data storage device 104, a network 108, and a user interface device 110. In some embodiments, server 102 may include storage device 104 (e.g., a server housing or enclosure may house storage device 104). In some embodiments, system 100 may include a storage controller 106, and/or a storage server configured to manage data communications between data storage device 104 and server 102 and/or other components in communication with network 108. In some embodiments, storage controller 106 may be coupled to network 108 (e.g., such that server 102 communicates or is configured to communicate with storage controller 106 and/or storage device 104 via network 108). In a general embodiment, system 100 may be configured to store data (e.g., user profiles, properties or structures, groups or portions of structures, items or product categories, available products, tasks, and/or flows (orders of display for groups, items, products, and/or tasks)) with which products to be obtained and/or tasks to be performed for a structure (e.g., for repair and/or remodeling of the structure) can be identified and/or tracked. In some embodiments, system 100 is configured to permit multiple uses and/or functions to or with the data from which the products and/or tasks can be identified and/or tracked. For example, in some embodiments, system 100 is configured to present to a user a plurality of input portions each associated with a different portion of a structure; receive user selections of products from among available products that are available from a supplier, at least some of the available products associated with a portion of the structure; and generate a compilation of information associated with the selected products, the compilation including for each of the selected products a unique identifier corresponding to a product record of the supplier.

In some embodiments, server 102 is configured to access data stored in data storage device(s) 104 via a Storage Area Network (SAN) connection, a LAN, a data bus, or the like. Data storage device 104 may include a hard disk, including hard disks arranged in an Redundant Array of Independent Disks (RAID) array, a tape storage drive comprising a magnetic tape data storage device, an optical storage device, or the like. In one embodiment, data storage device 104 stores product data including, for example, custom data, as described in more detail below. In some embodiments, server 102 and/or storage device(s) 104 are configured to create a back-up (full and/or partial back-up) of the data of system 100, such as, for example, periodically and/or responsive to an instruction from a system administrator to back-up data on the system.

In some embodiments, user-interface device 110 is referred to broadly and comprises a suitable processor-based device such as, for example, a desktop computer, a laptop computer, a Personal Digital Assistant (PDA), and/or a mobile communication or organizer device (e.g., a cellular phone, smartphone, etc.) having access to the network 108. In some embodiments, user interface device 110 can be configured to access the Internet to access a web application or web service hosted by server 102 and thereby provide a user interface for enabling a user to enter or receive information (e.g., from server 102). For example, a user may receive or view, via user interface device 110, a webpage including a group of products, a subset of a group of products, and/or a subset of possible product pairs in the group of products. By way of further example, in some embodiments, user interface device 110 can be configured to receive from a user (e.g., via user-input device, such as a keyboard, mouse, touchscreen, and/or the like), can be configured to prompt a user for (e.g., server 102 can be configured to instruct user-interface device 110 to prompt a user for), and/or can be configured to transmit to server 102 (e.g., via network 108), user inputs related to: groups; items; available products; flows (order of presentation) of groups, items, and/or available products; and/or products selected from among the available products.

Network 108 may facilitate communications of data between server 102 and user interface device 110. Network 108 may include any type of communications network including, but not limited to, a direct PC to PC connection, a local area network (LAN), a wide area network (WAN), a modem to modem connection, the Internet, a combination of the above, or any other communications network now known or later developed within the networking arts which permits two or more computers to communicate, one with another.

In some embodiments, system 100 comprises: one or more electronic storage devices 104 configured to, for a plurality of SKUs or products: store product information (e.g., current availability from a selected location of the supplier, price, description, and/or an image associated with the product). For example, in some embodiments, server 100 can be configured to permit a user to enter inputs (e.g., manually via a web browser running on a user interface device 110) of product information associated with available products. For example, as in the embodiments described below, system 100 can (e.g., via a web browser) receive an individual SKU associated with an available product and/or receive a batch of multiple SKUs each related to different available products.

FIG. 2 illustrates one embodiment of a data management system 200 configured to store and manage data for identifying and tracking products and tasks. In one embodiment, the system 200 may include a server 102. The server 102 may be coupled to a data-bus that may, for example, communicate with one or more data storage devices. In one embodiment, the system 200 may also include a first data storage device 202, a second data storage device 204 and/or a third data storage device 206. In further embodiments, the system 200 may include additional data storage devices (not shown). In such an embodiment, each data storage device 202-206 may host a separate database of products including, for example, product type (e.g., hammer), sub-type (e.g., tack), product attributes (e.g., head weight), and/or other data related to the product(s). In some embodiments, each of storage devices 202-206 can store or be configured to store data associated with a different classes of products or subsets of product-related data (e.g., storage device 202 storing data associated with a first class of products (e.g., tools), storage device 204 storing data for a second class of products (e.g., hardware), storage device 206 storing data for a third class of products (e.g., fixtures), etc.; or, storage device 202 storing a first type of data, such as SKUs associated with all products, storage device 204 storing data associated with or indicative of product attributes for the product SKUs stored in storage device 202, storage device 206 storing data associated with user profiles, properties, products, and/or tasks), etc. In some embodiments, storage devices 202-206 may be arranged in a RAID configuration for storing redundant copies of a database or databases (e.g., through synchronous or asynchronous redundancy updates).

In various embodiments, server 102 may communicate with data storage devices 204-210 over a data-bus (illustrated by arrows between server 102 and storage devices 202-206). In such embodiments, the data-bus may comprise a SAN, a LAN, or the like. The communication infrastructure may include Ethernet, Fibre-Channel Arbitrated Loop (FC-AL), Small Computer System Interface (SCSI), and/or other similar data communication schemes associated with data storage and communication. For example, server 102 may communicate indirectly with data storage devices 202-206 (e.g., via a storage server or storage controller 106), cloud storage servers, and/or Virtual machines.

Server 102 may host one or more software applications (e.g., web- and/or Internet-accessible software applications) configured for (e.g., network-based) access to and/or modification of the data and/or executables (e.g., for implementing the methods) described in this disclosure. The software application may further include modules configured to interface with data storage devices 202-206, network 108, a user (e.g., via a user-interface device 110), and/or the like. In a further embodiment, server 102 may host an engine, application plug-in, or application programming interface (API). In another embodiment, server 102 may host a web service and/or other web accessible software application.

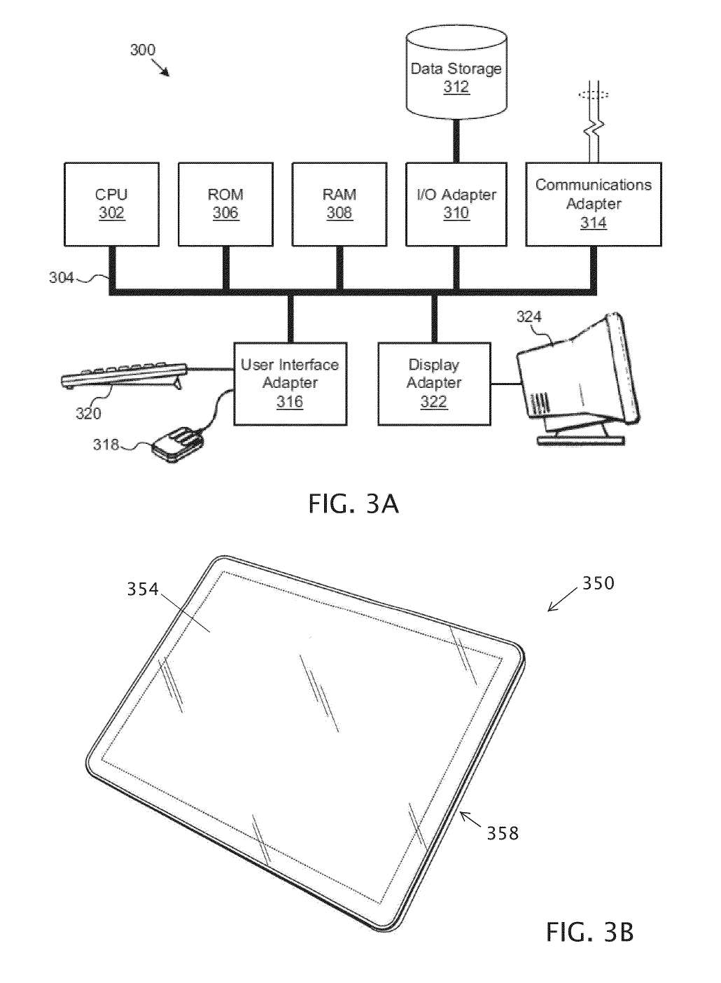

FIG. 3A illustrates a computer system 300 adapted according to certain embodiments of server 102 and/or user interface device 110. Central processing unit (CPU) 302 is coupled to system bus 304. CPU 302 may be a general purpose CPU or microprocessor. The present embodiments are not restricted by the architecture of CPU 302, as long as CPU 302 supports the modules, configurations, and/or operations as described herein. CPU 302 may execute the various logical instructions according to the present embodiments. For example, CPU 302 may execute machine-level instructions according to the exemplary operations described below.

Computer system 300 also may include Random Access Memory (RAM) 308, which may be SRAM, DRAM, SDRAM, or the like. Computer system 300 may utilize RAM 308 to store the various data structures used by a software application configured for identifying and/or tracking products and/or tasks. Computer system 300 may also include Read Only Memory (ROM) 306 which may be PROM, EPROM, EEPROM, optical storage, or the like. ROM 306 may store configuration information for booting computer system 300. RAM 308 and ROM 306 may also store user and/or system 100 data.

Computer system 300 may also include an input/output (I/O) adapter 310, a communications adapter 314, a user interface adapter 316, and a display adapter 322. I/O adapter 310, communications adapter 314, and/or user interface adapter 316 may, in some embodiments, enable or a user to interact with computer system 300 (e.g., to input information for example, to access, identify, and/or modify data associated with user profiles, properties or structures, groups or portions of structures, items or product categories, available products, tasks, and/or flows (orders of display for groups, items, products, and/or tasks). In a further embodiment, display adapter 322 may display a graphical user interface associated with a software or web-based application for accessing the system and/or implementing the methods described in this disclosure.

I/O adapter 310 may connect to one or more storage devices 312, such as one or more of a hard drive, a Compact Disk (CD) drive, a floppy disk drive, a tape drive, to the computer system 300. Communications adapter 314 may be adapted to couple computer system 300 to network 108, which may, for example, be one or more of a LAN, WAN, and/or the Internet. User interface adapter 316 couples user input devices, such as a keyboard 320 and a pointing device 318, to computer system 300. Display adapter 322 may be driven by CPU 302 to control the display on display device 324.

The present embodiments are not limited to the architecture of system 300. Rather computer system 300 is provided as an example of one type of computing device that may be adapted to perform the functions of a server 102 and/or user interface device 110. For example, any suitable processor-based device may be utilized including without limitation, personal data assistants (PDAs), computer game consoles, smart phones, and multi-processor servers. Moreover, the present embodiments may be implemented on application specific integrated circuits (ASIC) or very large scale integrated (VLSI) circuits. In fact, persons of ordinary skill in the art may utilize any number of suitable structures capable of executing logical operations according to the described embodiments.

FIG. 3B depicts a portable computing device 350 that can function as a user interface device 110 to run one of the present end-user applications and/or allow an administrator (a user associated with a user profile having administrative permission) to modify settings in a corresponding back-end application via a web browser running on device 350. In particular, in the embodiment shown, device 350 comprises a tablet computer having a touch screen interface 354 that functions as a display to depict or present information to a user and as an input device to enable a user to provide inputs to device 350. Examples of tablet computers that may be suitable for use with or in the present embodiments include the iPad tablet computer that is available from Apple, the Surface tablet computer that is available from Microsoft, and tablet computers based on and/or running the Android operating system and available from various manufacturers such as Samsung. In the embodiment shown, device 350 also comprises a rear-facing camera with an aperture facing away from display 354. As will be understood by those of ordinary skill in the art, such tablet computers can include many if not all of the components described above with reference to FIG. 3A, sometimes in different form (e.g., device 350 includes touch-screen interface 354 instead of mouse 318 and keyboard 320, but device 350 may, in some embodiments, also be connected wirelessly to a mouse and keyboard). For example, device 350 comprises a processor and memory (not independently shown in FIG. 3B, but housed within device 350) configured to store at least portions of an end-user application including instructions executable by the processor of device 350 to perform certain functions of the present embodiments.

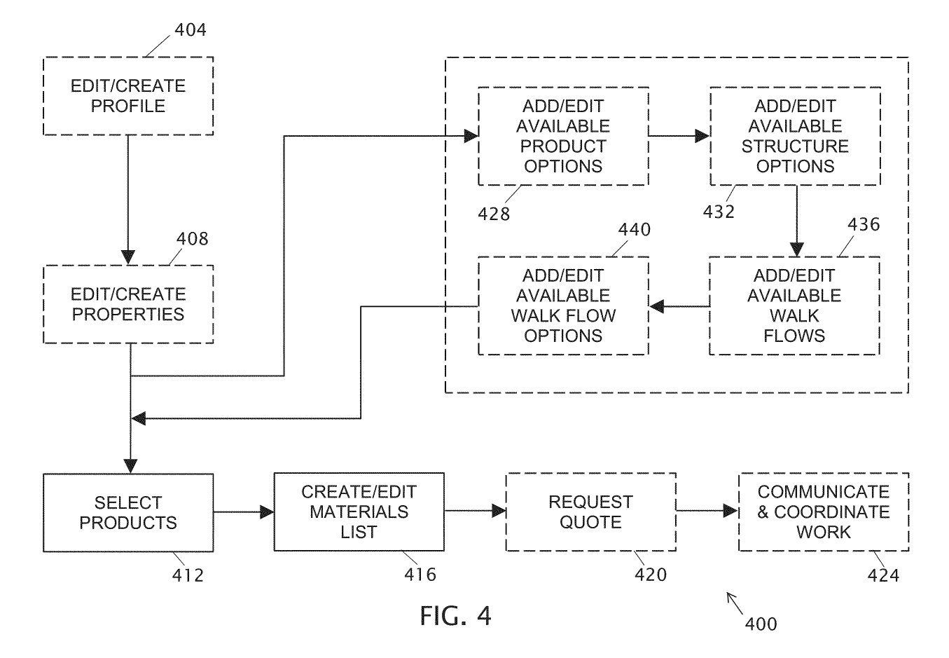

FIG. 4 depicts a high-level flowchart of certain functionality of one embodiment 400 of the present methods that can be implemented on and/or with the present devices and systems. As will be appreciated by those of ordinary skill in the art, the functions depicted and described with reference to FIG. 4 will, in some of the present embodiments, be performed by a processor executing instructions from memory, such as, for example, a processor of device 350 (or another user interface device 110, such as, for example, computer system 300) and/or a processor of a server 102 that is configured to communicate with the device (e.g., via a wireless data connection such as may be provided by WiFi, cellular telephone networks, Bluetooth, and/or the like). In most (if not all) of the present embodiments, most (if not all) of the functions of the present back-end applications will typically be performed by a processor of a server (e.g., server 102), and most (if not all) of the functions of the present end-user applications will typically be performed by a processor of an end-user device (e.g., device 350 and/or computer system 300).

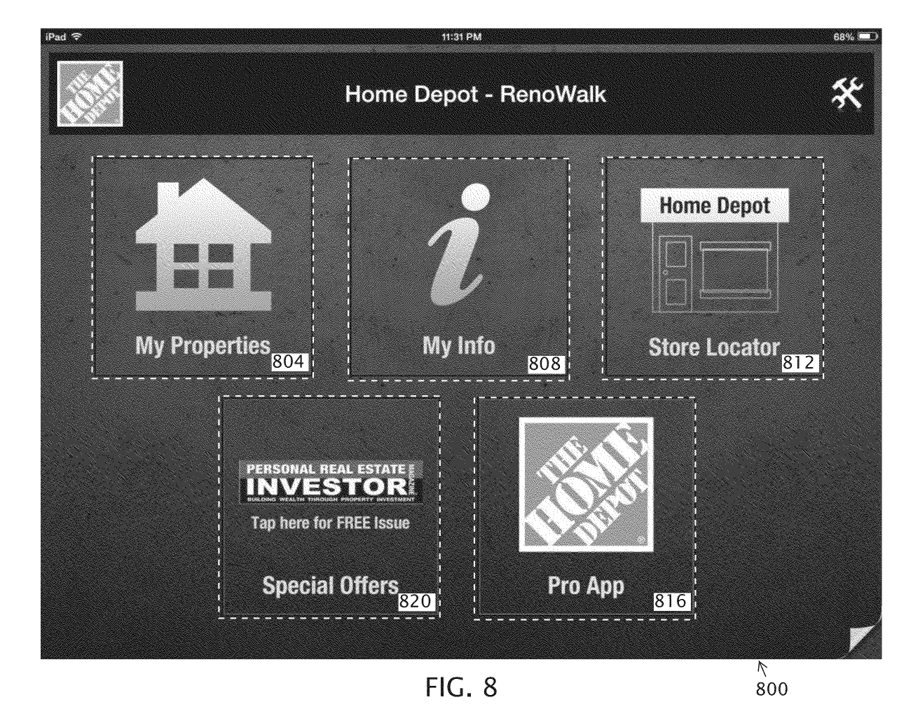

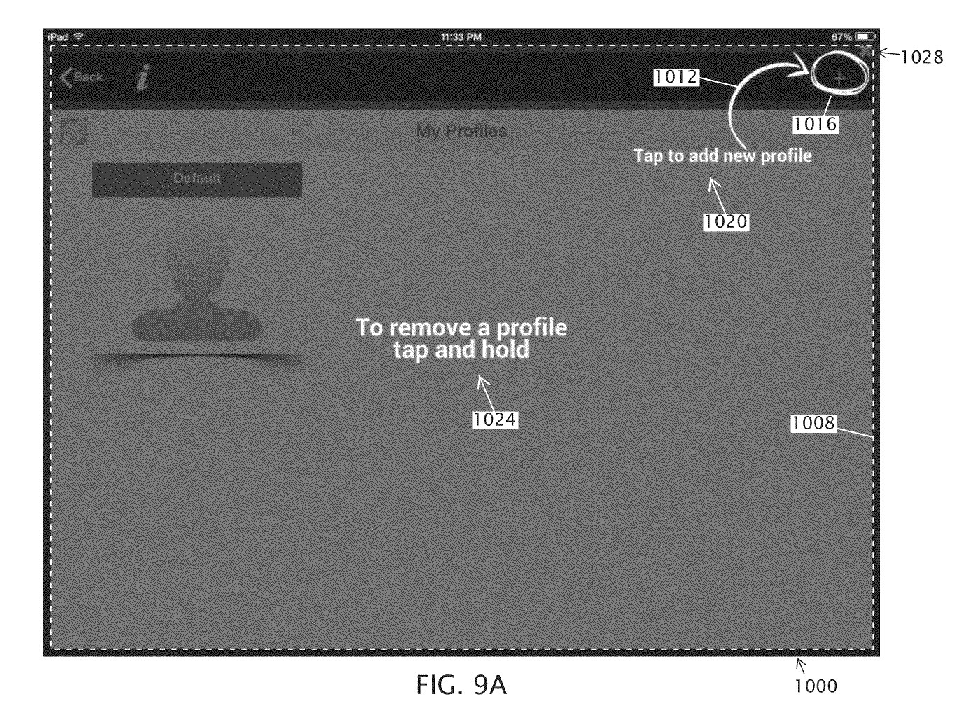

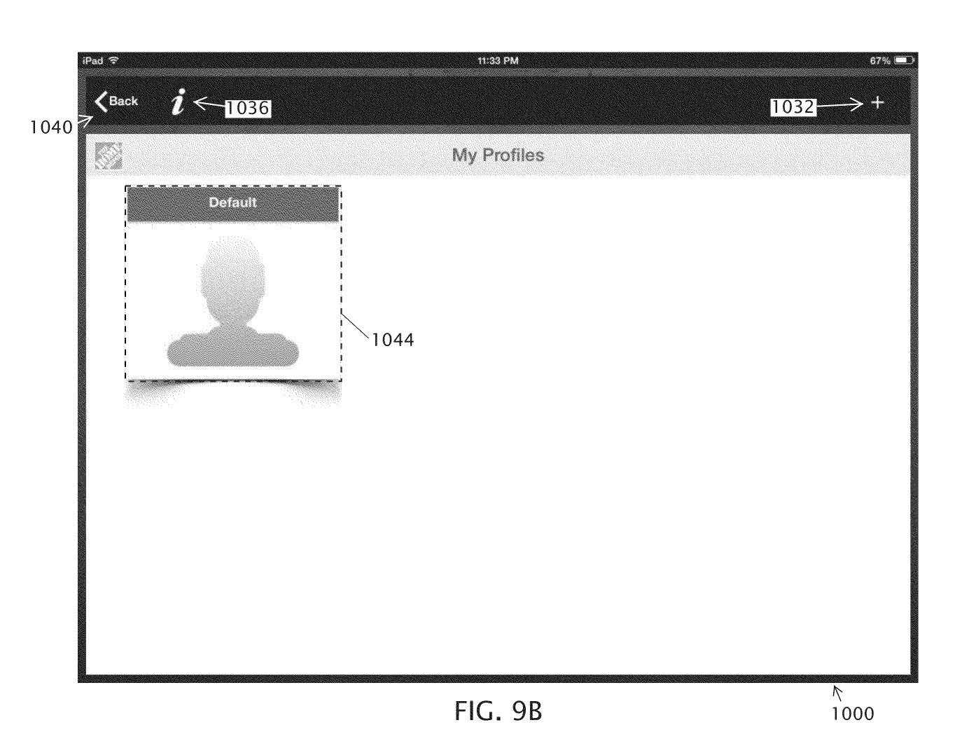

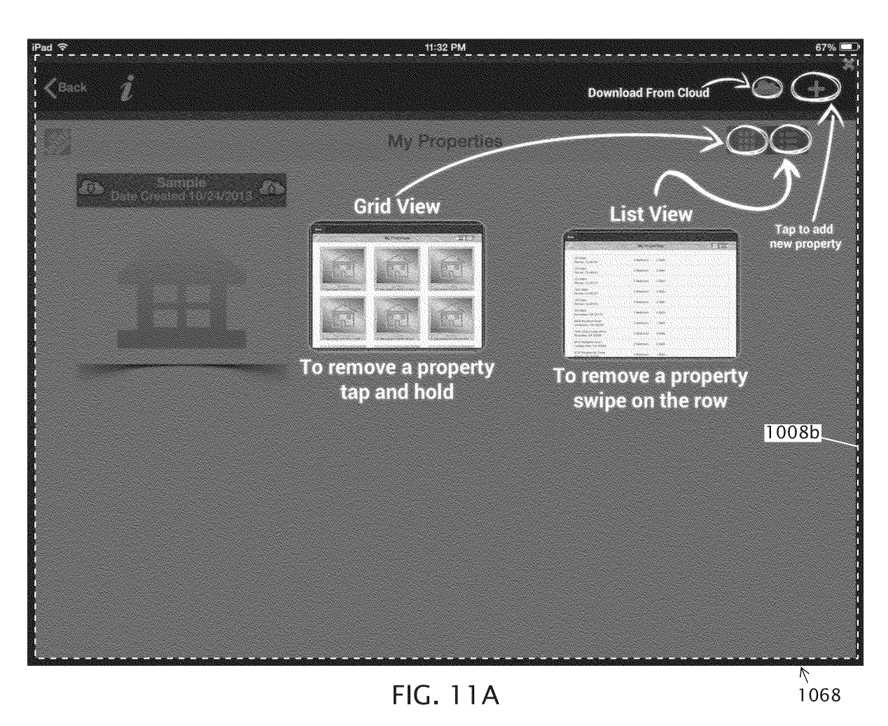

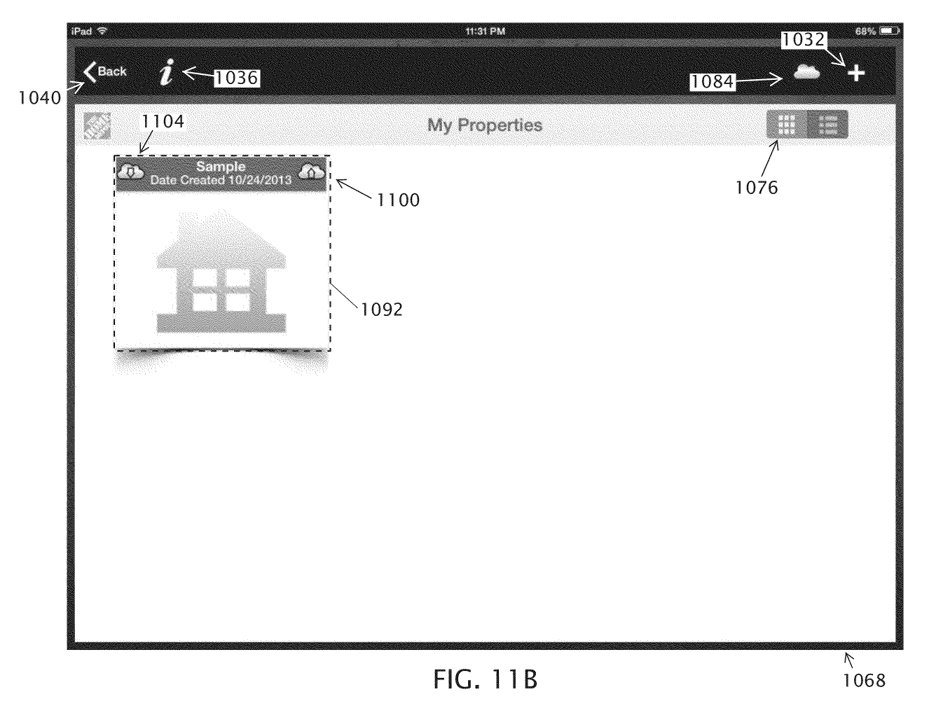

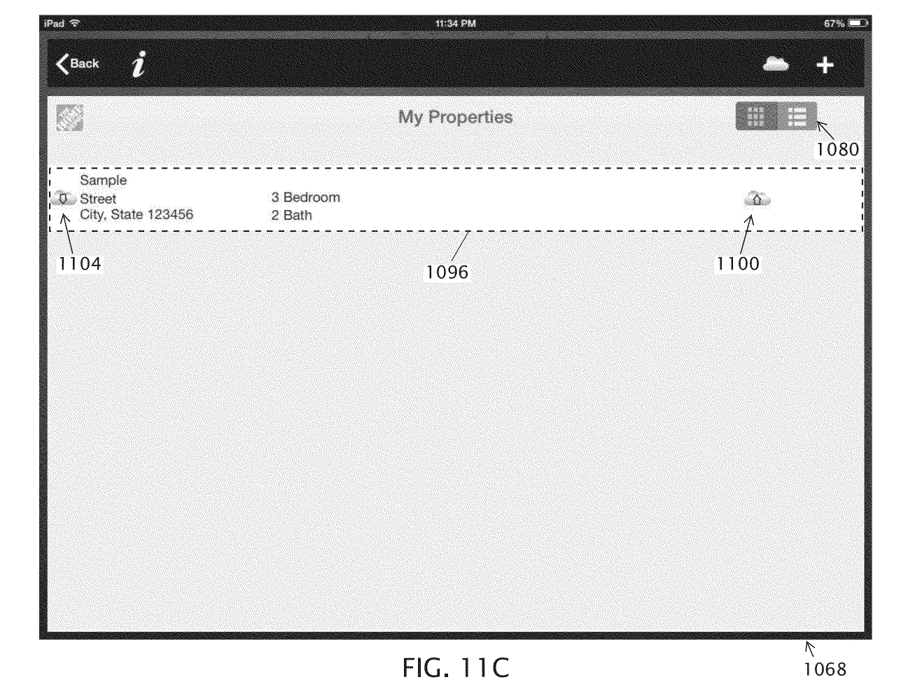

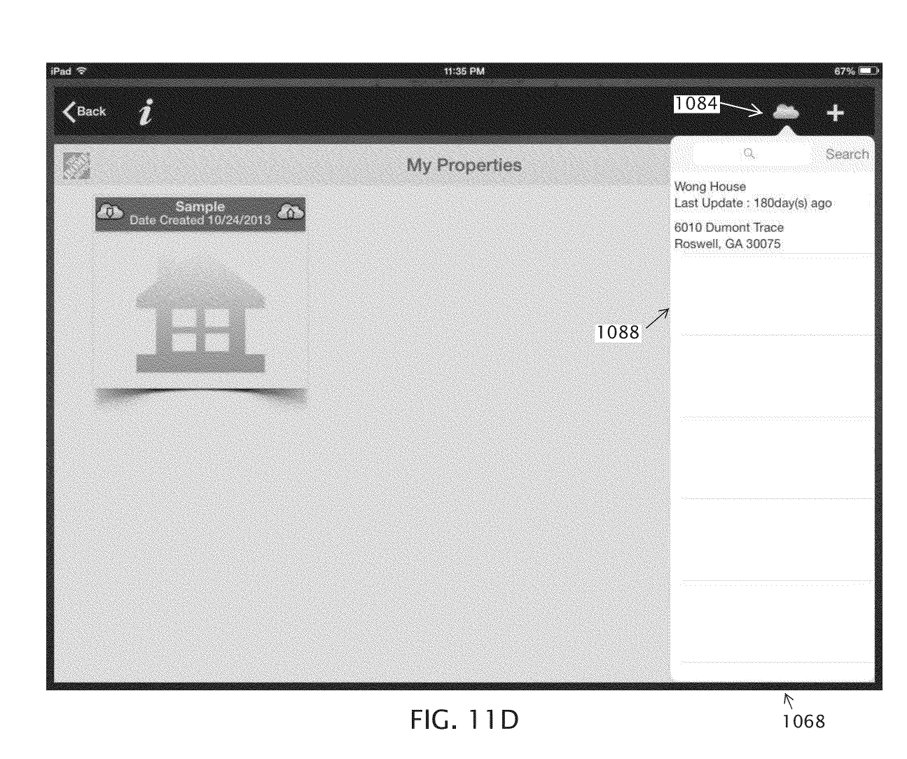

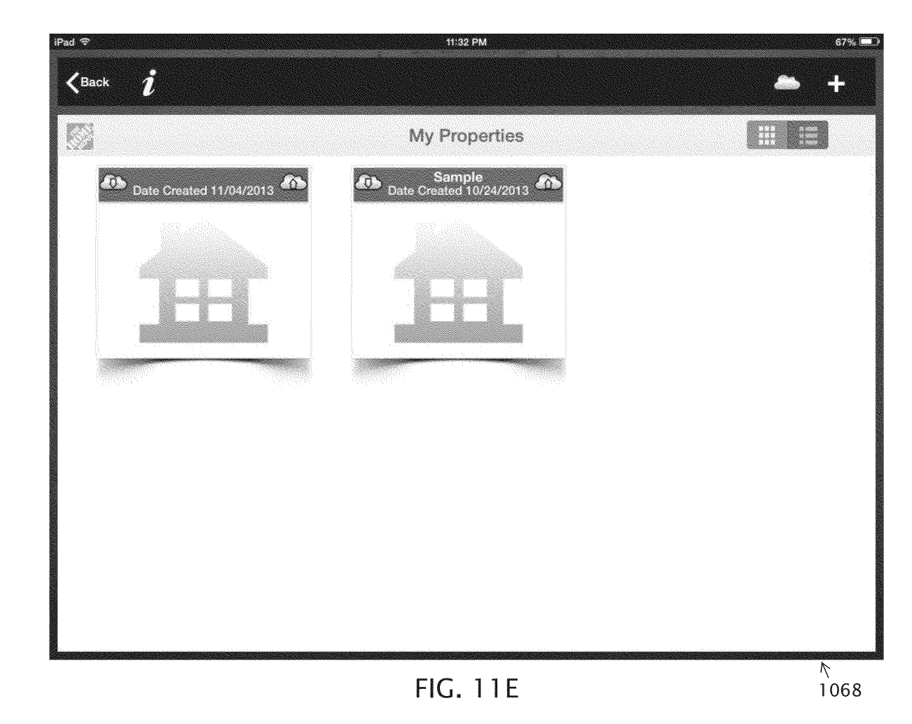

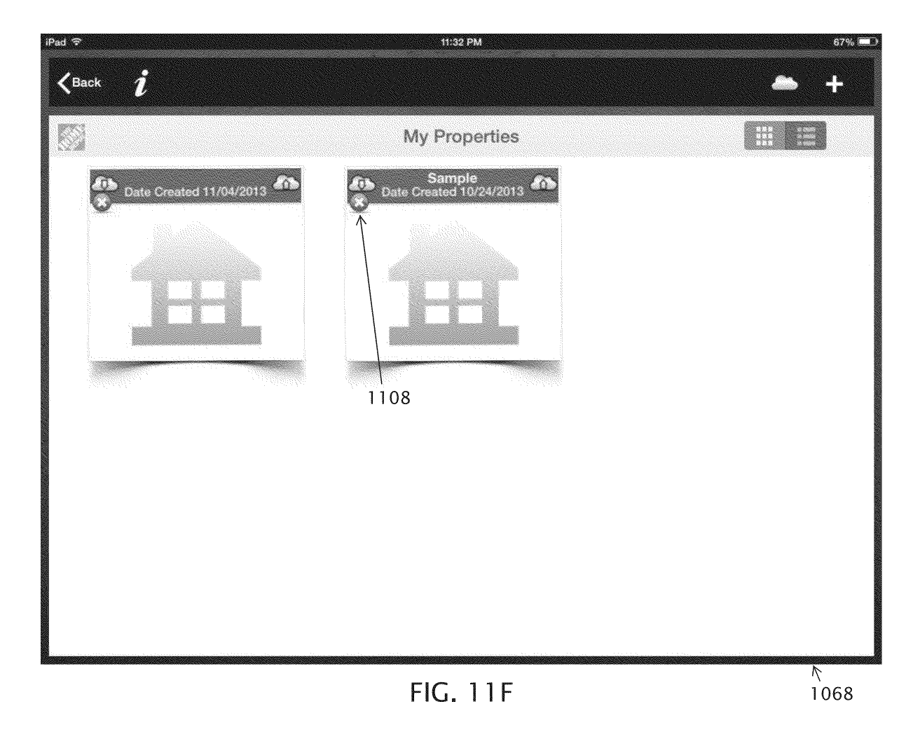

In the embodiment shown, method 400 comprises: a step 404 of editing and/or creating one or more user profiles, a step 408 of editing and/or creating one or more property profiles, a step 412 of selecting products for a property, and a step 416 of editing and/or creating a materials list for a property. In the embodiment shown, each of steps 404, 408, 412, and 416 can be performed by and/or with one of the present end-user applications, as described in more detail below. FIG. 8, for example, depicts a home screen 800 of a graphical user interface (GUI) for one example of the present end-user applications that can be depicted or presented to a user via touch-screen display 354 of device 350. In the embodiment shown, home screen 800 comprises a button or region 804 associated with the property-management screen of FIGS. 11A-11F (e.g., configured to, upon selection by a user, cause device 350 to present the property-management screen), a button or region 808 associated with the profile-management screen of FIGS. 9A-9B (e.g., configured to, upon selection by a user, cause device 350 to present the profile-management screen), a store locator button or region 812 associated with a store-locator screen or webpage (e.g., configured to, upon selection by a user, cause device 350 to present the store-locator creation screen or webpage), an application button or region 816 associated with a second application such as the Pro App offered by The Home Depot (e.g., configured to, upon selection by a user, cause device 350 to open the second application if already installed on the device, or to cause device 350 to access a webpage or third application (e.g., Apple App Store) from which the second application can be downloaded if not already installed on the device), and an advertising button or region 820 associated with an advertised product or service (e.g., configured to, upon selection by a user, cause device 350 to present a webpage or other information related to the advertised product or service). As will also be appreciated by those of ordinary skill in the art, the method steps described with reference to FIG. 4 and other figures can be implemented by various modules of the end-user application and/or the back-end application (e.g., one module for each step of method 400 and/or modules that each include or are configured to implement multiple steps of method 400.

In the embodiment depicted in FIG. 4, method 400 also comprises a step 420 in which a quote is requested (e.g., from a supplier) such as, for example, by submitting the materials list to the supplier. In the embodiment shown, method 400 also comprises a step 424 in which work on a property can be coordinated with subcontractors and/or the like (e.g., by communicating selected tasks for a property to various subcontractors according to the type or category of the task). For example, a list of plumbing tasks and associated information (e.g., a list of selected plumbing products, photos, notes, and/or the like) can be transmitted to a selected plumbing contractor.

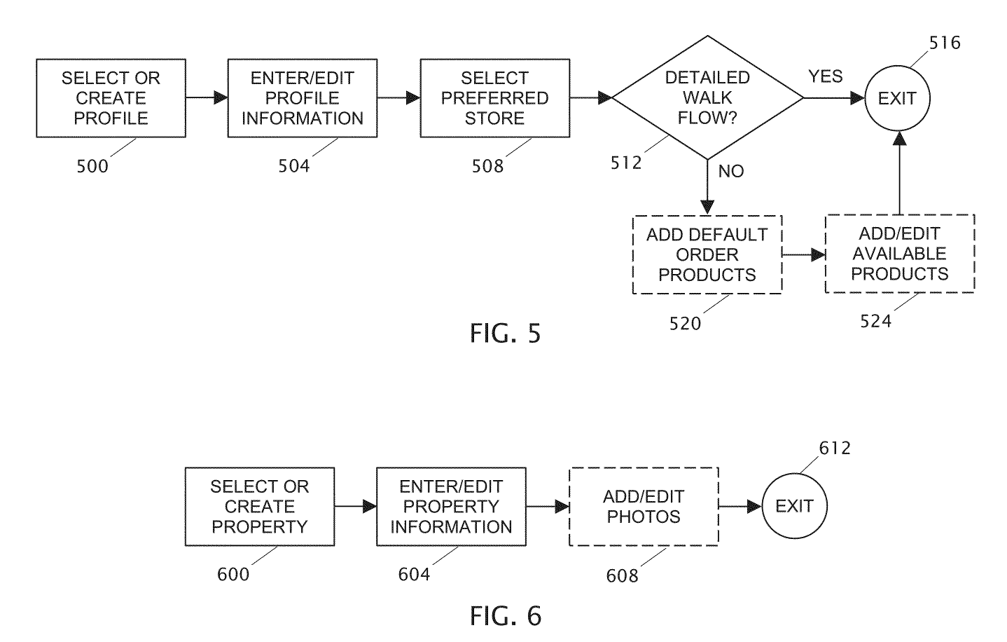

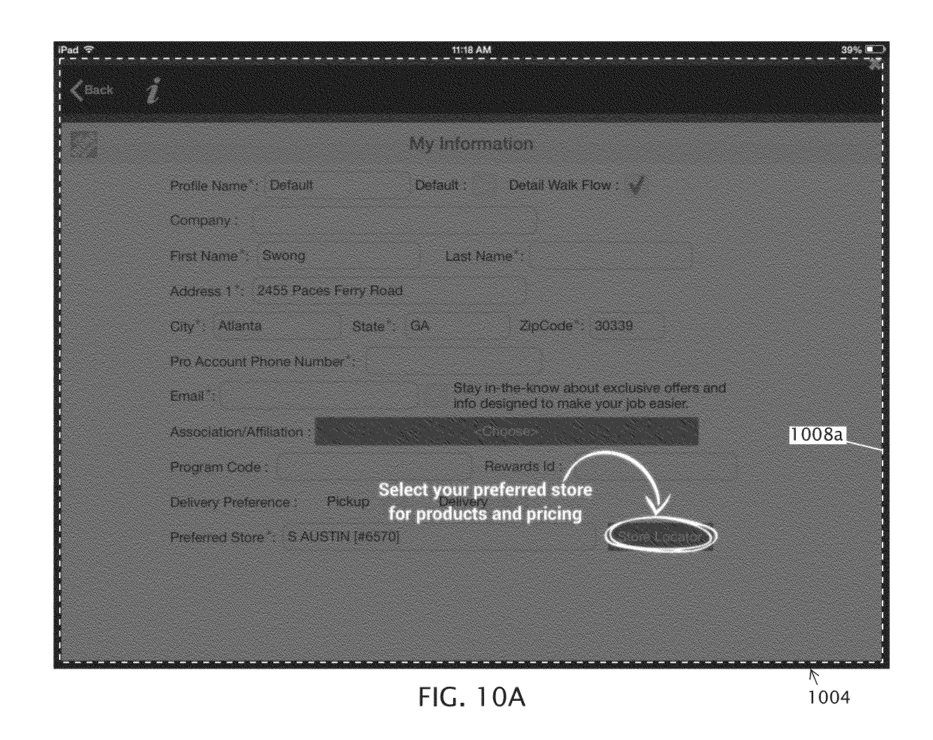

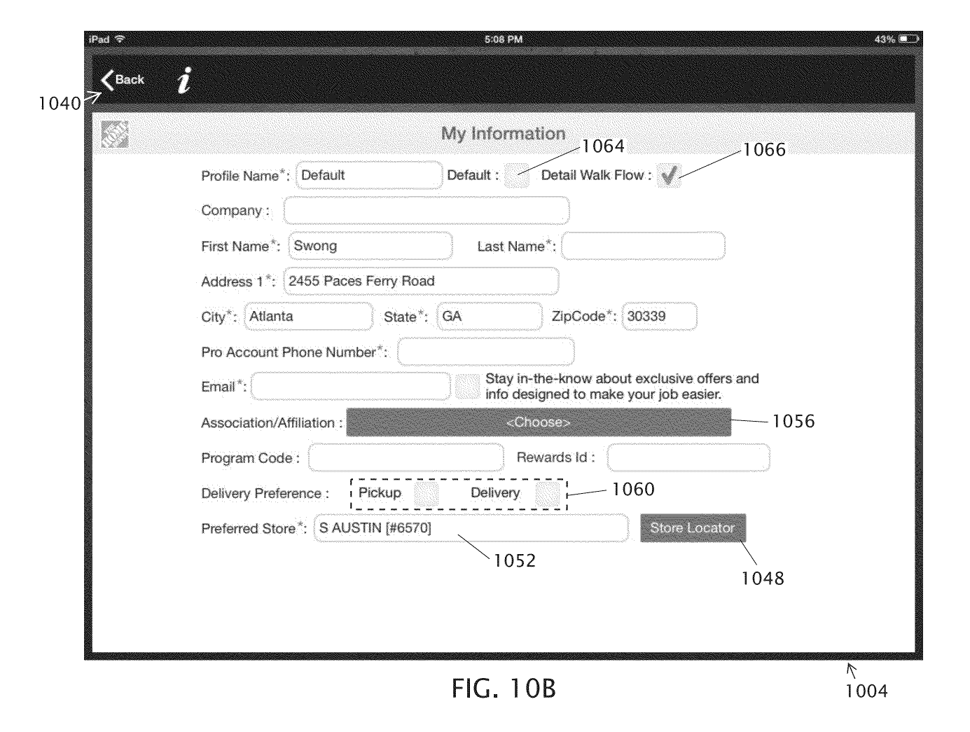

Referring now to FIGS. 5, 9A-9B, and 10A-10B FIG. 5 depicts a flowchart of sub-steps of one example of step 404 of editing and/or creating one or more user profiles, FIGS. 9A-9B depict a profile-management screen 1000 of one of the present end-user applications that can be presented to a user via device 350 (e.g., responsive to user selection of button or region 808 on home screen 800), and FIGS. 10A-10B depict a profile-editing screen 1004 for a detailed walk flow of one of the present end-user applications that can be presented to a user via device 350. As depicted in the embodiment of FIG. 5, step 404 can comprise a sub-step 500 of creating and/or selecting a user profile, a sub-step 504 of entering and/or editing information in the user profile, a sub-step 508 of selecting a preferred store, and a sub-step 512 of determining whether a detailed walk flow is desired. An example of sub-step 500 of creating and/or selecting a user profile is illustrated in FIGS. 9A-9B, which depict profile-management screen 1000.

In some embodiments, such as the one shown, the end-user application is configured to present a “help” overlay 1008 over screen 1000 to indicate to a user certain functions that are accessible via screen 1000. In this embodiment, overlay 1008 includes a single image with spatial indicators of (e.g., arrows 1012 pointing to and/or lines 1016 outlining) regions of screen 1000 that can be touched, tapped, or otherwise selected by a user to invoke certain functions and/or text 1020, 1024 describing a function that can be invoked or initiated and/or describing how to invoke the function (e.g., “press and hold”). Overlay 1008 also includes an icon 1028 (an “X” in the depicted embodiment) in the upper right corner of the overlay that can be selected by a user to close or remove overlay 1008 and thereby permit access to screen 1000 as depicted in FIG. 9B. Other overlays of the depicted end-user application include similar types of icons, text, and/or functions.

As indicated by overlay 1008, screen 1000 includes an icon 1032 (a “+” in the depicted embodiment) that can be selected by a user to add a profile, and an info icon 1036 (an “i” in the depicted embodiment) that can be selected by a user to display overlay 1008. In the present embodiments, icon 1036 appears on multiple screens and can be selected by a user to invoke or display an overlay with hints and/or instructions corresponding to the functionality of the screen on which icon 1036 is selected. Similarly, screen 1000 includes a “back” button or region 1040 that also appears on other screens of the depicted end-user applications to permit a user to return to a previous screen. As shown, screen 1000 also includes one (as shown) or more regions 1044 each corresponding to a user profile. In the embodiment shown, selection by a user of either icon 1032 or region 1044 causes device 350 to present profile-editing screen 1004 of FIGS. 10A and 10B corresponding to either a new user profile or the user profile associated with the selected region.

FIGS. 10A-10B illustrate an example of a profile-editing screen 1004 through which sub-step 504 of entering and/or editing information in the user profile can be completed. An overlay 1008a is depicted in FIG. 10A that provides an indicator of a store-locator button 1048, as shown in FIG. 10B, which button 1048 can be selected by a user to cause device 350 to present a store-locator creation screen or webpage in which a user can enter a desired location (e.g., a zip code, address, or city near where a store location is desired to be located) to facilitate sub-step 508 of selecting a preferred store (which can be completed by entering an indicator such a store number of the preferred store in text box 1052). As also shown, in this embodiment, profile-editing screen 1004 includes a plurality of text boxes (e.g., text box 1052) corresponding to various pieces of information (e.g., profile name, company, name, address, email, program code, rewards-program identification, and preferred store number), as well as a drop-down menu 1056 configured to enable selection of an association or affiliation with which a user is a member or otherwise affiliated, check boxes 1060 to enable a user to select a delivery preference (pickup or delivery) for products ordered from supplier (e.g., the preferred store), and a check box 1064 to select whether the profile should be used as the default profile for new properties. Finally, profile-editing screen 1004 includes a check box 1066 to enable a user to indicate whether a detailed walk flow is desired for the profile, such as to facilitate sub-step 512 of determining whether a detailed walk flow is desired. If a detailed walk flow is desired, then method 400 can proceed to exit at 516 such that method 400 can proceed to step 408. For example, in the embodiment shown, once the desired information is entered into screen 1004, the user can select back button 1040 of screen 1004 to return to profile-management screen 1000 (FIG. 9B) and can then select back button 1040 of screen 1000 to return to home screen 800 (FIG. 8).

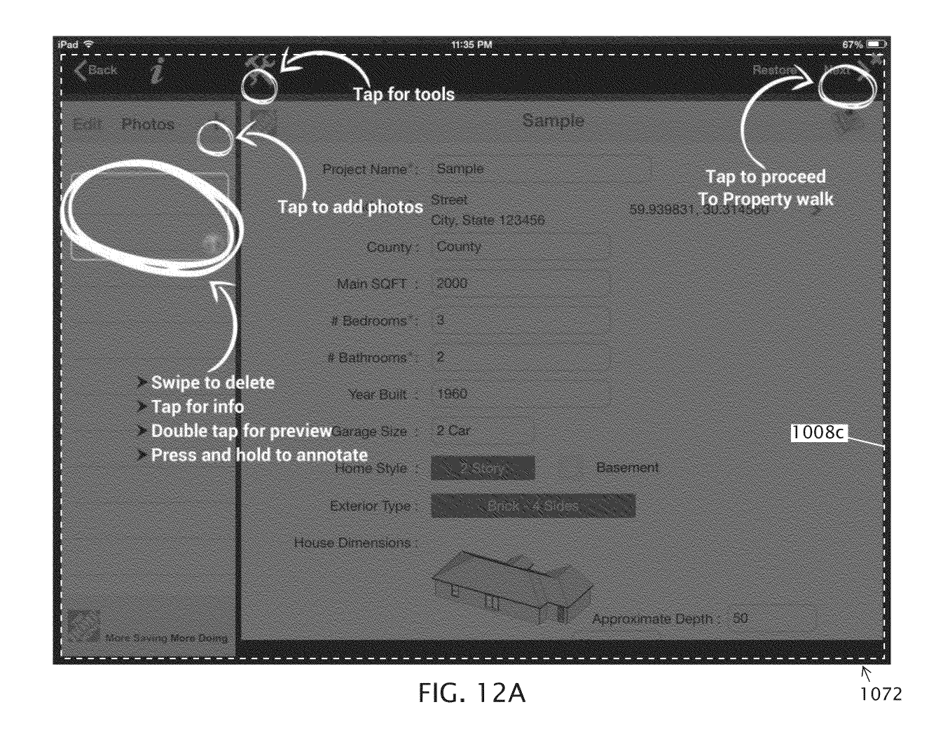

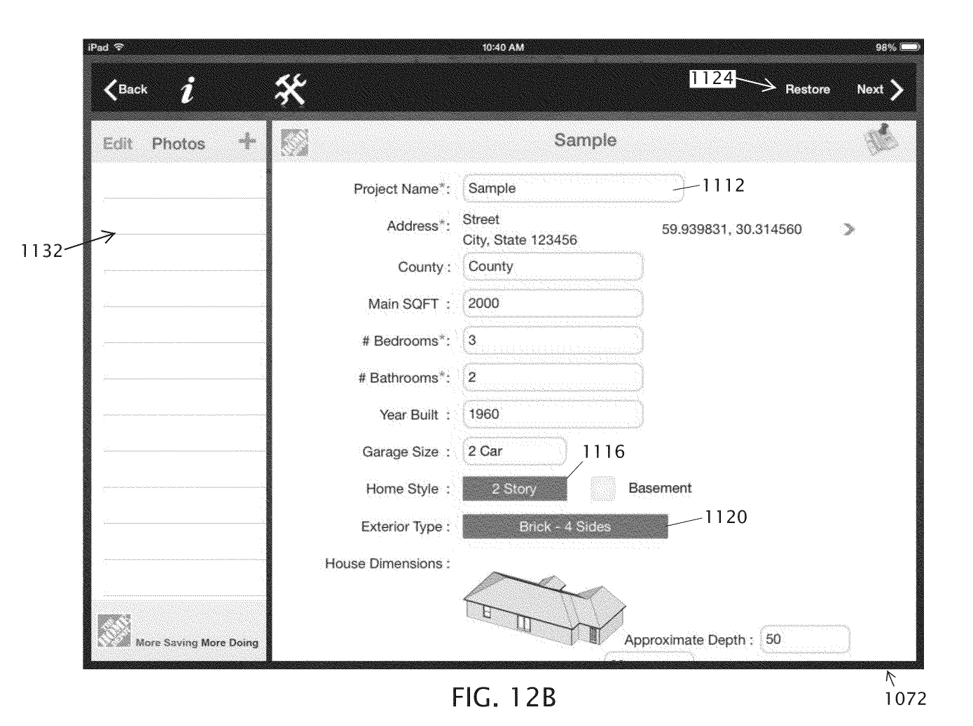

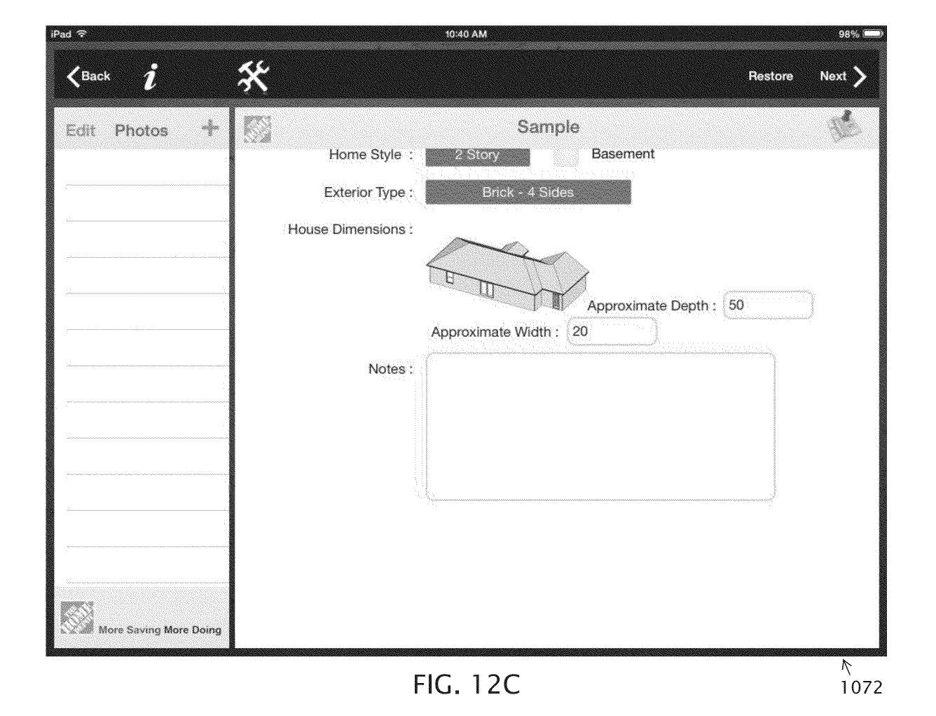

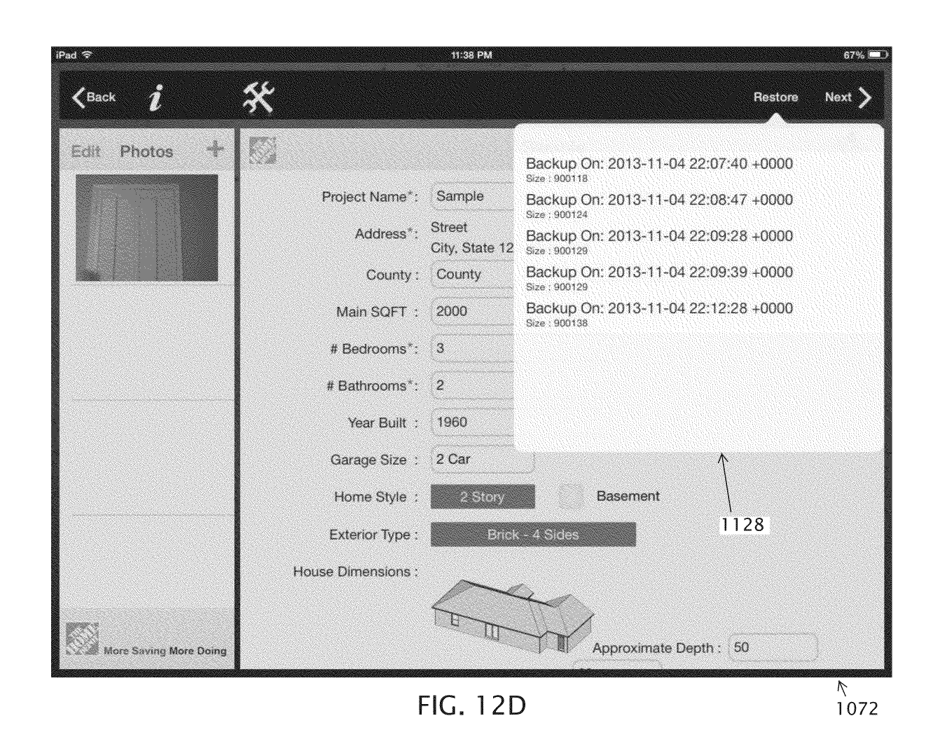

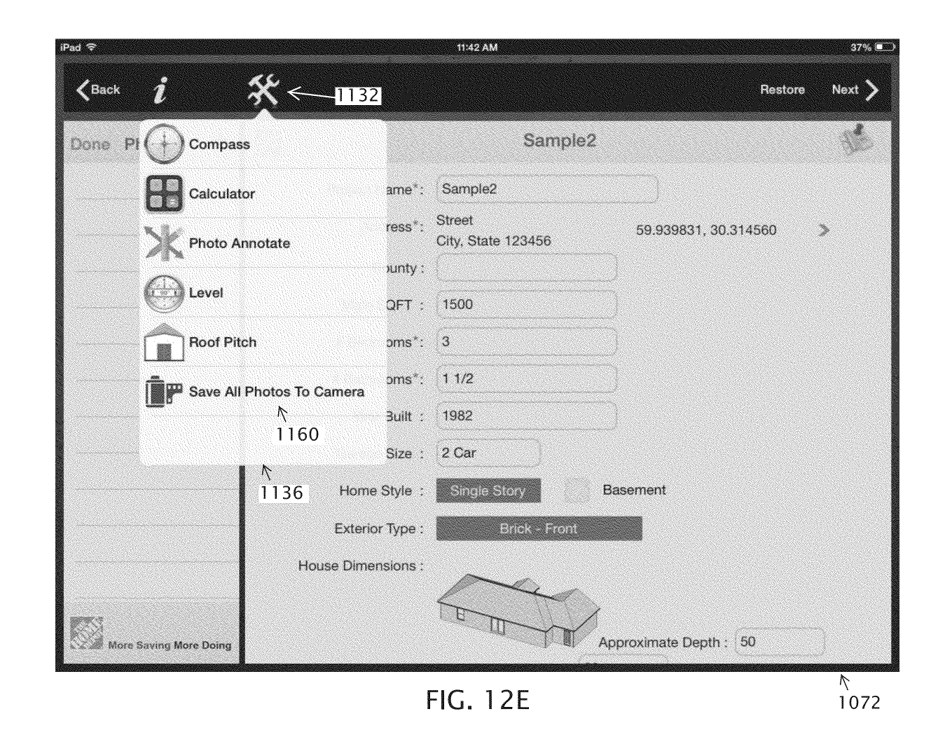

Referring now to FIGS. 6, 11A-11F, and 12A-12D, FIG. 6 depicts a flowchart of sub-steps of one example of step 408 of editing and/or creating properties in the end-user application, FIGS. 11A-11f depict a property-management screen 1068 of one of the present end-user applications that can be presented to a user via device 350 (e.g., responsive to user selection of button or region 804 on home screen 800), and FIGS. 12A-12D depict a property-editing screen 1072 that can be presented to a user via device 350. As depicted in the embodiment of FIG. 6, step 408 can comprise a sub-step 600 of creating and/or selecting a property (e.g., a property profile), a sub-step 604 of entering and/or editing information in property profile, a sub-step 608 of adding and/or editing photos of or otherwise associated with the property. An example of sub-step 600 of creating and/or selecting a user profile is illustrated in FIGS. 11A-11F, which depict property-management screen 1068.

An overlay 1008b is depicted in FIG. 11A that provides indicators of various icons and functions of property-management screen 1068, as shown in more-detail in FIG. 11B. In this embodiment, in addition to icon 1032 (selectable to create a new property profile), icon 1036 (selectable to depict help overlay 1008b), and icon 1040 (selectable to return to home screen 800) the functions of which are described above, property-management screen 1068 includes icon 1076 and icon 1080, respectively, to enable a user to select a grid view (as shown in FIG. 11B) or a list view (as shown in FIG. 11C). In this embodiment, property-management screen 1068 also includes an icon 1084 (e.g., a cloud shape, in the depicted embodiment) that is selectable to permit a user to view and/or select a remotely-stored profile (e.g., stored on a server 102 on which the back-end application resides) to download to the device (e.g., as depicted in pop-up window 1088 shown in FIG. 11D). Additionally, in this embodiment, each property region 1092 in the grid view of FIG. 11B and/or each property region 1096 in the list view of FIG. 11C includes an up-sync icon 1100 selectable by a user to upload the profile to a remote storage device (e.g., server 102) and/or sync or upload local changes to a version of the profile that was previously uploaded, and a down-sync icon 1104 selectable by a user to sync or download changes to the profile that were previously uploaded to the remote storage device (e.g., from a different device 350). FIG. 11E depicts screen 1068 after creation of a second property profile. Finally, as illustrated in FIG. 11E, a user can select and hold a region 1092 (or 1096) associated with a property to enable deletion of a property profile, such as, for example, by displaying “X” icons 1108 that can then be selected by a user to delete the corresponding property profile, as illustrated in FIG. 11F. In the embodiment shown, selection by a user of either icon 1032 or a region 1092 causes device 350 to present property-editing screen 1072 of FIGS. 12A-12E corresponding to either a new user profile or the user profile associated with the selected region. In some embodiments, an administrative user can restrict the creation of new properties for end users, such that certain end users may only be able to access and/or edit certain properties, and/or may be prevented from creating new properties.

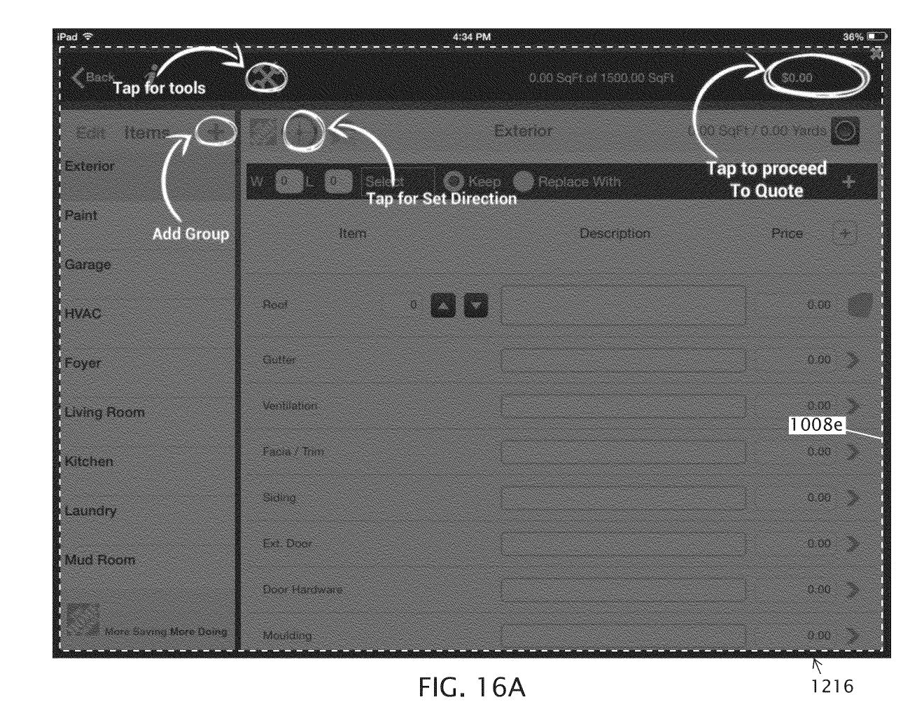

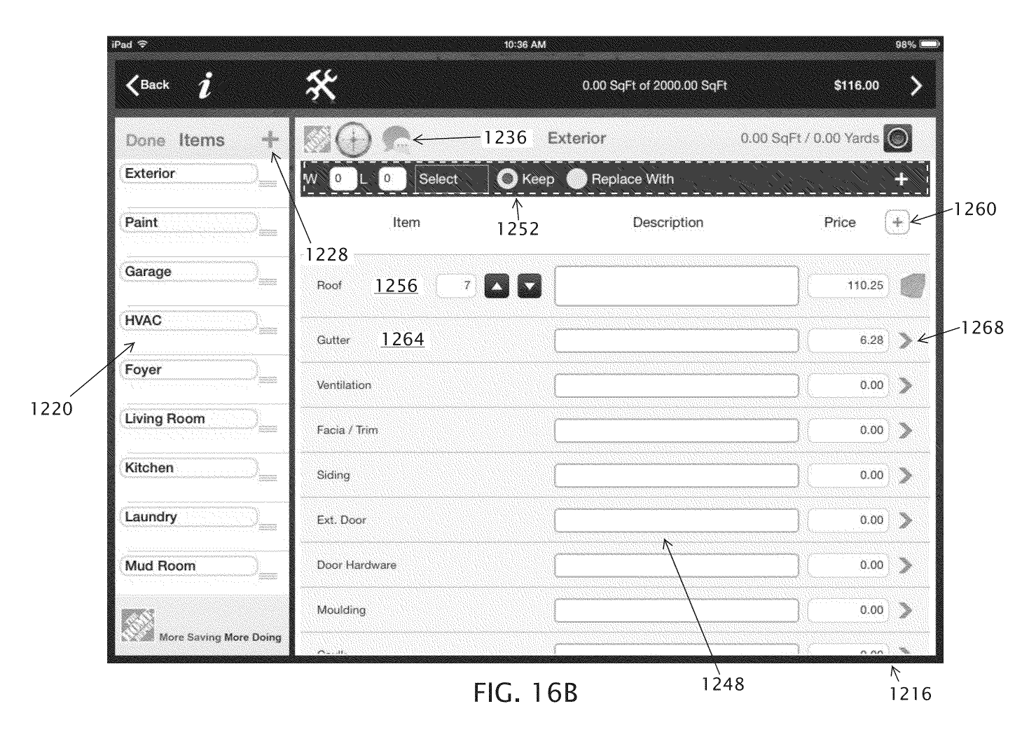

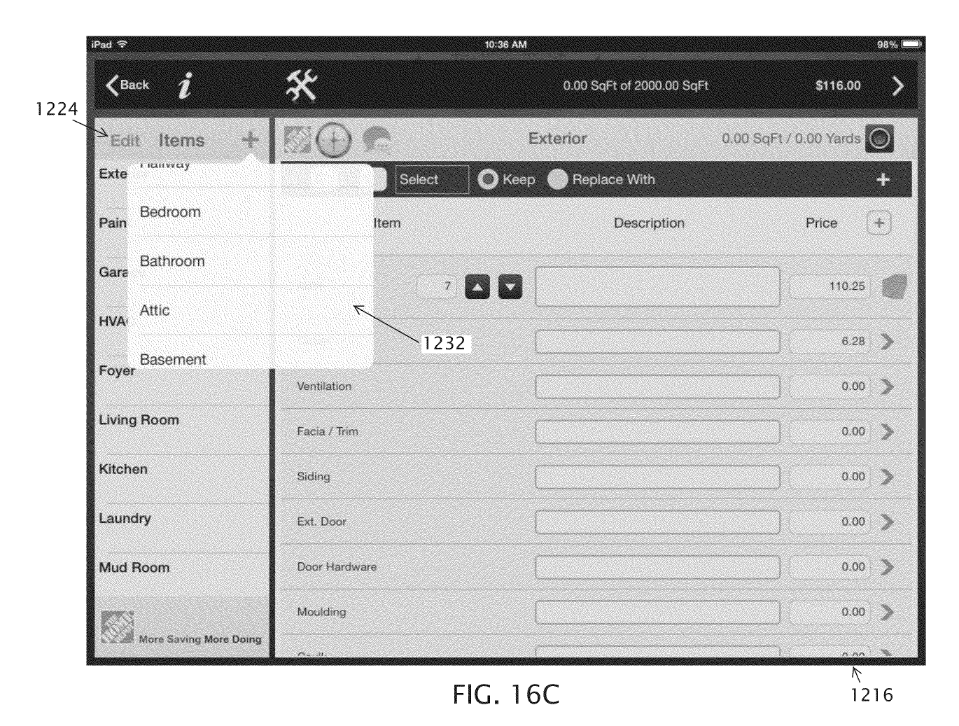

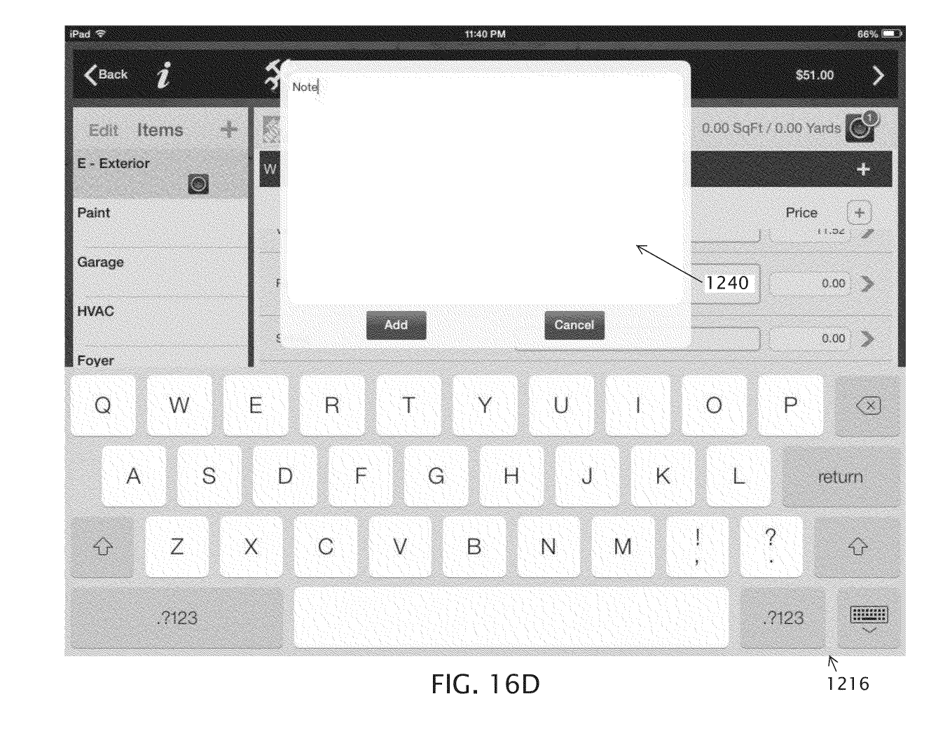

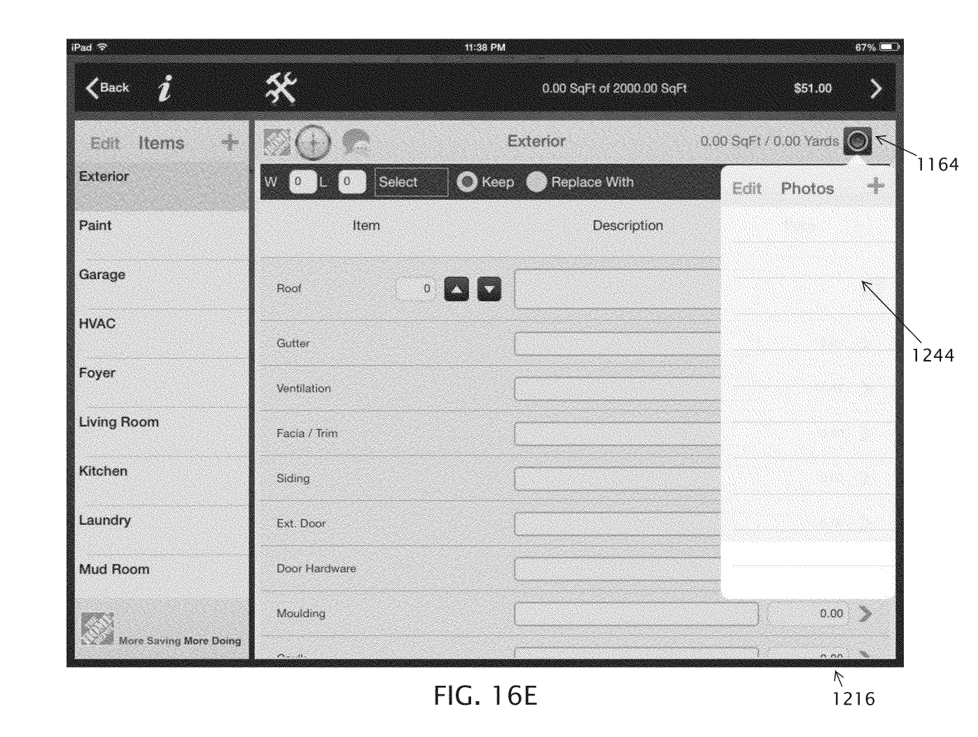

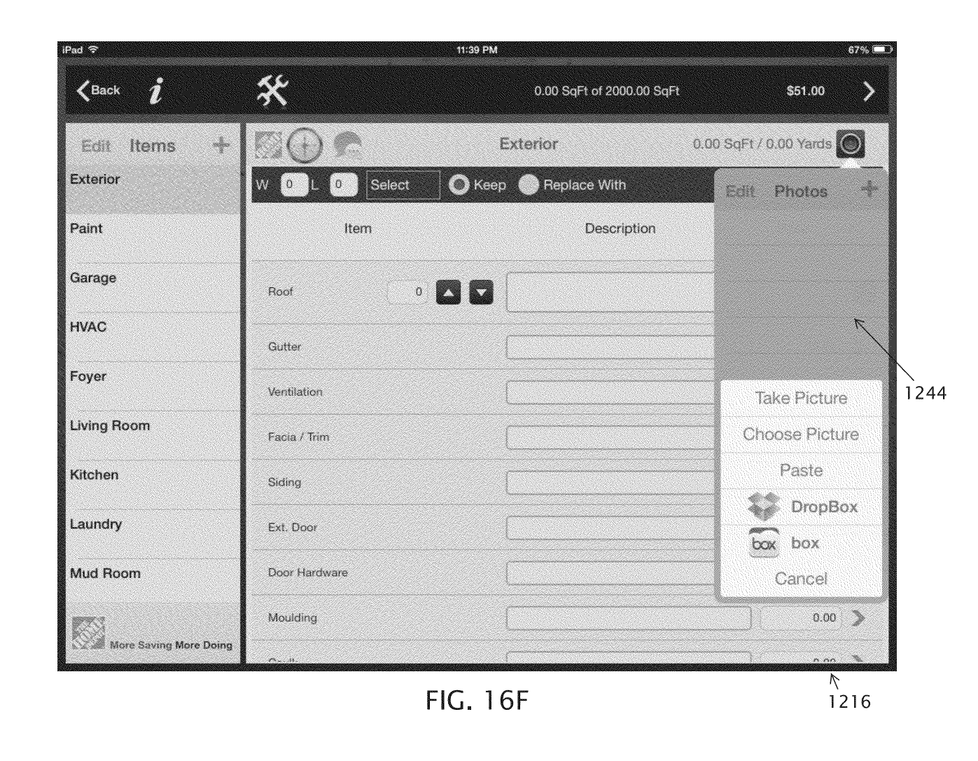

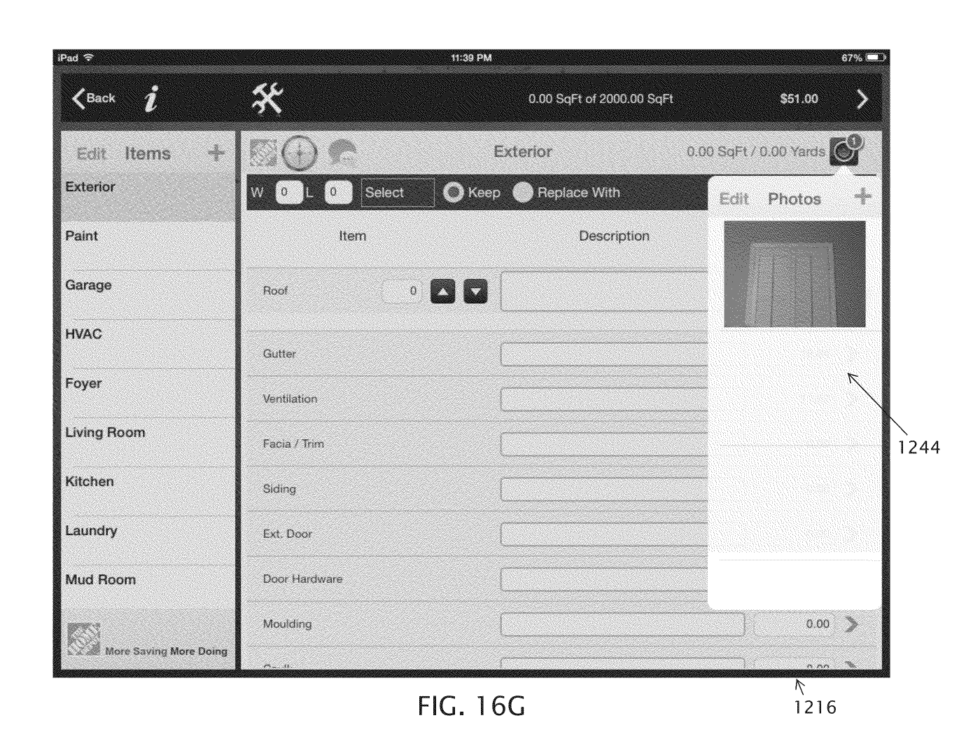

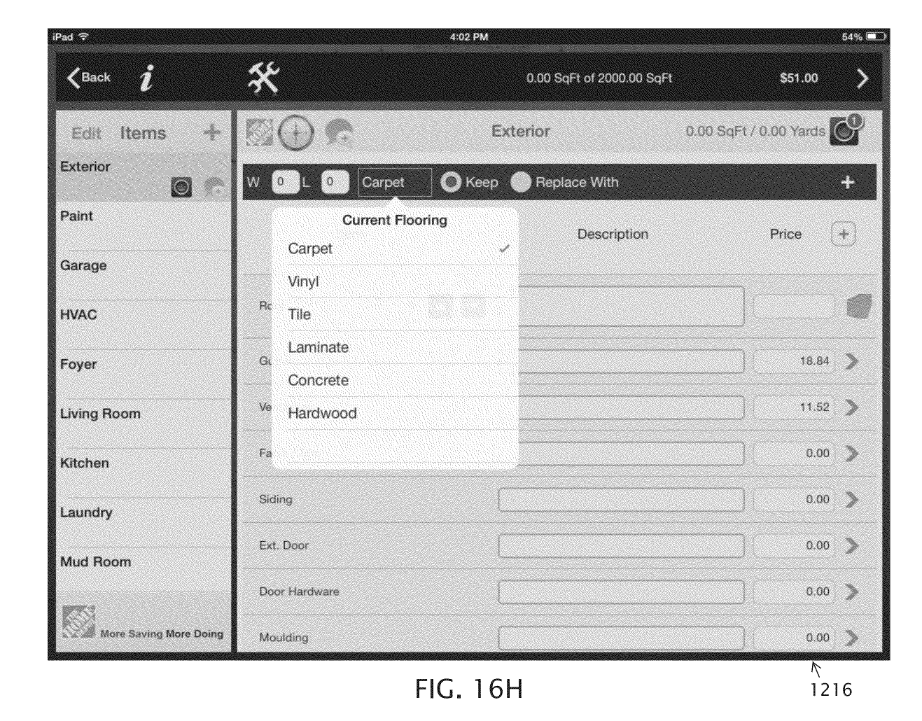

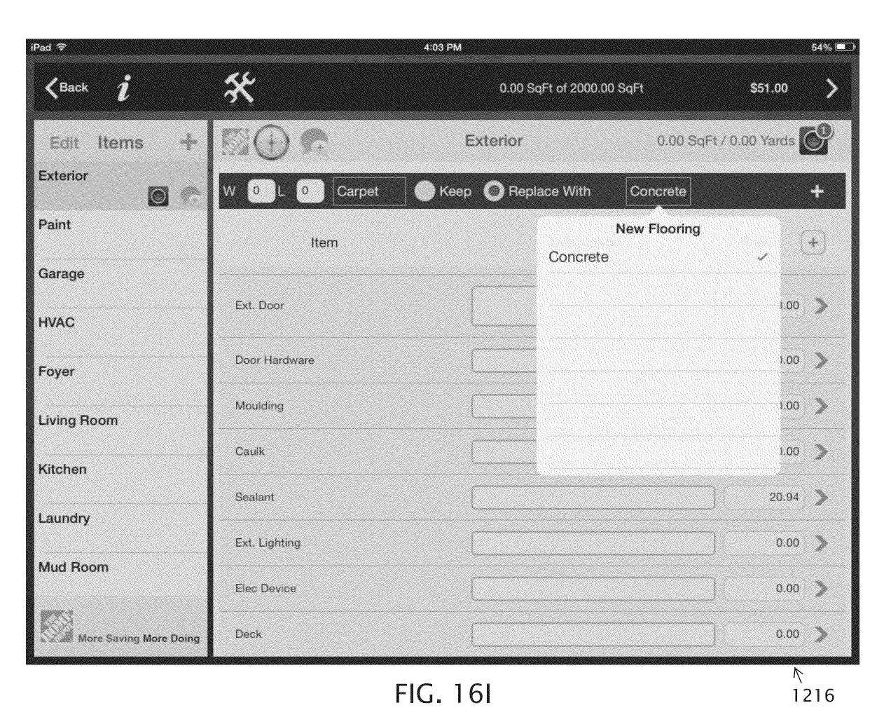

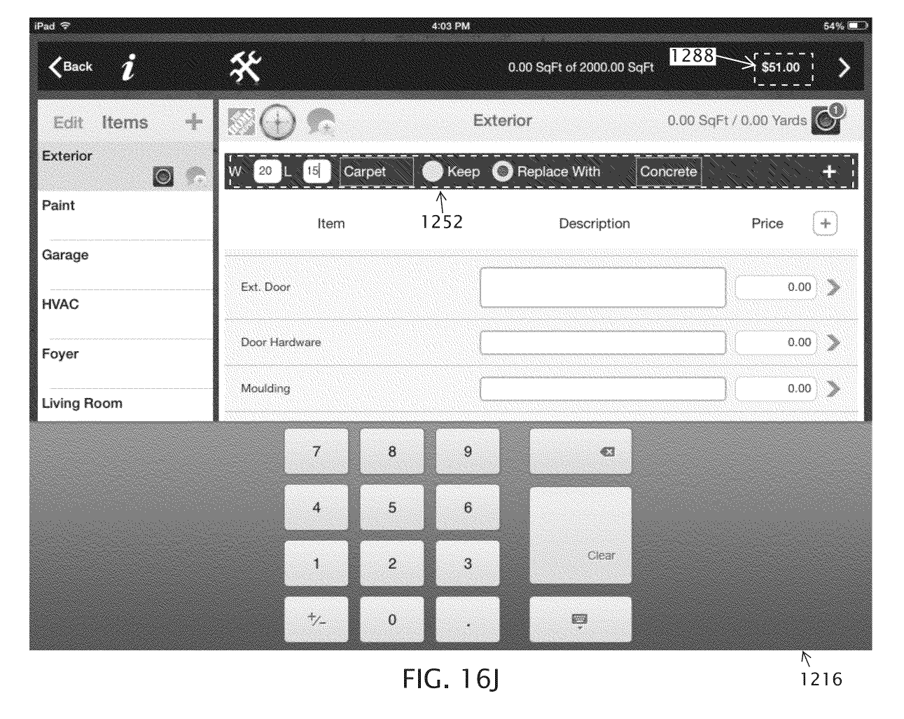

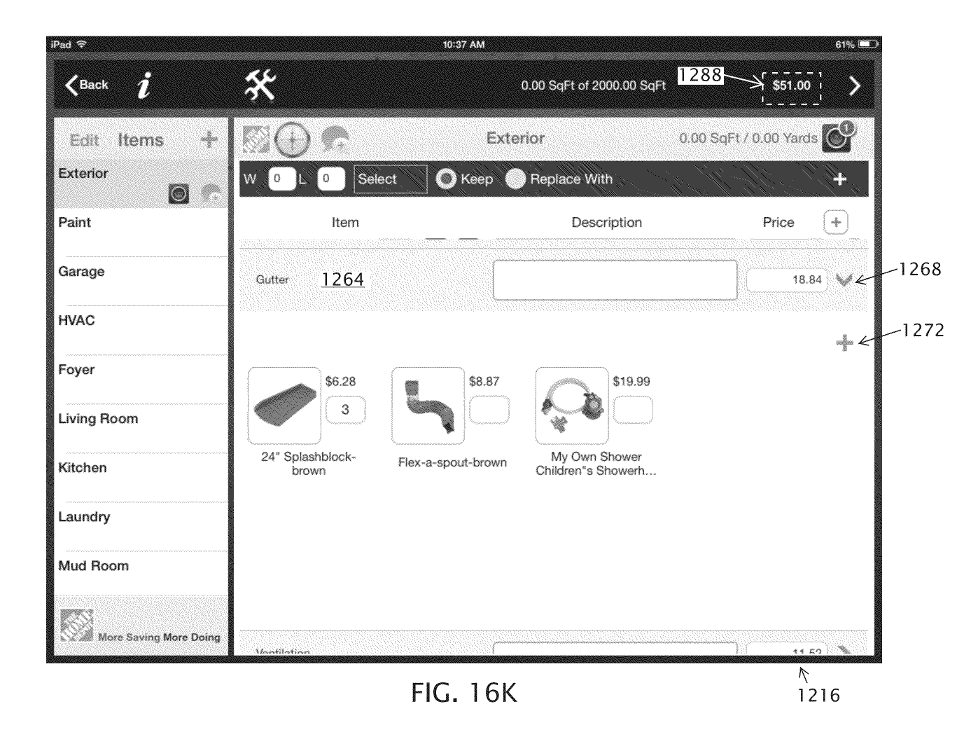

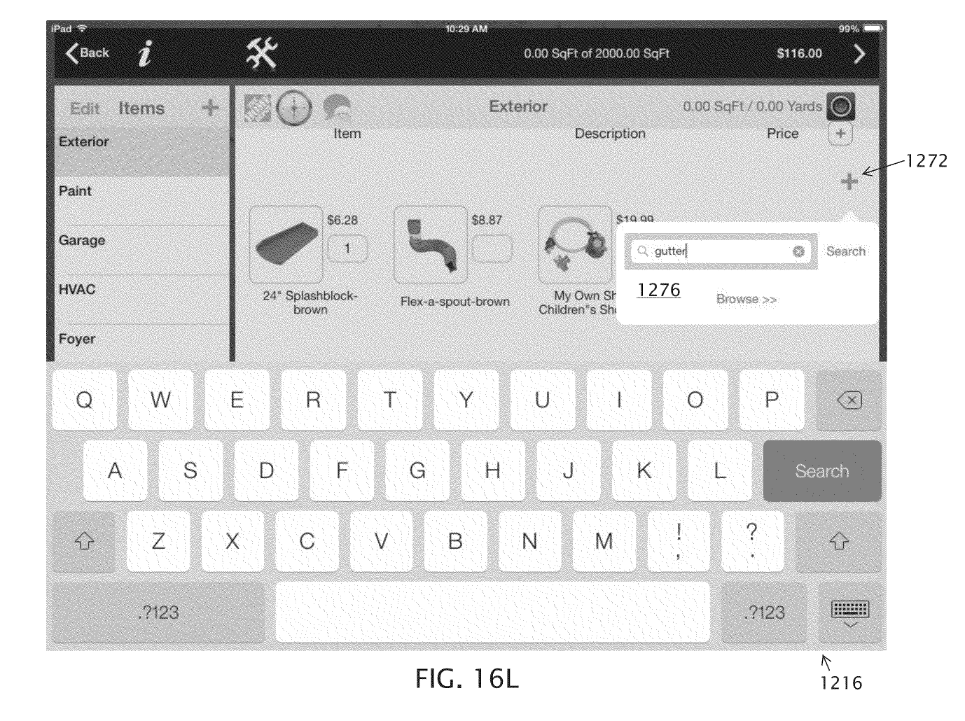

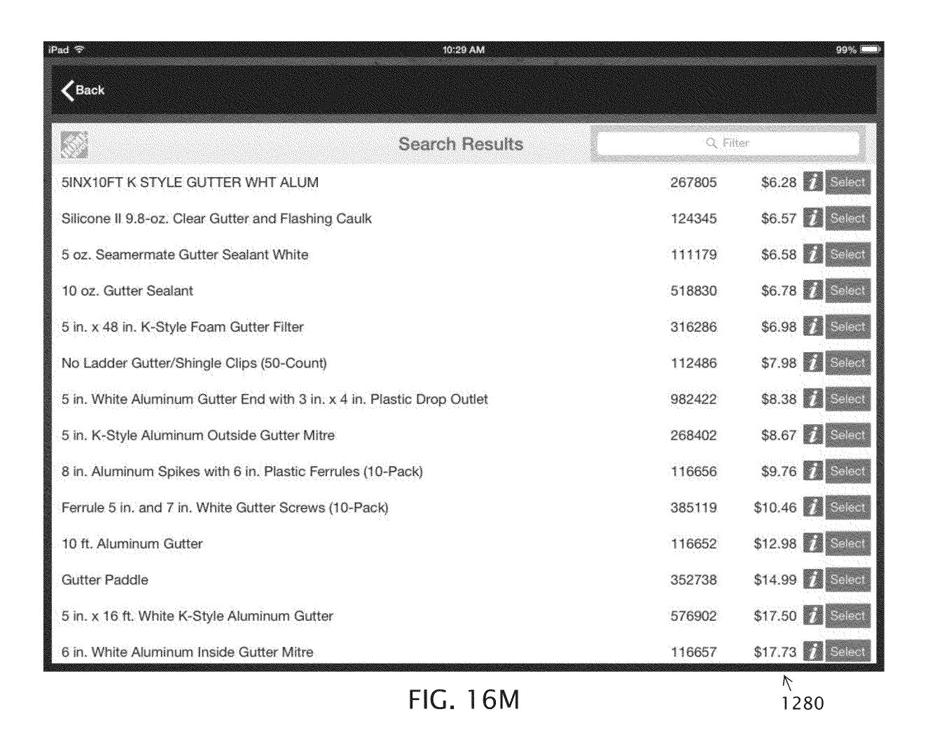

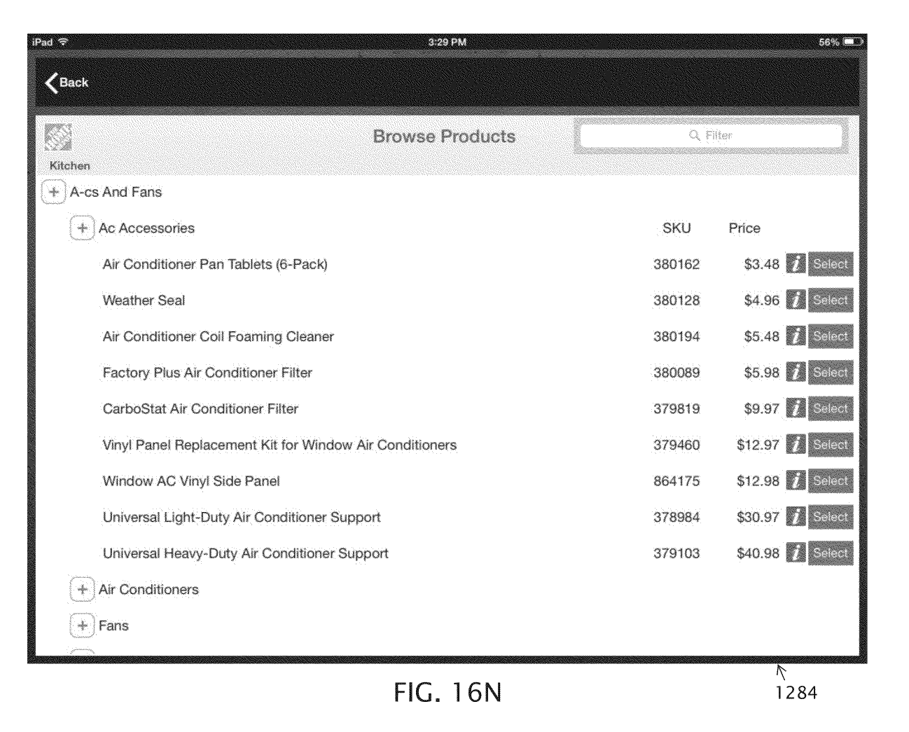

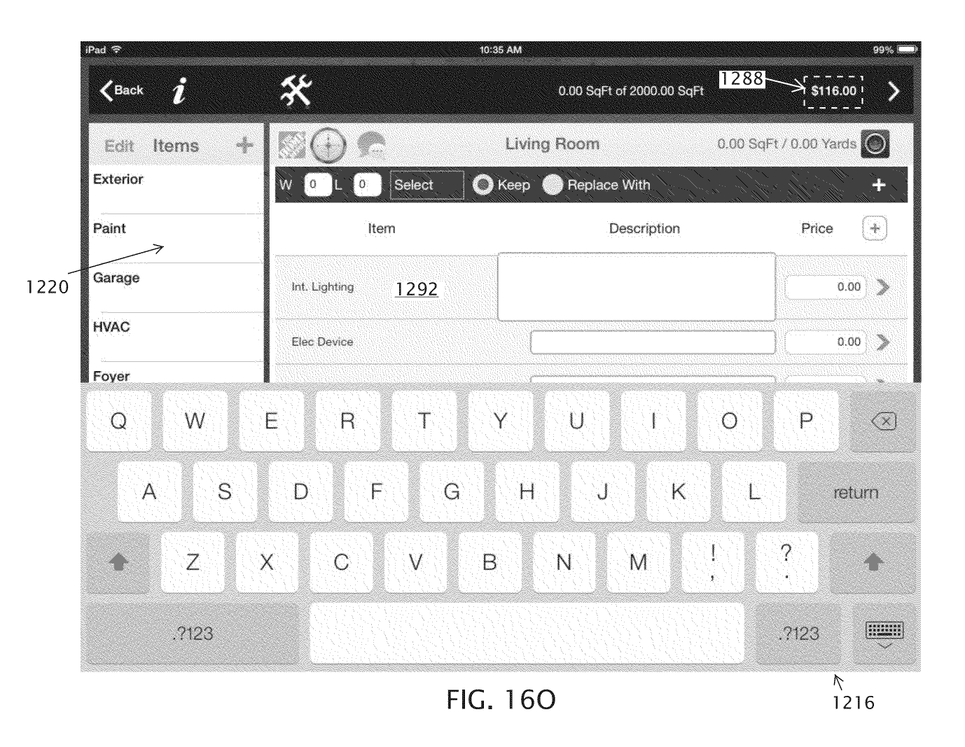

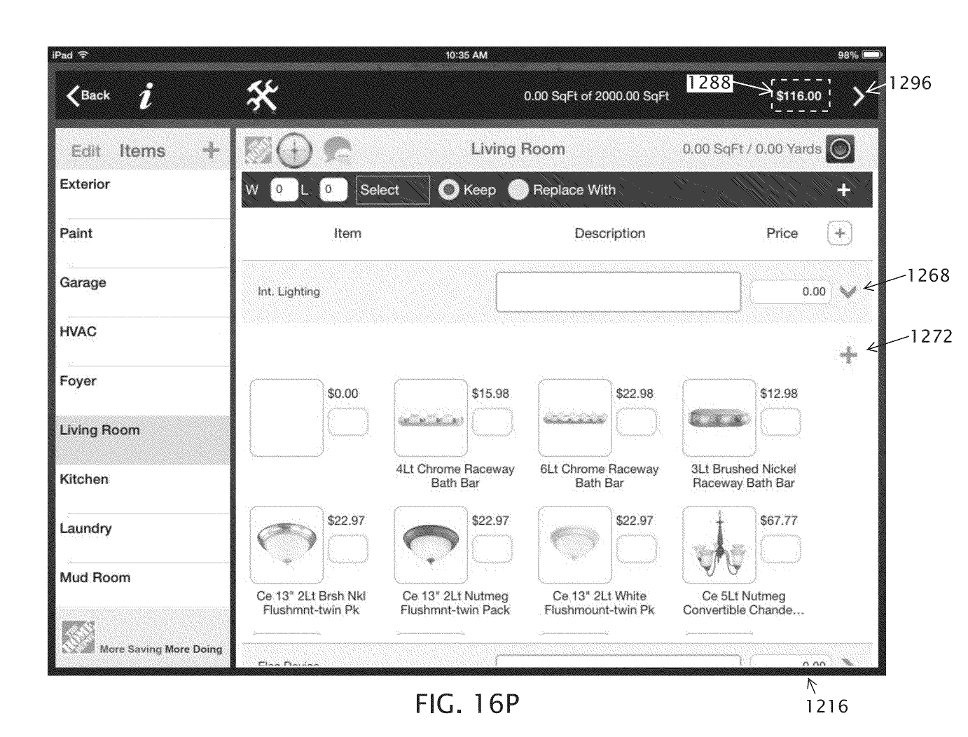

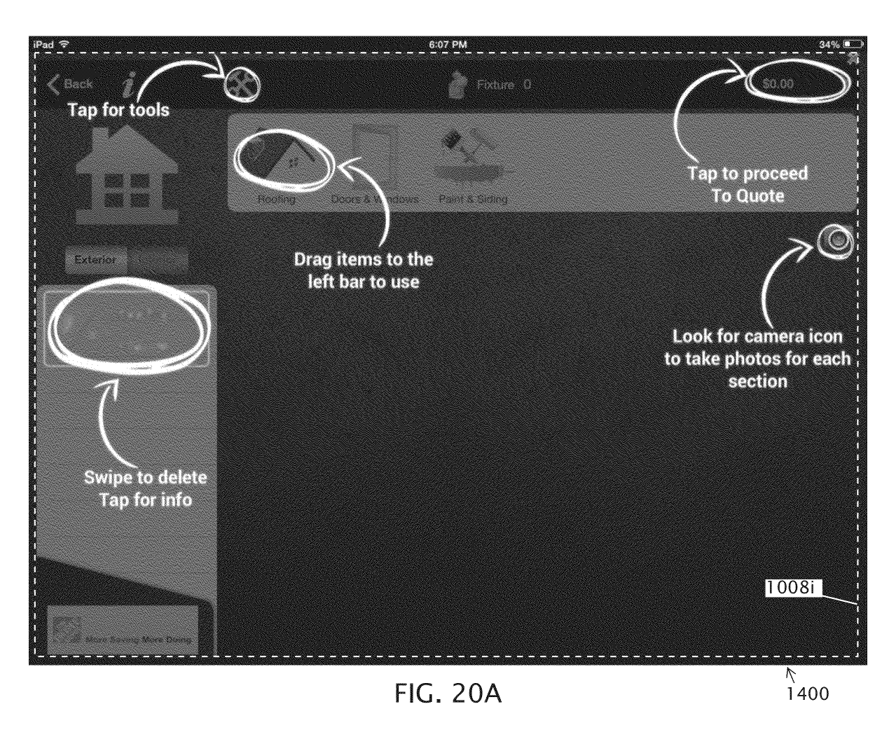

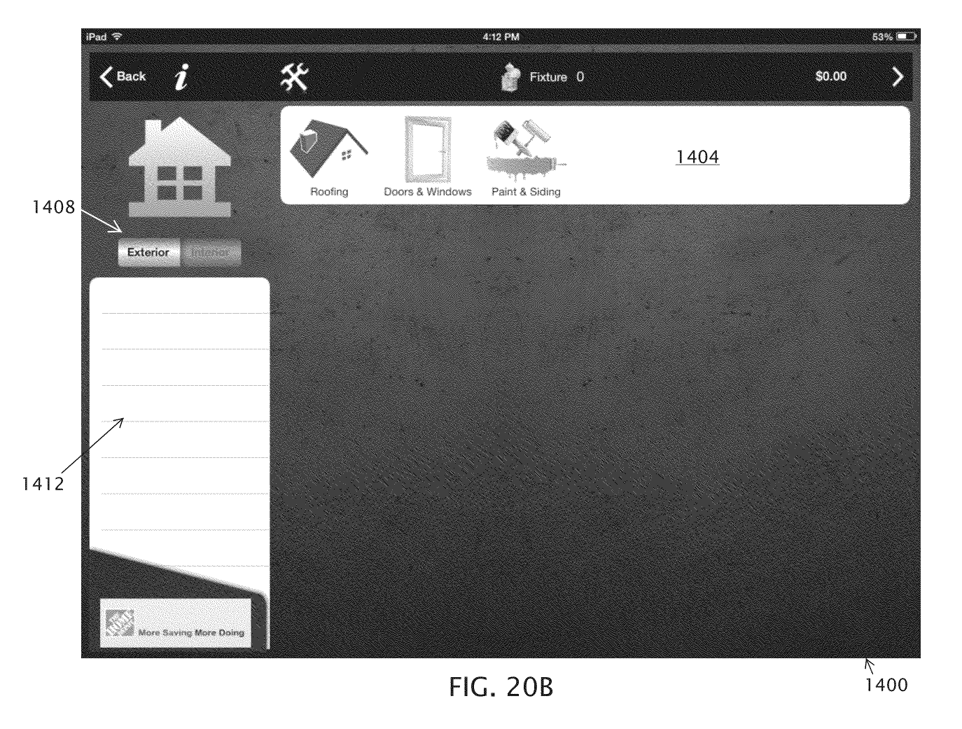

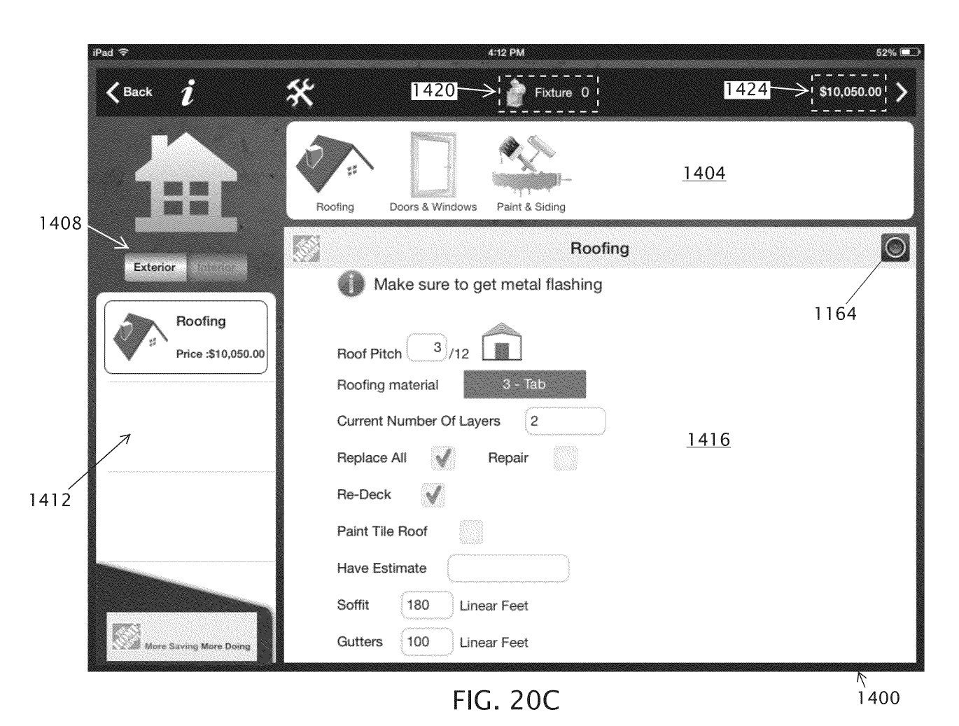

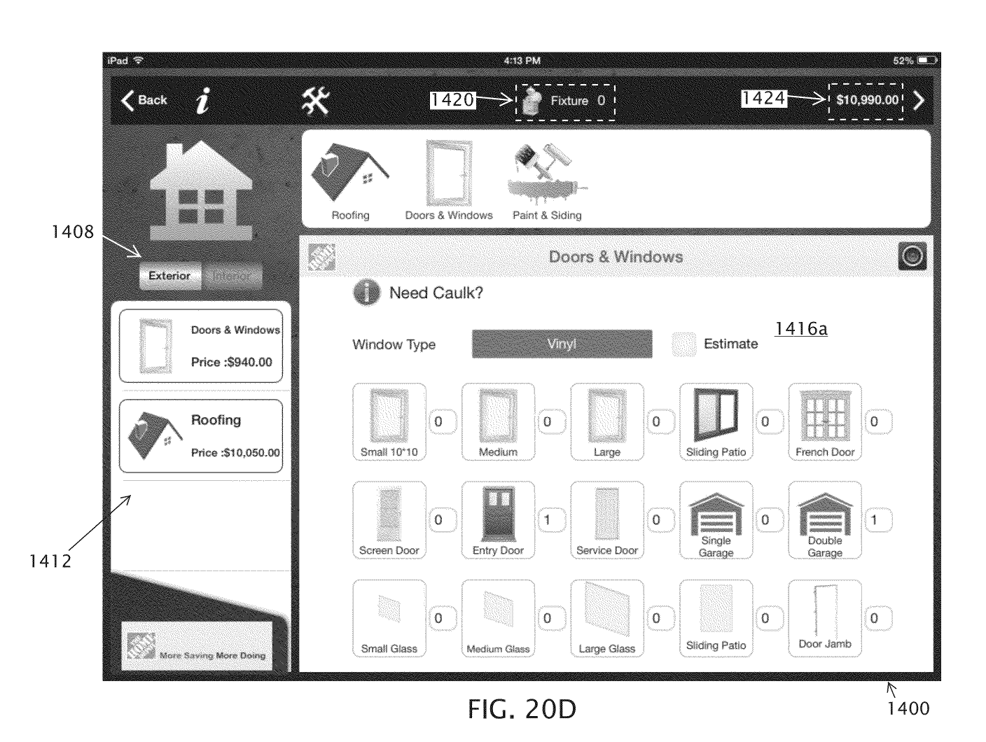

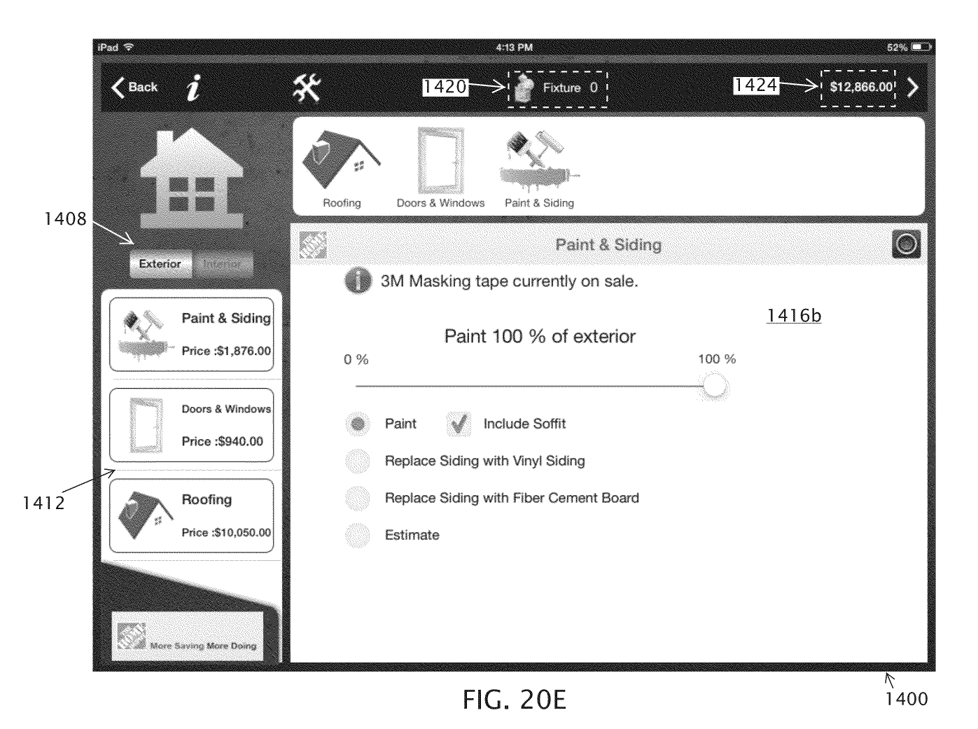

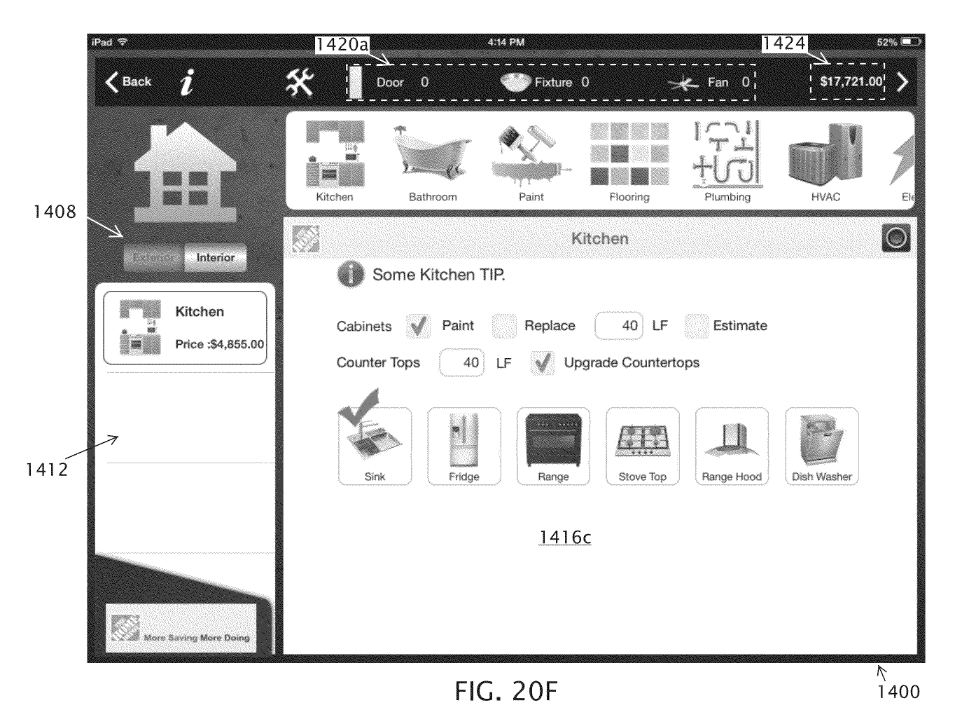

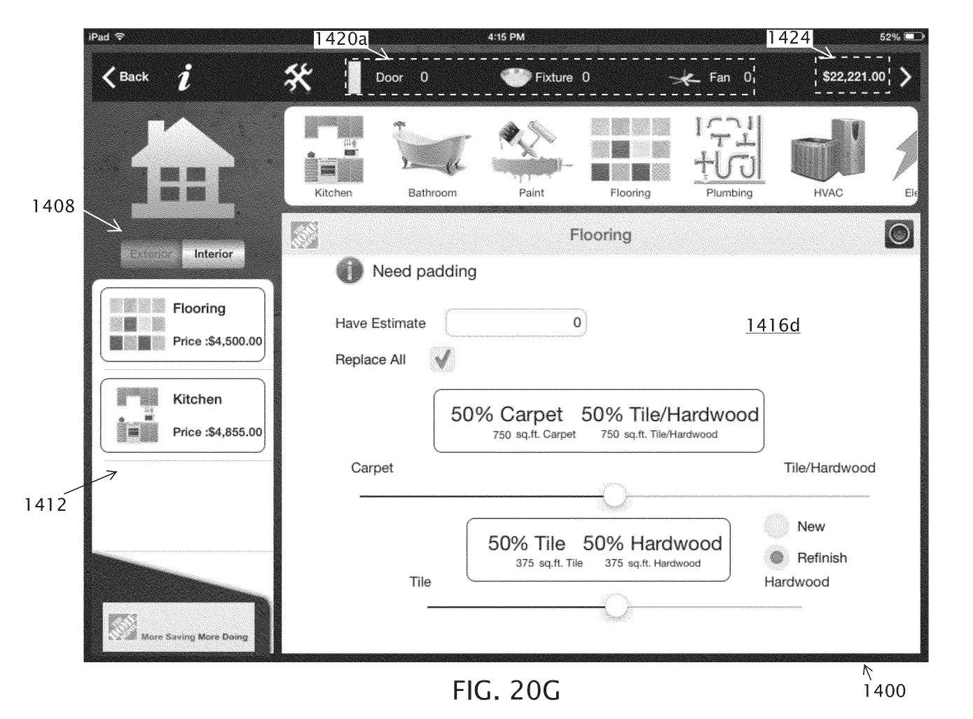

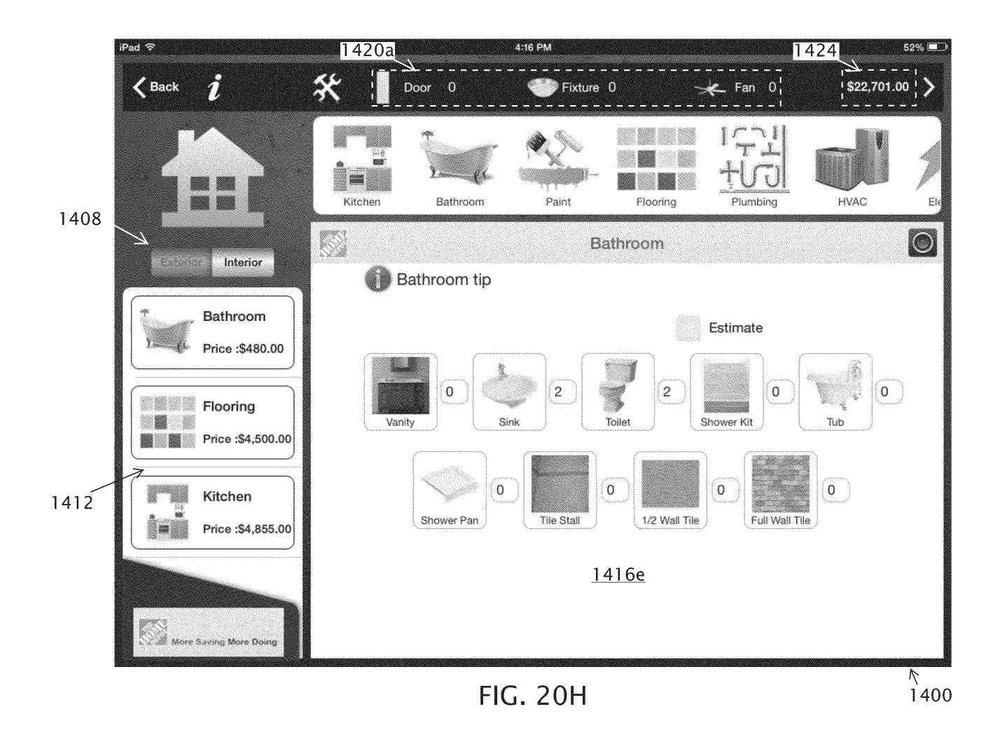

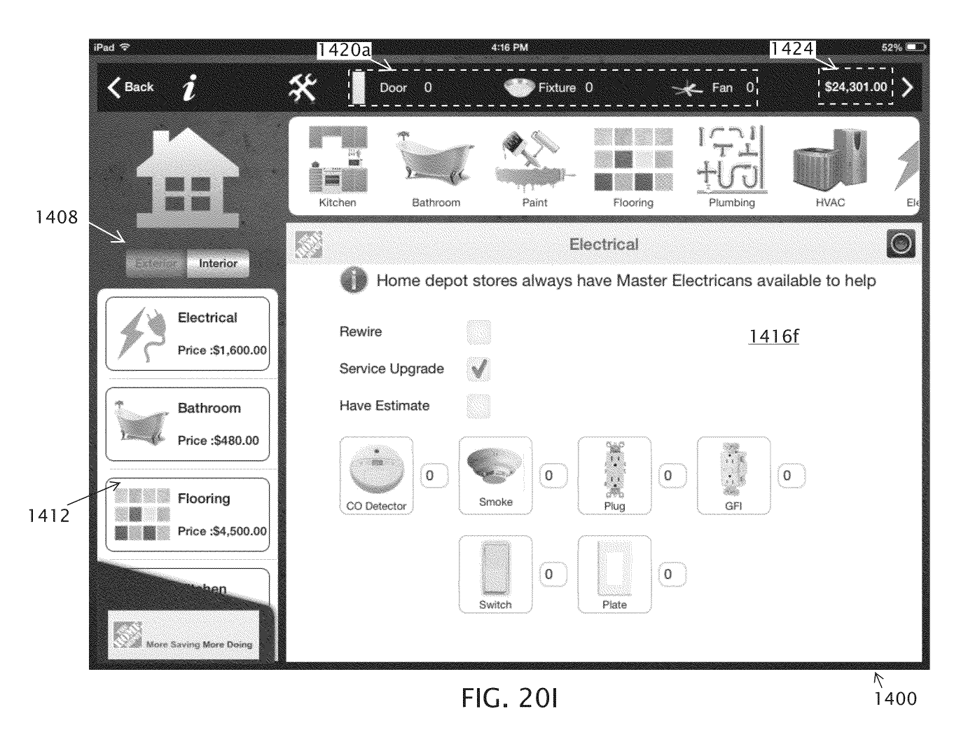

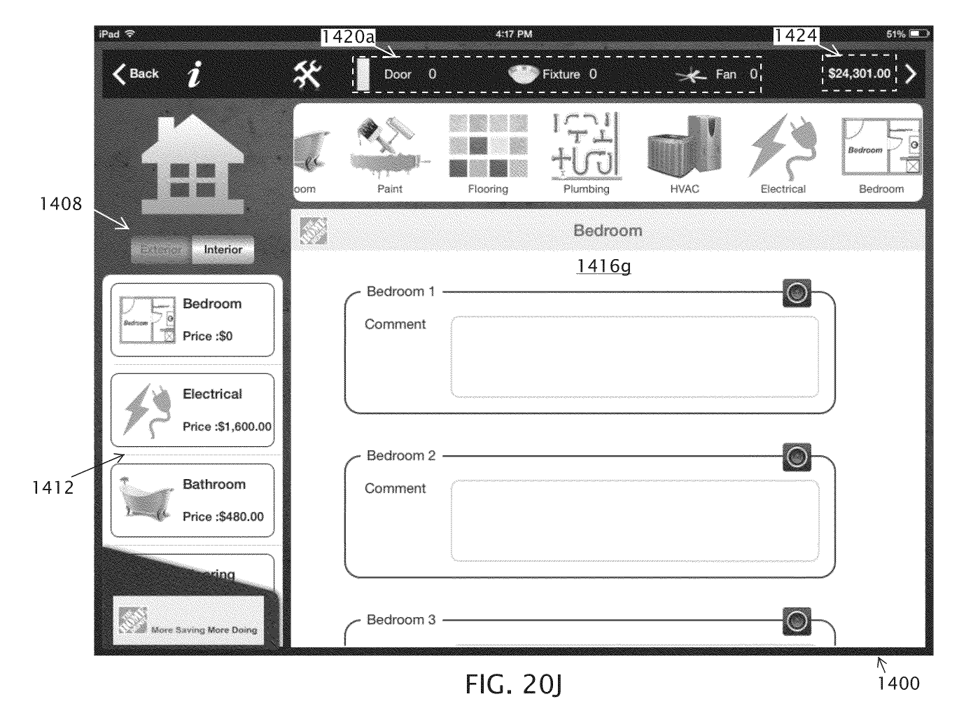

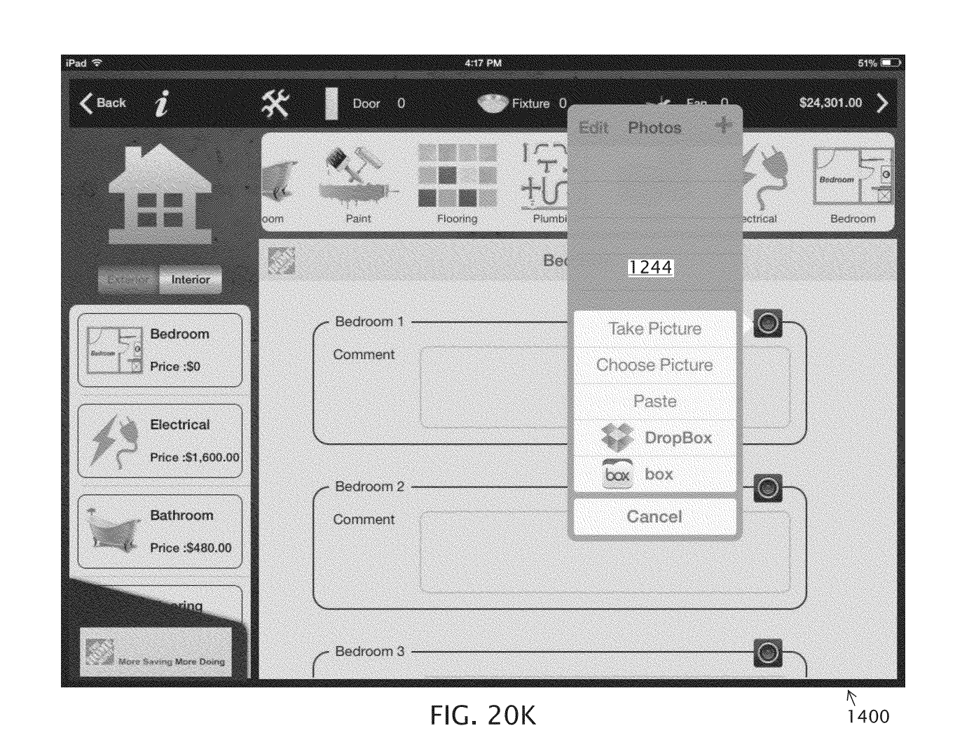

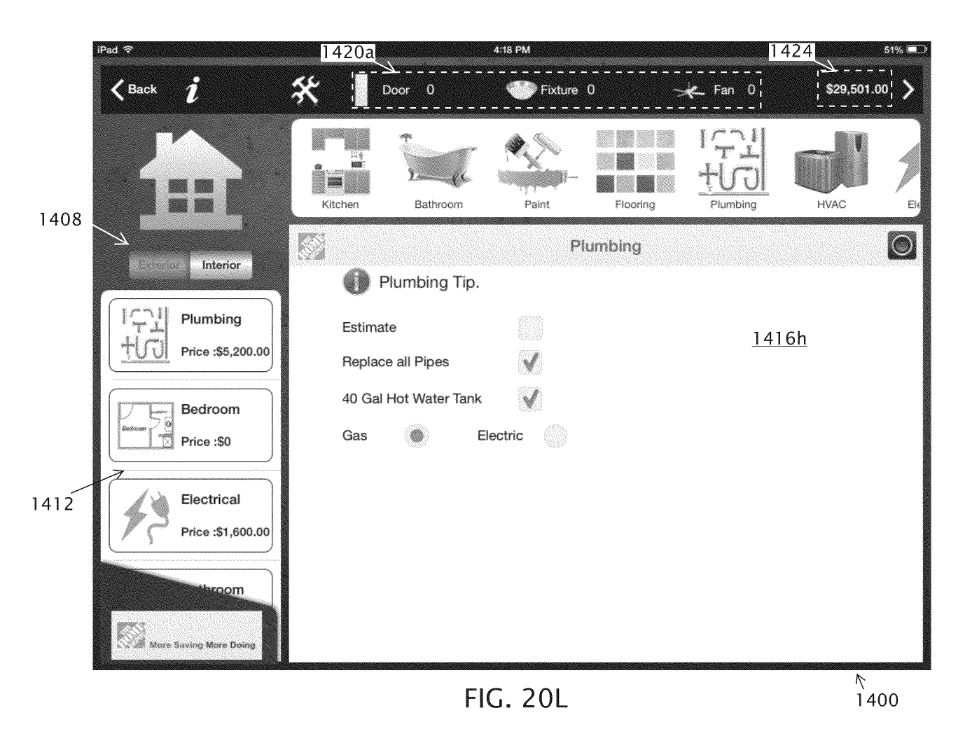

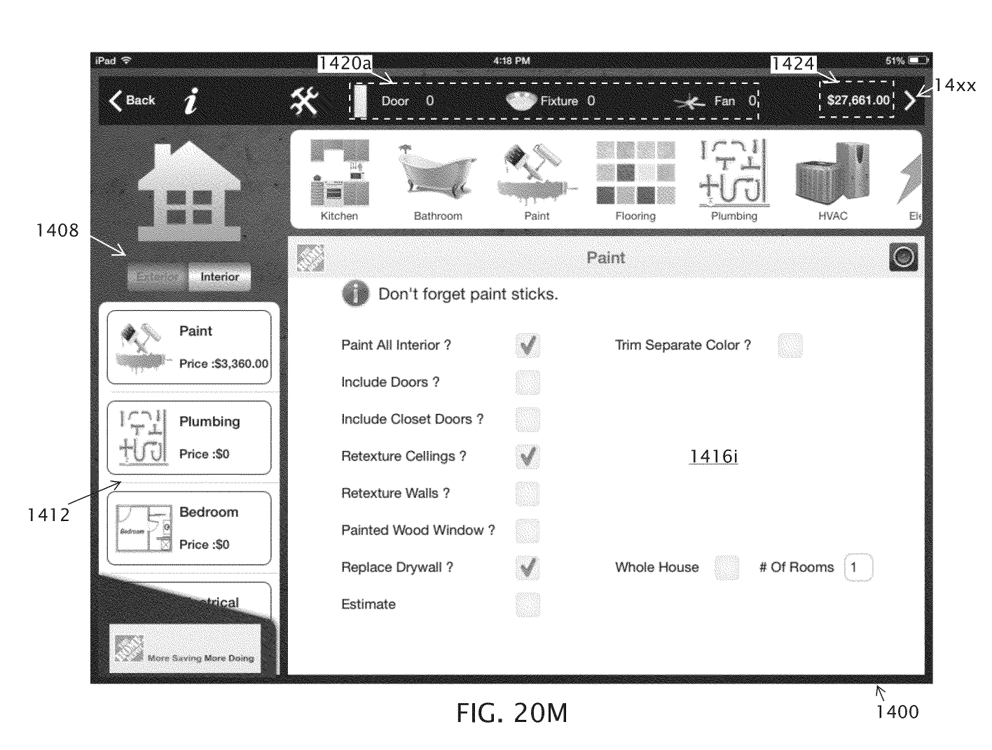

FIGS. 12A-12E illustrate an example of a property-editing screen 1072 through which sub-step 604 of entering and/or editing information in the property profile can be completed. An overlay 1008c is depicted in FIG. 12A that provides indicators of various icons and functions of property-editing screen 1072, as shown in more-detail in FIGS. 12B-12C. In the embodiment shown, property-editing screen 1072 includes a plurality of text boxes (e.g., text box 1112) corresponding to various pieces of information (e.g., project name, address, county, square footage, number of bedrooms, number of bathrooms, year built, garage size, approximate depth, approximate width, and general notes), as well as drop-down menus 1116 and 1120 configured to enable selection of home style (e.g., single story, 2 story, 3 story, tri-level, and/or the like) and exterior type (e.g., brick-front, brick-3 sides, brick-4 sides, cinder block, frame-aluminum siding, frame-asbestos siding, frame-vinyl siding, frame-wood siding, stucco, and/or the like), respectively. In this embodiment, screen 1072 also includes a check box to indicate whether the property has a basement and, if the radio button is checked, a further text box may be presented to a user to enter the square footage (area in square feet) of the basement. Similarly, where multiple profiles are defined in the end-user application (e.g., as described above), screen 1072 can further include a drop-down menu configured to enable the user to select which user profile to apply to the property. In the embodiment shown, screen 1072 also includes a “Restore” button 1124 that is selectable by a user to show backups of the property profile (e.g., in a pop up box 1128, as shown in FIG. 12D) and select and restore a backup of the property profile (e.g., to effectively undo unintended or undesired changes to the property profile) and/or of property walk information (e.g., as described in with reference to FIGS. 16A-16P and/or FIGS. 20A-20M).

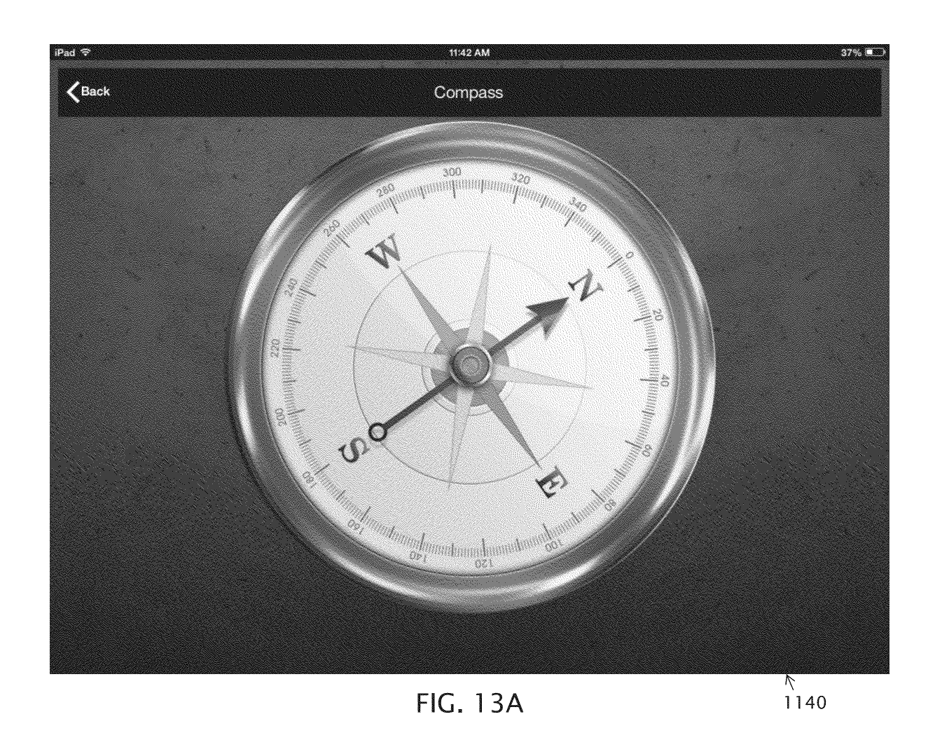

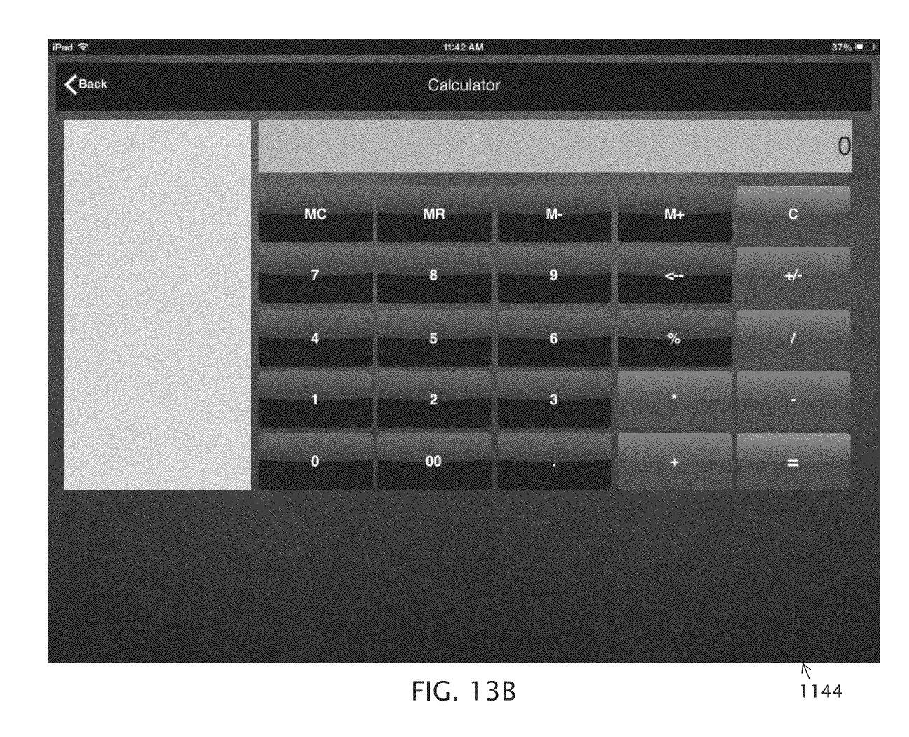

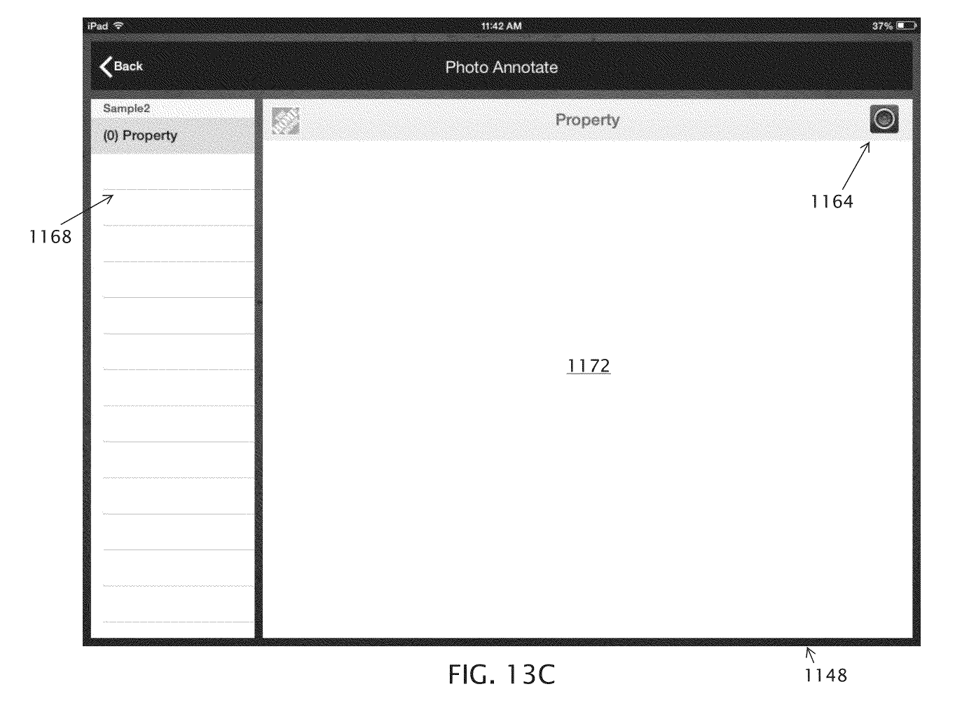

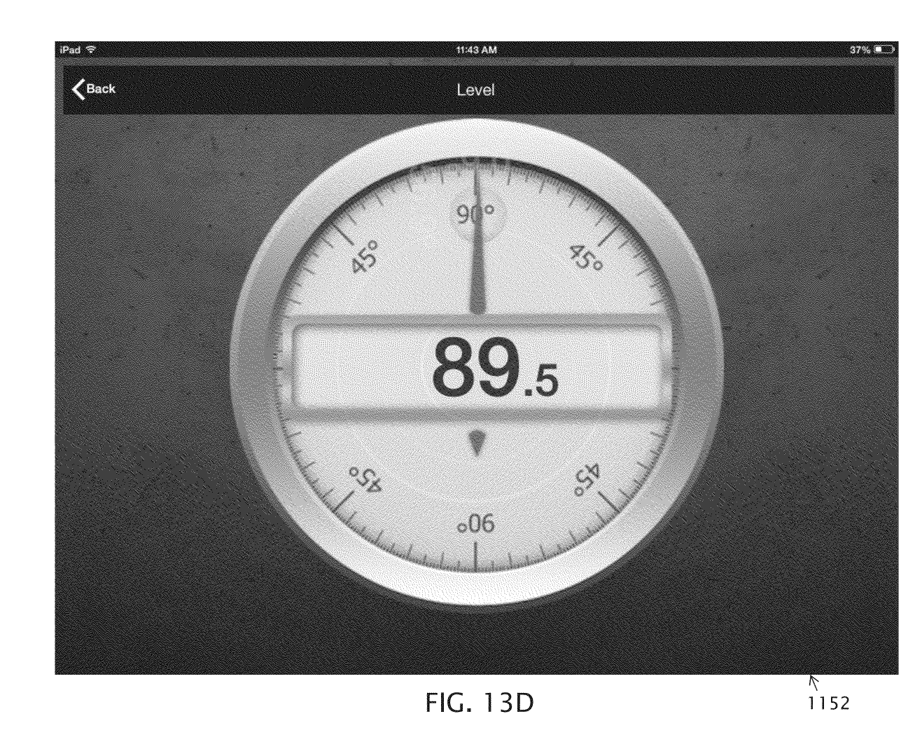

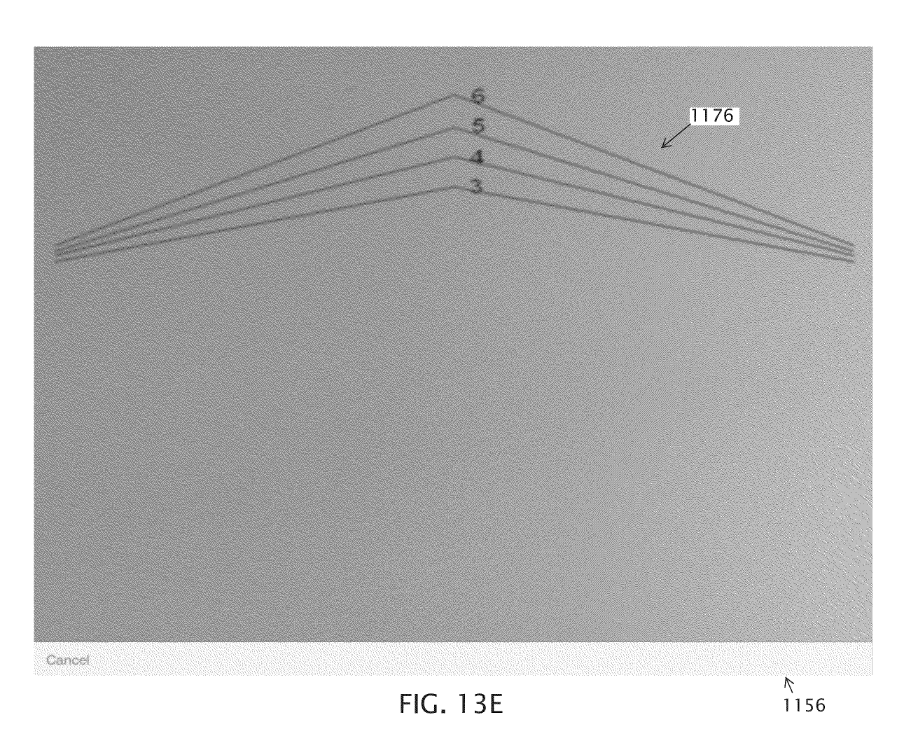

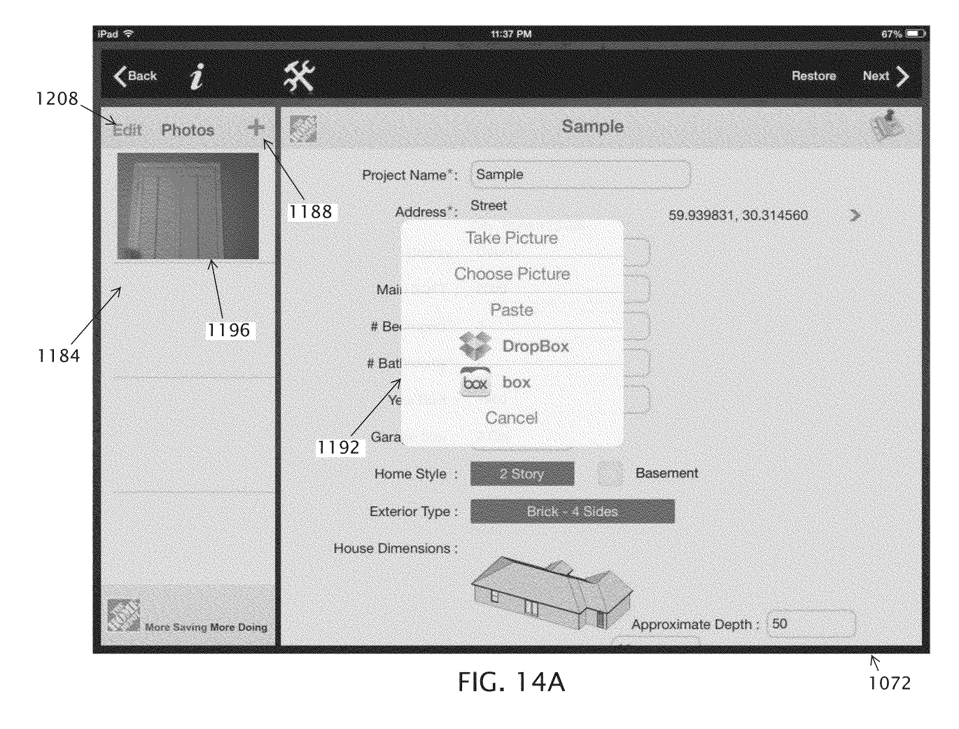

In the embodiment shown, property-editing screen 1072 also includes a tools icon 1132 that is selectable by a user to cause device 350 to present a pop-up window 1136 with a number of tools that can be selected by the user (FIG. 12E). For example, the tools can include a compass 1140 (as shown in FIG. 13A), a calculator 1144 (as shown in FIG. 13B), a photo annotation tool 1148 for adding notes to photographs that are associated with the property (as shown in FIG. 13C), a level tool 1152 (as shown in FIG. 13D), a roof pitch tool 1156 (as shown in FIG. 13E), and a photo-save tool 1160 to save all photos taken or associated with the end-user application to a different application (e.g., a photo gallery) that is associated with the camera of the device. Compass 1140, calculator 1144, photo-annotation tool 1148, and level 1152 are tools the individual implementation of which on a tablet computer will generally be understood by those of ordinary skill in the art. Photo-annotation tool or screen 1148 (FIG. 13C), for example, includes a camera icon 1164 that is selectable by a user to launch a camera screen to enable the user to capture an image with camera 358 of the device (FIG. 3B), a photo-management portion 1168 in which thumbnails of images can be displayed for selection by a user, and a primary portion 1172 within which images can be displayed for annotation. In the depicted embodiment, camera icon 1164 is included in a number of screens to enable a user to capture images to associate with the subject matter of a particular screen (e.g., an image of a portion of a property such as a bathroom).

In the depicted embodiment, roof pitch tool or screen 1156 (FIG. 13E) includes a depiction of an image (e.g., an image of the roof of a structure associated with a property profile) captured by camera 358 of the device and a plurality of lines 1176 (superimposed over the image) that are angled to correspond to possible roof pitches (e.g., roof pitches of x/12 where x=3, 4, 5, 6, as indicated in FIG. 13E) such that a user can identify the line most closely corresponding to the pitch of a roof, if any, depicted in the image.

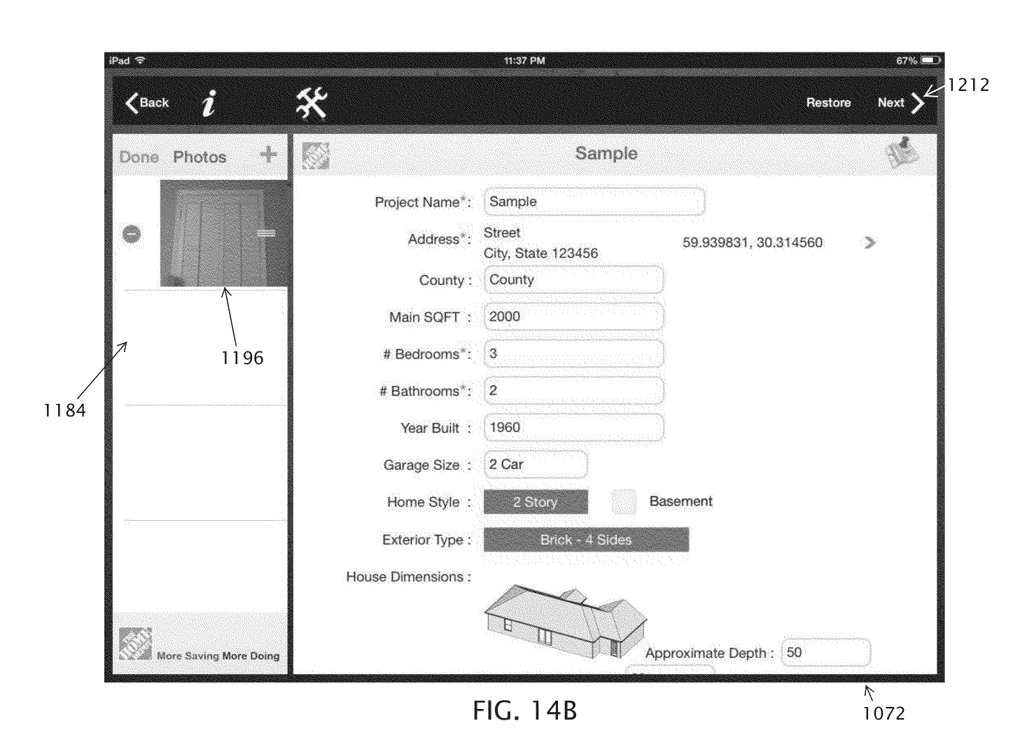

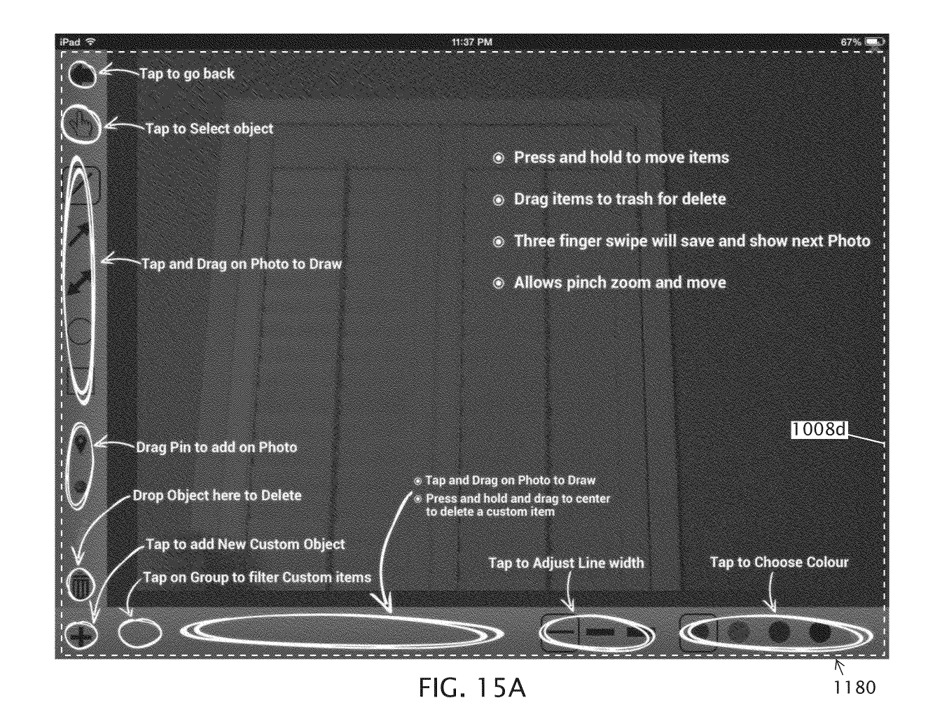

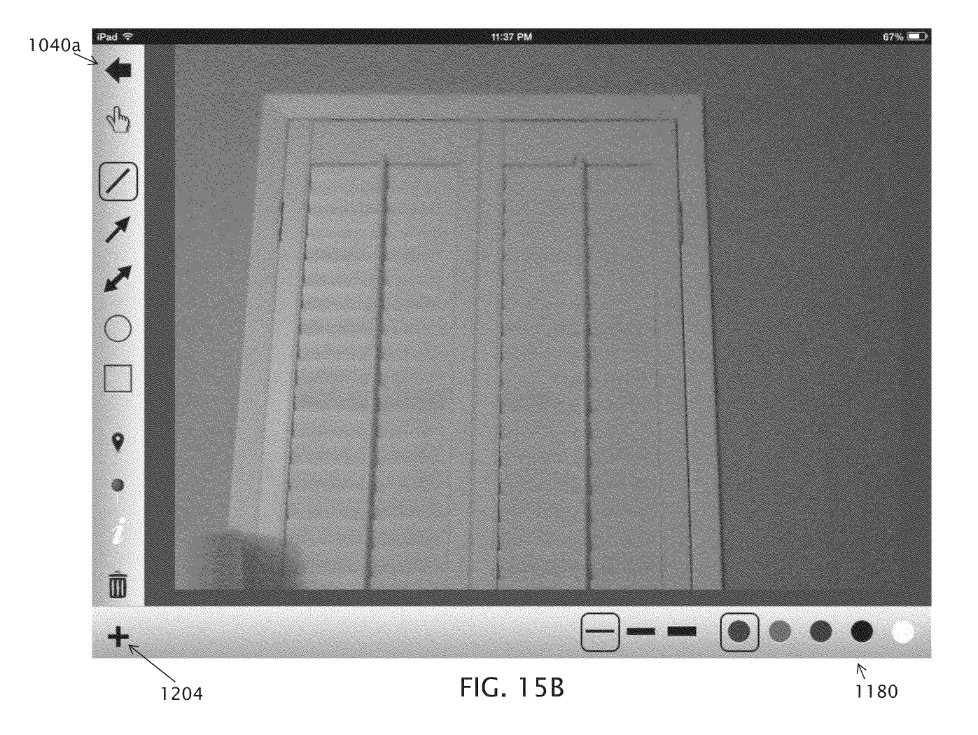

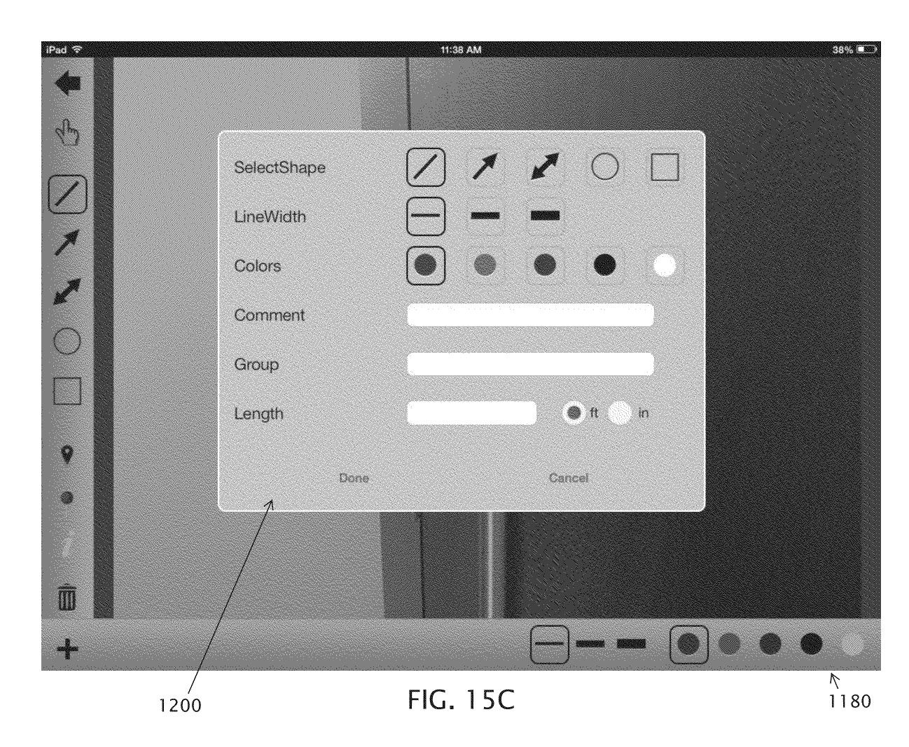

Referring now to FIGS. 14A-15C, FIGS. 14A-14B illustrate certain photo-management features of property-editing screen 1072 through which sub-step 608 of adding and/or editing photos of or otherwise associated with the property can be completed, and FIGS. 15A-15C depict a photo-editing screen 1180 with which images can be edited and/or annotated. In the embodiment shown, screen 1072 includes a photo-management section 1184 within which thumbnails of images can be displayed. In this embodiment, section 1184 includes a “+” icon 1188 that is selectable by a user to add an image. For example, selection of icon 1188 can cause device 350 to present to a user a pop-up window 1192 with a menu of options to take a picture with the camera of the device, choose a picture from a photo gallery of the device, paste a picture from the clipboard of the device, or download a picture from a cloud-based storage system such as DropBox. Once a photograph is added through one of the available sources, the photograph is displayed in photo-editing screen 1180 of FIGS. 15A-15C and can be edited and/or annotated using various functions indicated in overlay 1008d of FIG. 15A, the buttons for which are shown in FIG. 15B. FIG. 15C illustrates a pop-up menu 1200 for creating custom annotation objects that can include shapes and/or text, as indicated, and that can be accessed by selecting icon 1204. Once an image is annotated as desired, a user can select back button 1040a to return to property-editing screen 1072. As shown in FIG. 14B, the photograph (1196) is then displayed as a thumbnail in photograph-management section 1184. In this embodiment, section 1184 includes an “Edit” icon 1208 that can be selected to enable deletion (e.g., via selection of a circle to the left of the image) or re-ordering of images (by dragging and dropping the images) within section 1184. Once property profile information and any desired images or photographs are added, then step 404 can proceed to exit at 612 and method 400 can proceed to step 412. For example, in the embodiment shown, once the desired information is entered into screen 1072, the user can select “next” button 1212 (FIG. 14B) to proceed to the product-selection screens of FIGS. 16A-16P for the detailed walk flow selected at sub-step 512 depicted in FIG. 5 and check box 1066 depicted in FIG. 10B.

While functionality related to adding and/or editing user profiles and property profiles is, in the depicted embodiment, included in the end-user application; all or parts of such functionality may, in other embodiments, be included solely in the back-end application such that a user of the end-user application need only select a property profile and proceed to selecting products and/or tasks for the property.

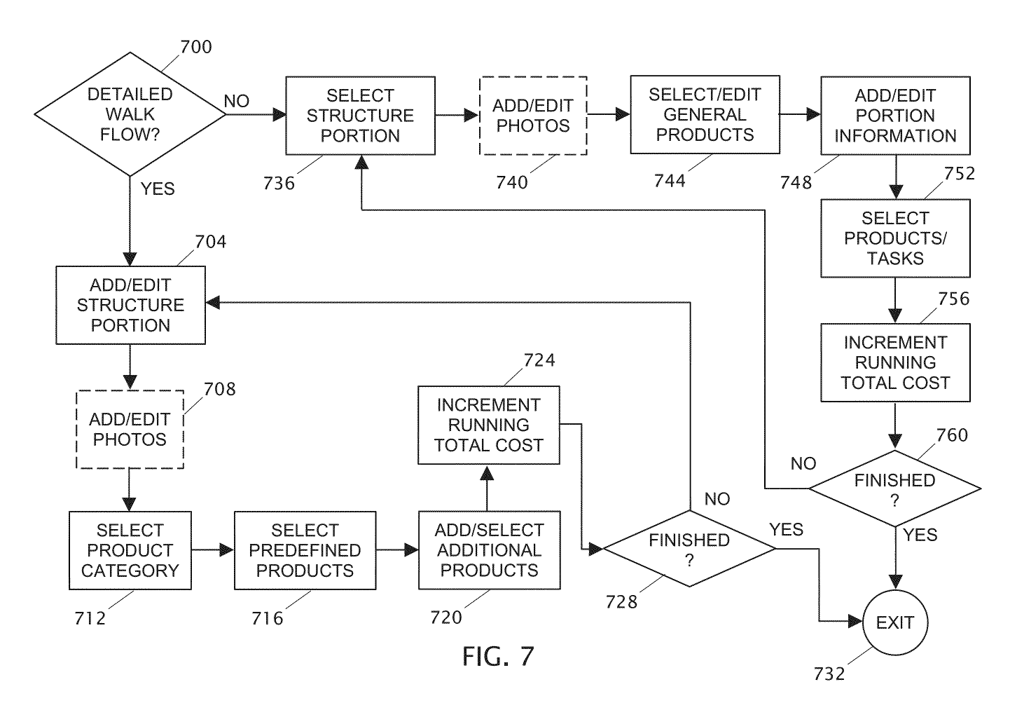

Referring now to FIGS. 7 and 16A-16P, FIG. 7 depicts a flowchart of sub-steps of one example of step 412 of selecting products and/or tasks, and FIGS. 16A-16P depict various product-selection screens through which step 412 of selecting products can be completed. As depicted in the embodiment of FIG. 7, step 412 can comprise a sub-step 700 of determining whether the user profile associated with the property requires a detailed walk flow. If so, the method proceeds to sub-step 704 of adding, editing, and/or selecting a group or structure portion, a sub-step 708 of adding and/or editing photos, a sub-step 712 of selecting an item or product category, a sub-step 716 of selecting predefined products and/or tasks, a sub-step 720 of adding and/or selecting additional products and/or tasks, a sub-step 724 of incrementing the running total cost estimate with the estimated costs associated with the products and/or tasks selected in sub-steps 716 and 720, and then proceeding to a sub-step 728 from which the method loops back to sub-step 704 if additional products are desired (the user has not yet finished evaluating the property).

FIGS. 16A-16L, 16O, and 16P depict a product-selection screen 1216 in various states. An overlay 1008e is depicted in FIG. 16A that provides indicators of various icons and functions of product-selection screen 1216, as shown in more-detail in FIGS. 16B-16L, 16O, and 16P. An example of sub-step 704 of adding, editing, and/or selecting groups or structure portions is illustrated in FIGS. 16B-16C. More particularly, in the depicted embodiment, screen 1216 includes a group-management section 1220 that includes a list of groups or structure portions (e.g., all or any subset of: exterior, paint, garage, HVAC, foyer, living room, kitchen, laundry, mud room, dining room, den/family room, wet bar, hallway, bedroom#, bathroom#, attic, basement, general construction items, and the like). In this embodiment, section 1220 further includes an “Edit” button 1224 that is selectable to place the list of groups into an editing mode in which the names of the groups are displayed in text boxes and are editable by a user (FIG. 16B), and in which the groups can be re-ordered by dragging and dropping individual groups (e.g., “Exterior”) within the list. In this embodiment, section 1220 also includes a “+” icon 1228 that is selectable to open a pop-up window 1232 (as shown in FIG. 16C) with available groups for selection to be added to the list in section 1220. Once the list of groups or structure portions in group-management section 1220 is as-desired, a user can select a desired group for which to enter notes and/or select products and/or tasks. Section 1220 thus provides an input region to facilitate sub-step 712 of selecting a group or structure portion. In the embodiment shown, screen 1216 further includes a notes icon 1236 that is selectable to cause device 350 to present a pop-up window 1240 (as shown in FIG. 16D) having a text box into which a notes can be entered about the particular group or structure portion (e.g., “Exterior) that has been selected in group-management section 1220.

FIGS. 16E-16G depict various features of product-selection screen 1216 with which sub-step 708 of adding and/or editing photos can be completed. As shown, the depicted embodiment of screen 1216 includes camera icon 1164 (described above with reference to FIG. 13C) that is selectable to open a pop-up window 1244 which is substantially identical in function and components to photo-management section 1184 of property-management screen 1072, as described above with reference to FIGS. 14A-14B and 15A-15C.

In the embodiment shown, screen 1216 provides a user interface that includes a plurality of input portions each corresponding to a different group or structure portion that listed in group-management section 1220. For example, FIGS. 16B and 16H-16J depict an input portion 1248 (IFG. 16B) that includes a flooring module or row 1252 and a plurality of additional item or product category rows (e.g., 1256) each corresponding to different item or product category (e.g., roof, gutter, ventilation, facia/trim, siding, exterior door, door hardware, moulding, caulk, sealant, exterior lighting, electrical device, deck, fence, misc. exterior, an open or blank row that can be completed or designated by an end user, and/or the like). In the embodiment shown, input portion 1248 (and other input portions associated with other groups or structure portion listed in section 1220) also includes a “+” icon 1260 that is selectable to present a pop-up window (not shown) from which a user may choose to add to input portion 1248 any additional items or product categories that are defined in the back-end application but not displayed by default (for a “Display Always” option is not selected in the back-end application).

In this embodiment, flooring module or row 1252 includes text boxes (FIG. 16J) to enter with width “W” and length “L” of flooring associated with a particular group or structure portion (e.g., exterior, living room, kitchen, or the like), as well as radio buttons to indicate whether the flooring should be kept or replaced, and drop-down menus to select the type of existing flooring (FIG. 16H) and the type of replacement flooring (FIG. 16I) to be used to replace the existing flooring. Module 1252 thus provides an input region to facilitate sub-step 716 of selecting predefined products and/or tasks (e.g., roof replacement, which may include both a product and a task).

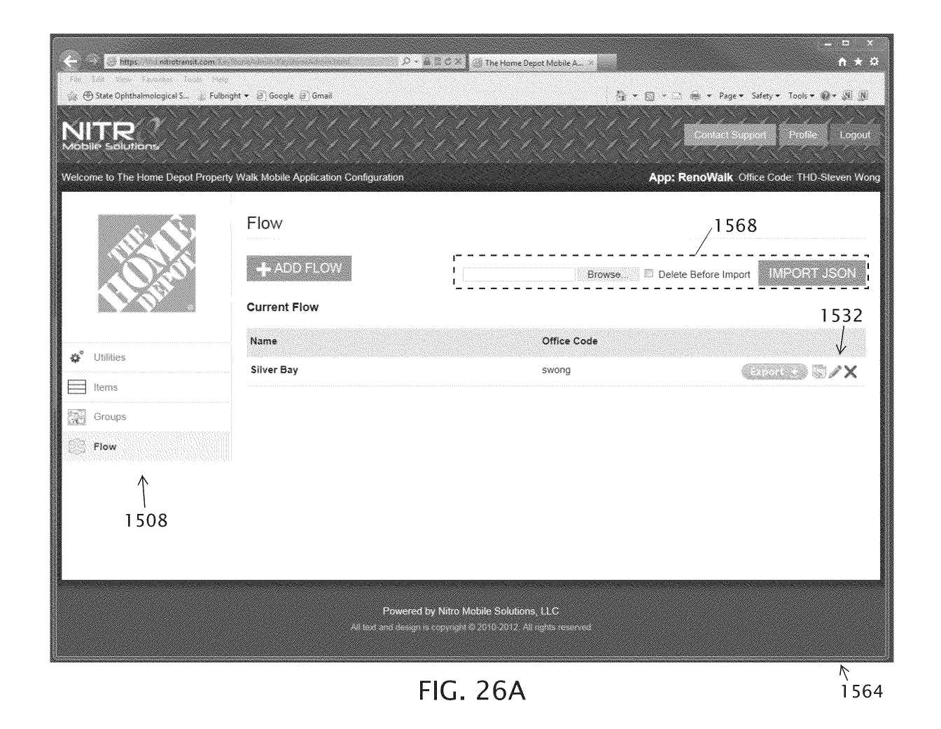

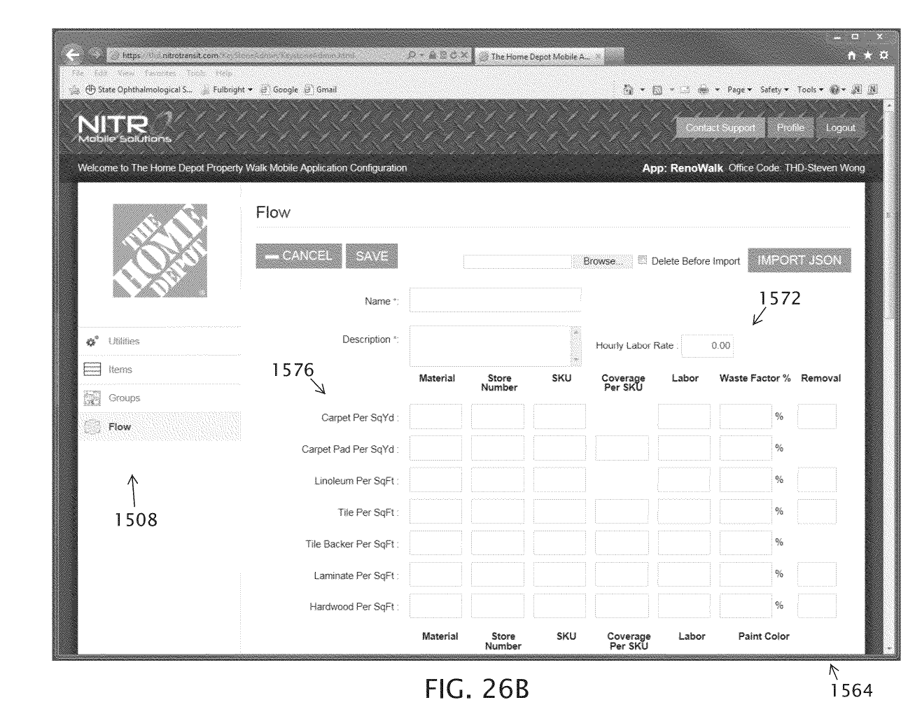

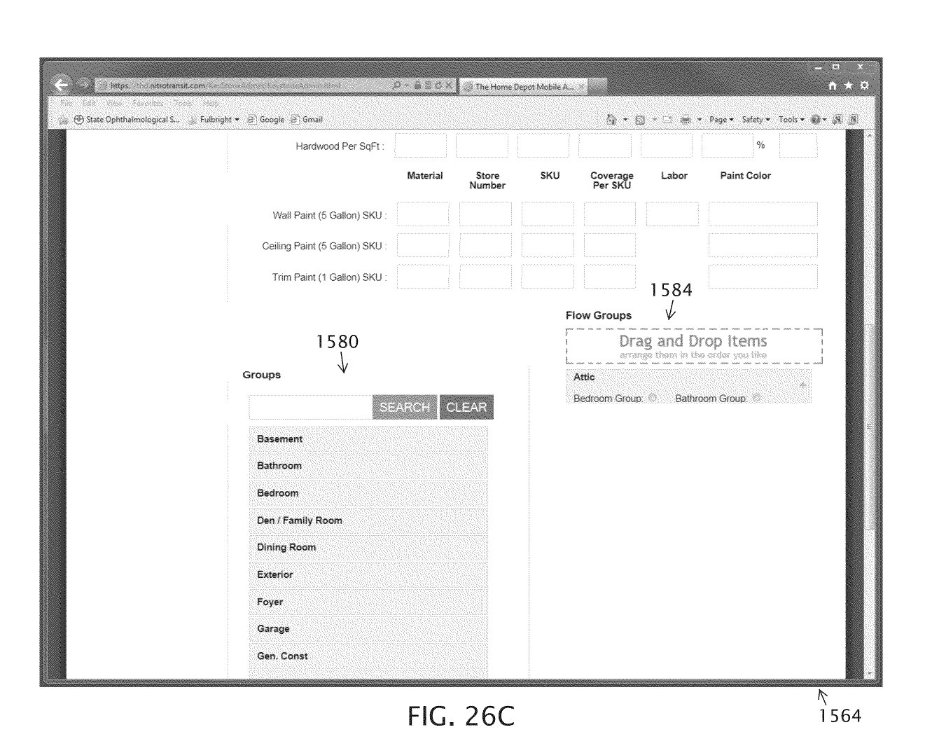

Item or category row 1256 (FIG. 16B), which corresponds to roof in the depicted embodiment, includes a text box to insert a number of units (e.g., square yards or “squares”) of roof material that need to be replaced, repaired, or overlayed and up/down arrow buttons to enable a user to either tap the text box and type in a number or to use the up/down arrow buttons to select the desired number of units. A larger text box under the “Description” heading is presented to enable a user to add notes related to the item, and an additional, smaller text box is presented under the “Price” heading. The end-user application can be configured to automatically populate the price text box on the right based on the number of units selected in the quantity text box at the left of row 1256 and a default unit price or a unit price provided to the back-end application (e.g., including product costs and/or labor costs, examples of which are described in more detail below with reference to FIGS. 26A-26C). Row 1256 thus provides an input region to facilitate sub-step 716 of selecting predefined products and/or tasks (e.g., roof replacement, which may include both a product and a task).

In the embodiment shown, product-selection screen 1216 also includes additional input rows that are each expandable to facilitate a user's selection of multiple products and/or tasks for the corresponding item or product category. For example, row 1264 (FIG. 16K), which corresponds to gutter in the depicted embodiment, includes a “Description” text box and “Price” text box as described for row 1248, but row 1264 also includes an arrow “>” icon 1268 that is selectable to expand row 1264 as shown in FIG. 16K. In this embodiment, when icon 1268 is selected by a user, the icon rotates such that the arrow points down to indicate that the row is in an expanded state, as in FIG. 16K. As illustrated, in its expanded state, row 1264 includes images corresponding to a plurality of products that are associated with the item or product category, and a text box next to each of the products to facilitate user input of a number of units needed for any desired ones of the presented products. Row 1264 thus provides an input region to facilitate sub-step 716 of selecting predefined products and/or tasks (e.g., roof replacement, which may include both a product and a task).

Additionally, in its expanded state, row 1264 includes a “+” icon 1272 that is selectable by a user to add additional products to row 1264 and thereby associate the products with the item or product category associated that is with the row. For example, in this embodiment, user selection of icon 1272 causes device 350 to present a pop-up window 1276 that includes a text box to enable a user to search available products and a “Browse>>” link to enable the user to browse available products, as shown in FIG. 16L. If an internet connection is available, these search and browse functions may allow a user to search and browse the entire product selection of the preferred store identified in the user profile associated with the property; if an internet connection is not available, these search and browse functions may be limited to products that were predefined and downloaded to device 350 the last time an internet connection was available. In the depicted embodiment, if a keyword search is performed (e.g., for the word “gutter”) in box 1276, then the end-user application causes device 350 to present a product search screen 1280 as shown in FIG. 16M. Screen 1280 can present the products located in response to the search in rows, as shown, along with “i” icons that are selectable by a user to see an image of or otherwise associated with each product and “Select” buttons that are selectable by a user to associate each product with the input row (e.g., 1264). If instead, the browse button is selected in box 1276, then the end-user application causes device 350 to present a brows-products screen 1284, as shown in FIG. 16N. Screen 1284 can present a hierarchical display of available products by group or structure portion (e.g., Kitchen), product category (e.g., A-cs And Fans), and sub-categories (e.g., Ac Accessories), each of which can be expanded by selecting the “+” icons on the left, as shown in FIG. 16N. Once a user has expanded a desired sub-category, the products in the sub-category are presented in rows, as shown, along with “i” icons that are selectable by a user to see an image of or otherwise associated with each product and “Select” buttons that are selectable by a user to associate each product with the input row (e.g., 1264). Once one or more additional products are associated with the input portion (e.g., 1264), such additional products can be selected in similar fashion to the predefined products depicted in FIG. 16K.

In this embodiment, the end-user application is configured to monitor inputs to the text boxes, radio buttons, and drop down menus of flooring module 1252 and the remaining item or product category rows (e.g., 1256) and perform sub-step 724 by updating a running cost total 1288 (FIG. 16O) which, in the depicted embodiment, includes the sum of the Price amounts for all item or product categories of each group or structure portion (i.e., the sum of costs for all of the groups or structure portions of section 1220 for which products and/or tasks have been selected.

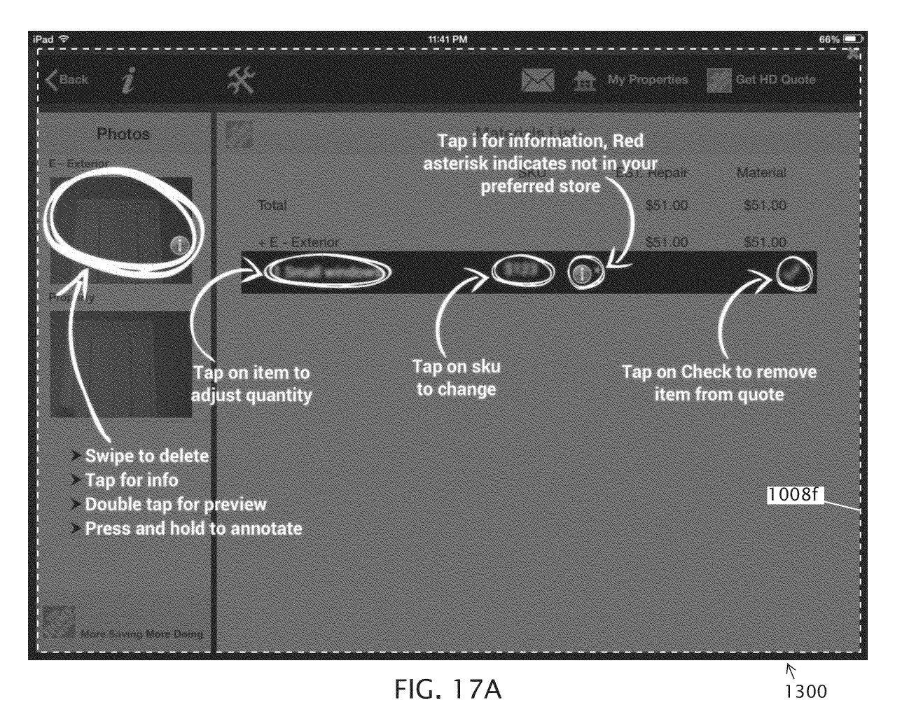

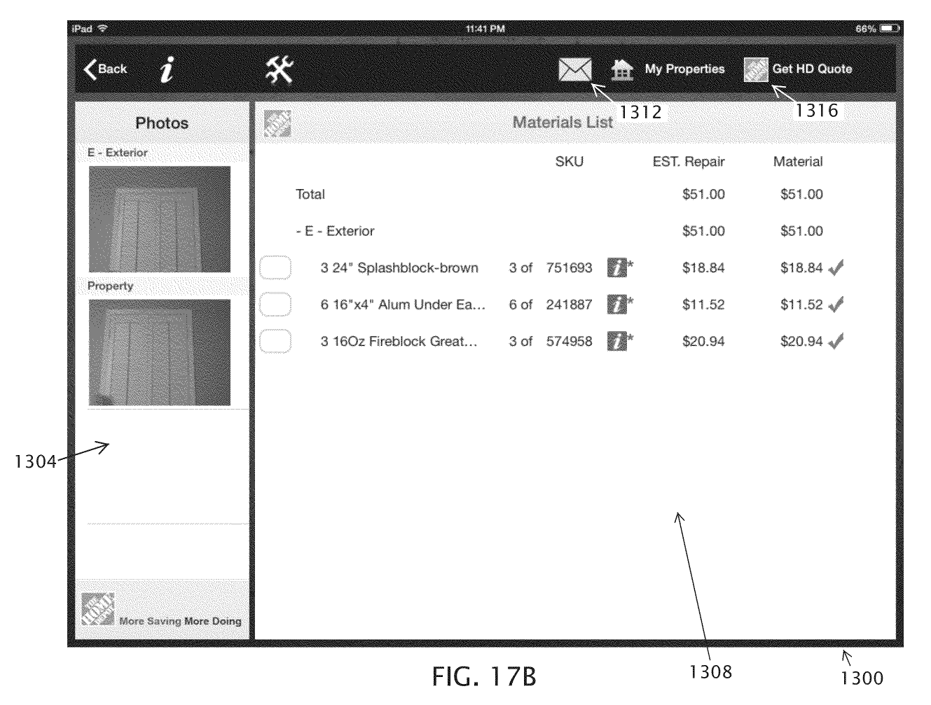

In most instances, products associated with multiple items or product categories will be desired for each group or product structure. As such, during a typical “walk” of a property, a user may select, for a single group or structure portion (e.g., “Exterior”) products and/or tasks for a first item or product category (e.g., flooring as depicted in FIGS. 16H-16J) and may also select products and/or tasks for a second item or product category (e.g., “gutter” as depicted in FIGS. 16K-16L. Likewise, during a typical “walk” of a property, a user may also select products and/or tasks associated with different groups or structure portions. For example, a user that selects “Exterior” products and/or tasks as depicted in FIGS. 16B-16L may also select “Living Room” products, for which an input portion 1292 is depicted in FIGS. 16O and 16P. In such an instance, once the user selects the desired “Exterior” products, sub-step 728 (FIG. 7) of determining whether the “walk” is finished would be answered in the negative and the process would loop back to sub-step 704 of adding, editing, and/or selecting a group or structure portion. To reach the “Living Room” input portion depicted in FIG. 16P, the user would select in sub-step 704 the “Living Room” group in group-management section 1220, and then in sub-step 708 would, if desired, add and/or edit any photos associated with the corresponding living room of the property. In sub-step 712, the user would then select a desired item or product category (e.g., “Interior Lighting” row 1292, as shown in FIGS. 16O and 16P), and proceed with sub-steps 716 and 720 to select predefined and/or additional products. As illustrated in FIGS. 16O and 16P row 1292 is substantially similar in form and function to row 1264, described above, with the exception that the products associated with row 1292 and depicted in FIG. 16P relate to interior lighting rather than gutters. Once evaluation (the “walk”) of the property is complete and no additional products are desired (the user has completed evaluating the property), such that step 412 exits at 732, as depicted in FIG. 7, method 400 can proceed to step 416 of generating and/or editing a materials list for a property. More particularly, in the depicted embodiment, the user can select arrow “>” icon 1296 to proceed to materials list screen 1300 of FIGS. 17A-17B.

FIGS. 17A-17B illustrate an example of a materials-list screen 1300 through which step 416 of generating and/or editing a materials list can be completed. An overlay 1008f is depicted in FIG. 17A that provides indicators of various icons and functions of materials-list screen 1300, as shown in more-detail in FIG. 17B. In the embodiment shown, materials-list screen 1300 includes a photo-management section 1304 that is substantially identical in function and components to photo-management section 1184 of property-management screen 1072, as described above with reference to FIGS. 14A-14B and 15A-15C. In this embodiment, screen 1300 also includes a primary display portion 1308 within which a list is presented of products and/or tasks selected for the property. In the depicted embodiment, the list includes a hierarchical display of selected products and/or tasks by group or structure portion (e.g., Exterior) each of which can be expanded by selecting the “+” icons on the left (which converts the “+” icon to a “−” icon, as shown in FIG. 17B). Once a user has expanded a desired group, the products in the group are presented in rows, as shown, along with “i” icons that are selectable by a user to see an image of or otherwise associated with each product and a text box at the left of each product within which a user can modify the quantity of the product that is needed. In this embodiment, each product and/or task includes two price or cost columns: a first “Estimated Repair” column that includes the product or material cost as well as any labor costs that have been associated with a product or task in the back-end application (e.g., examples of which are described in more detail below with reference to FIGS. 26A-26C), and a second “Material” column that includes only the product or material cost. In the embodiment shown, screen 1300 also includes a mail icon 1312 that is selectable by a user to email the material list, such as, for example, to a supervisor for review and approval before the material list is submitted to the supplier (e.g., The Home Depot) for a quote and/or fulfillment. In this embodiment, screen 1300 also includes a Quote icon or button 1316 that is selectable by a user to submit the material list to the supplier (e.g., The Home Depot) for a quote and/or fulfillment and thereby complete step 420 of requesting a quote.

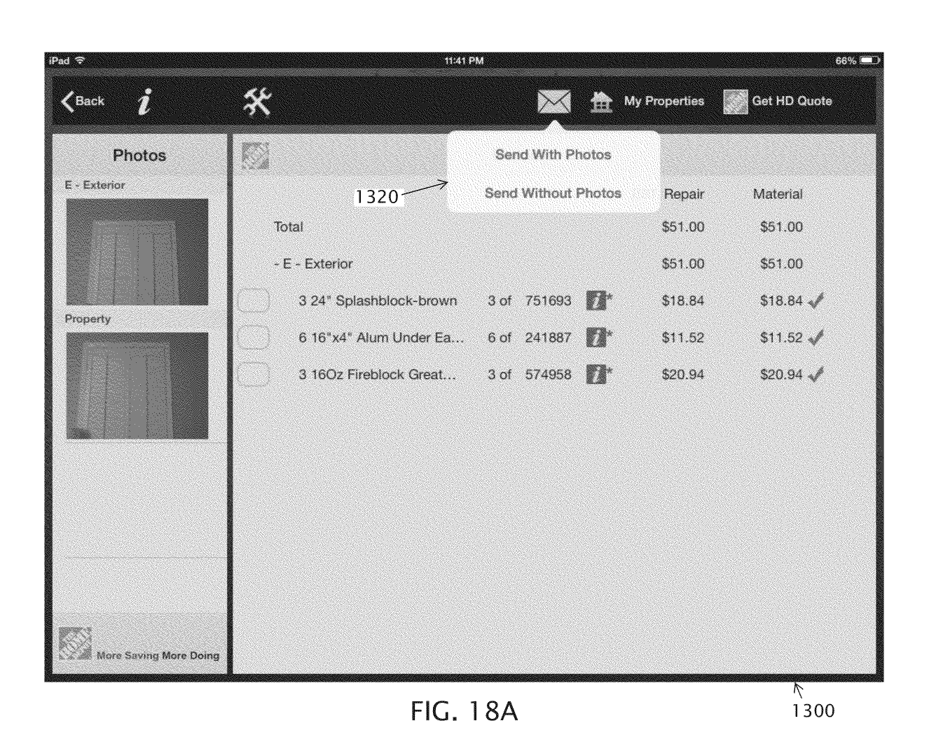

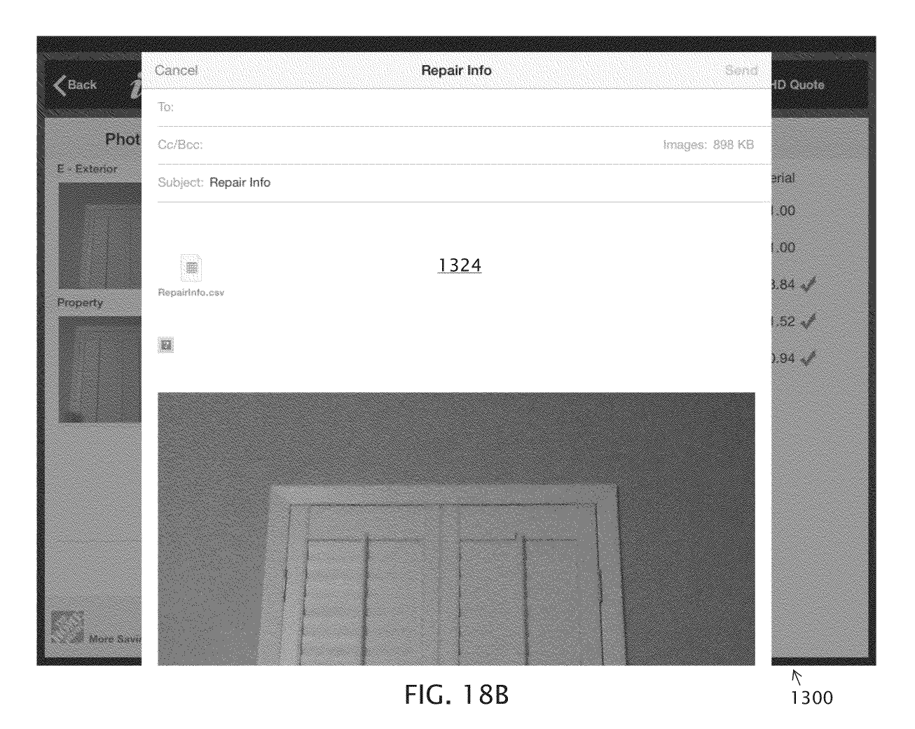

As shown in FIG. 18A, if mail icon 1312 is selected by a user, the end-user application causes device 350 to present a pop-up window 1320 with options to send the material list with or without photos. FIG. 18B illustrates a draft email message 1324 that is generated when the “Send With Photos” option is selected. As shown, message 1324 includes a .csv file (other embodiments may use other known file formats, such as .txt or .xls) with the material list and including for each of the selected products a unique identifier (e.g., a SKU) corresponding to a product record of the supplier. In some embodiments, message 1324 may be used to submit the materials list to the supplier (e.g., a store of a supplier) to request a quote and thereby complete step 420 of requesting a quote. In some embodiments, the end-user application is configured such that only groups or structure elements that have been expanded or otherwise selected on materials-list screen 1300 are included in the materials list that is generated when email icon 1316 is selected. In such embodiments, materials lists for only certain groups or structure portions can be generated for specific sub-contractors. For example, a plumbing materials list can be generated with only those of selected products and/or tasks that are associated with the plumbing group and email message 1324 can be addressed to a plumbing contractor to request a quote and/or completion of the selected tasks.

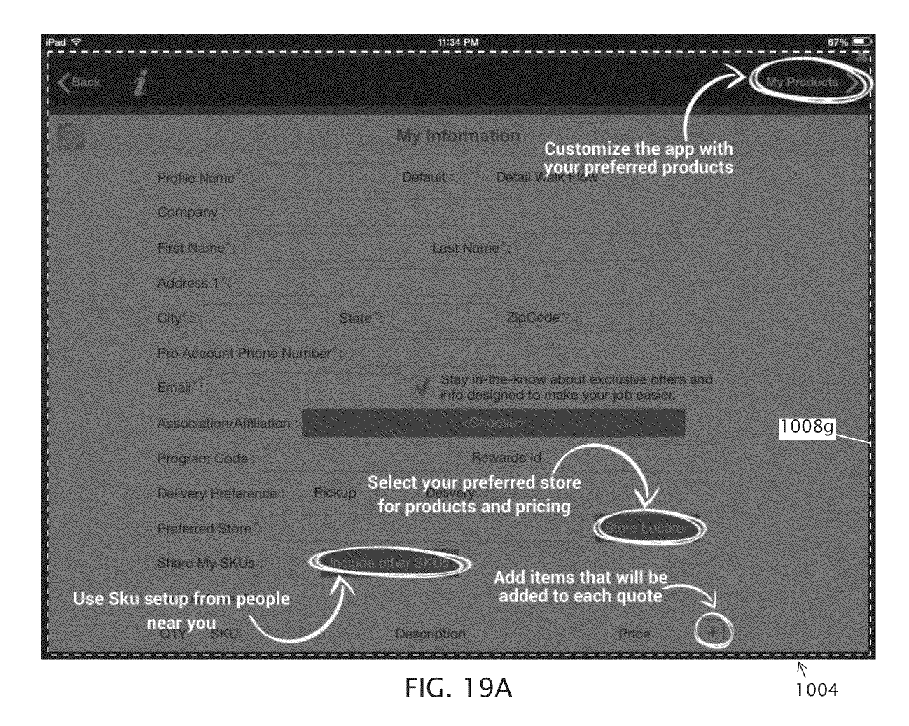

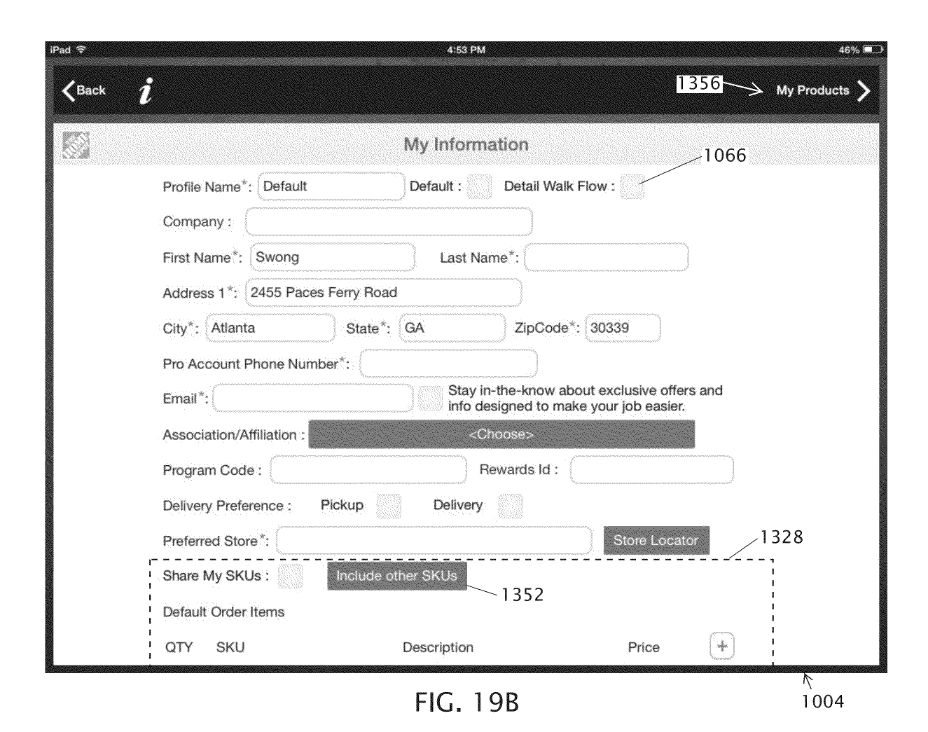

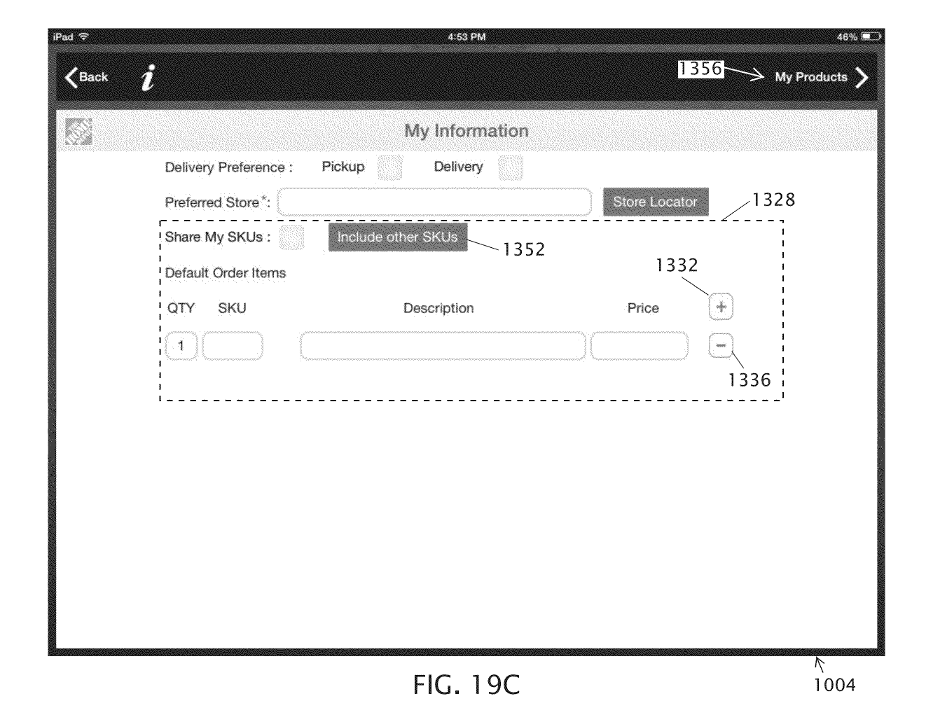

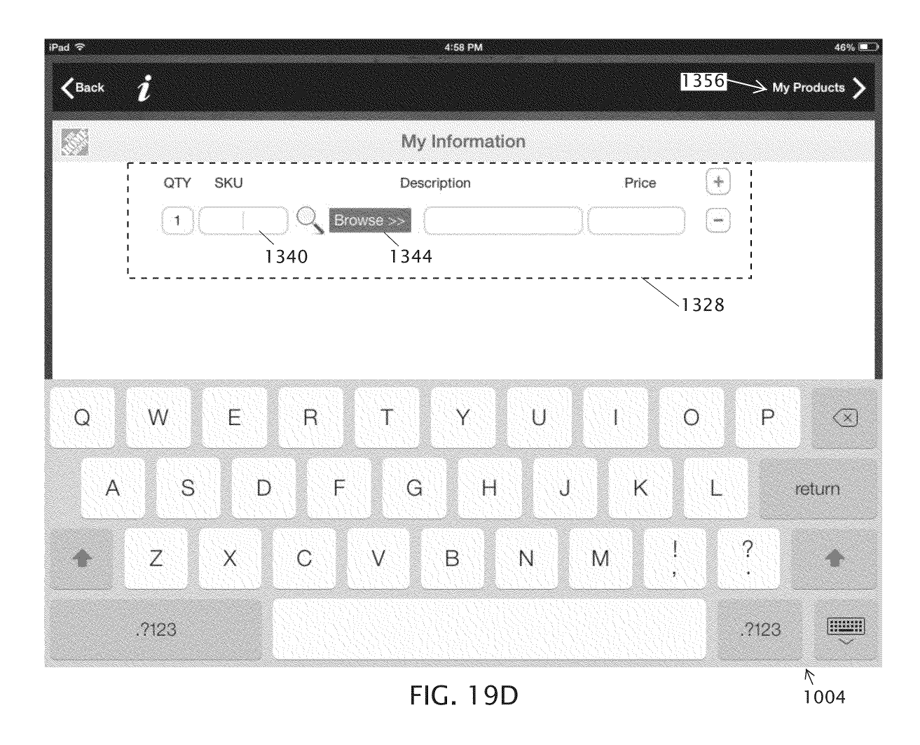

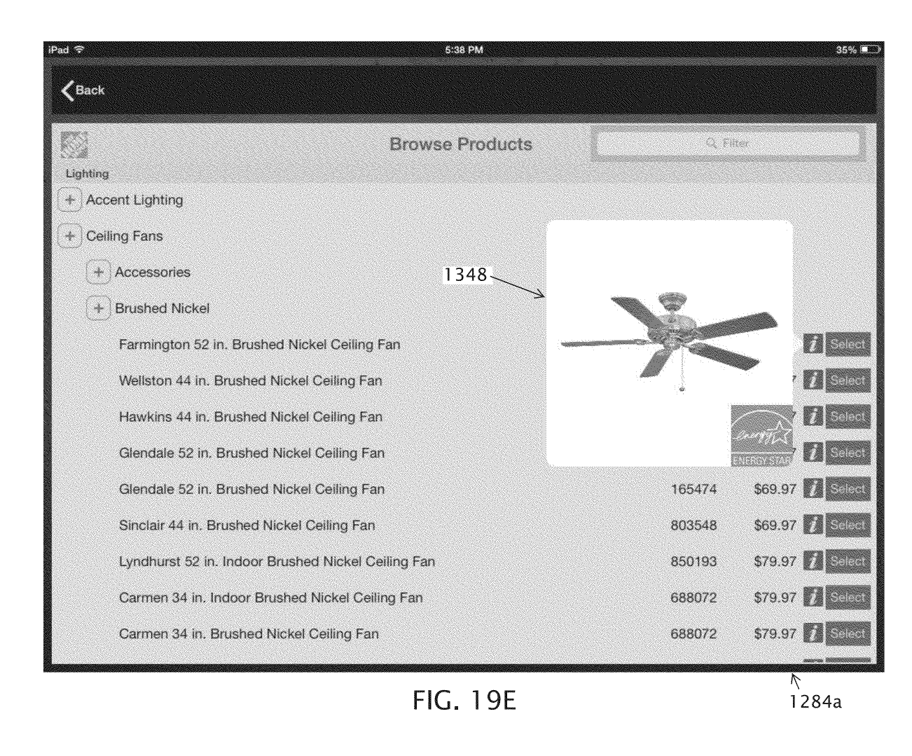

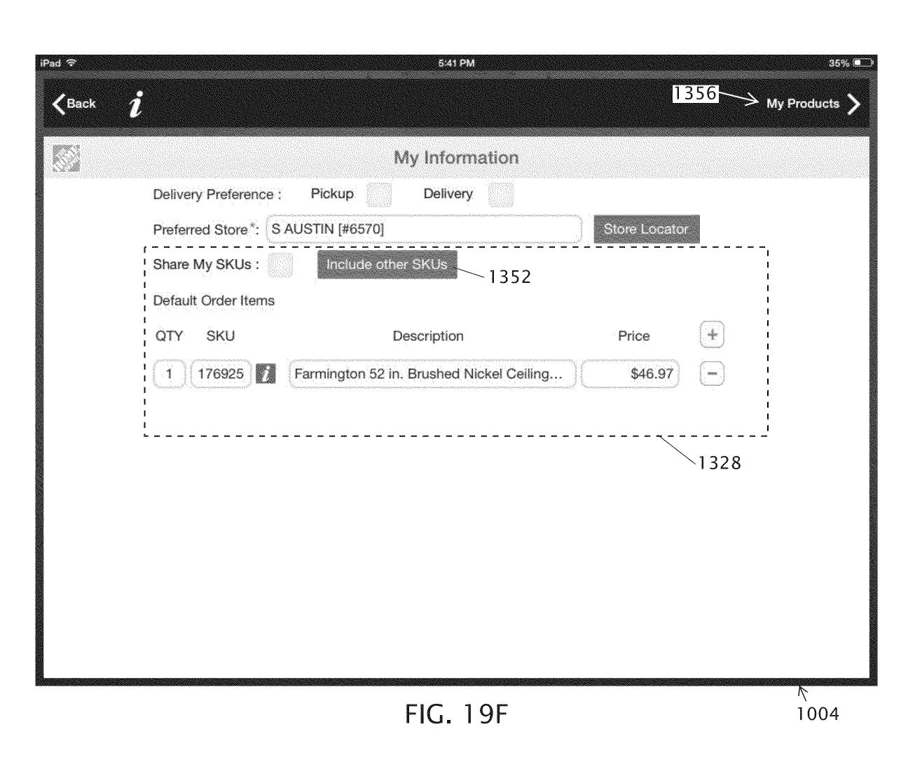

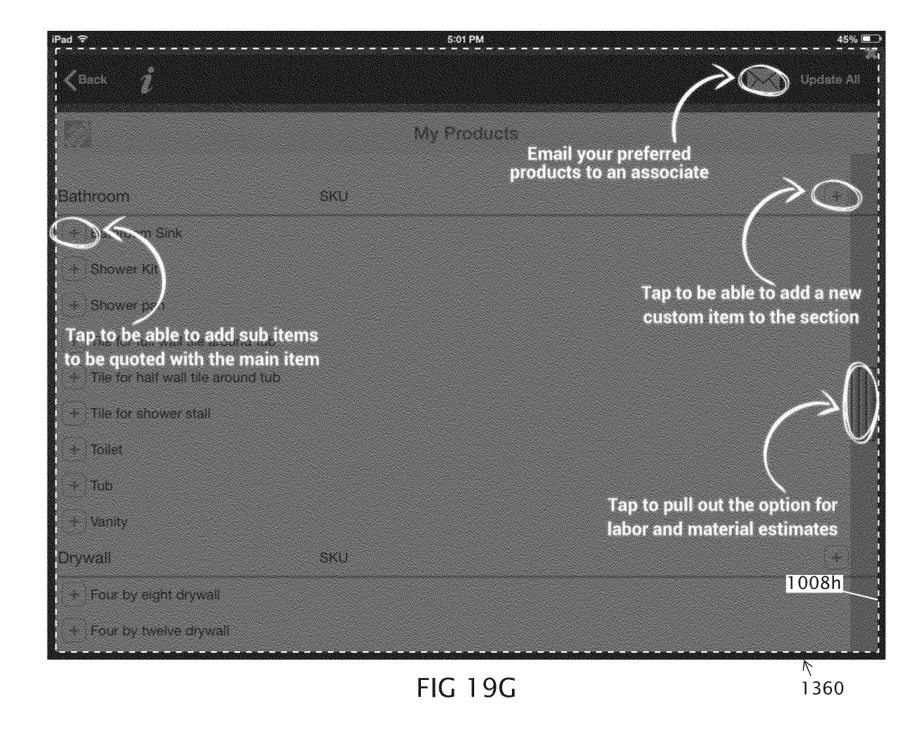

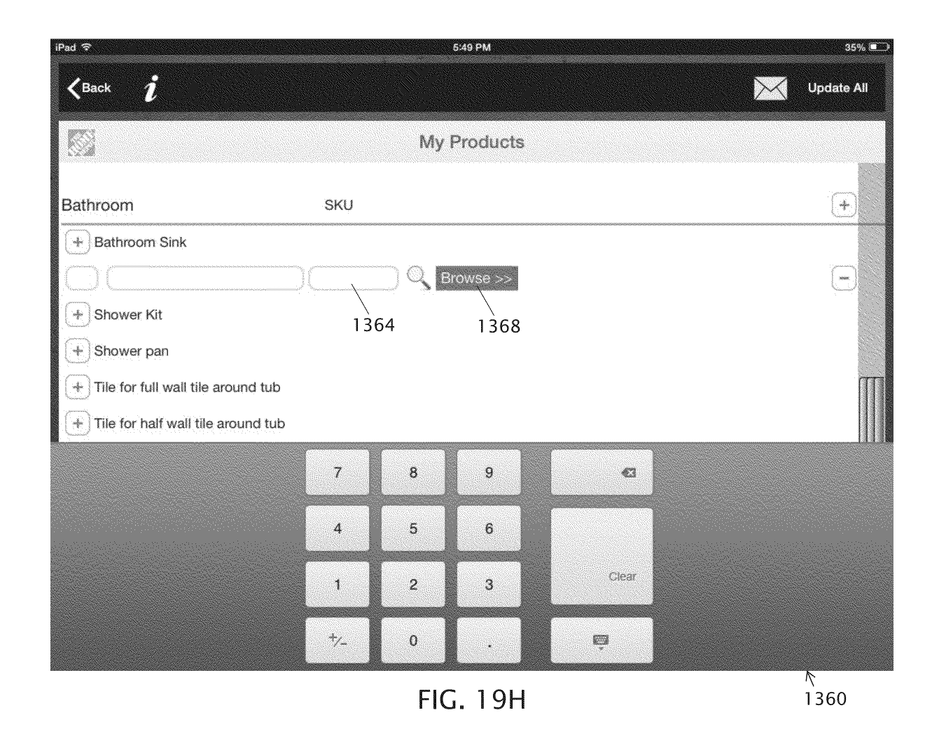

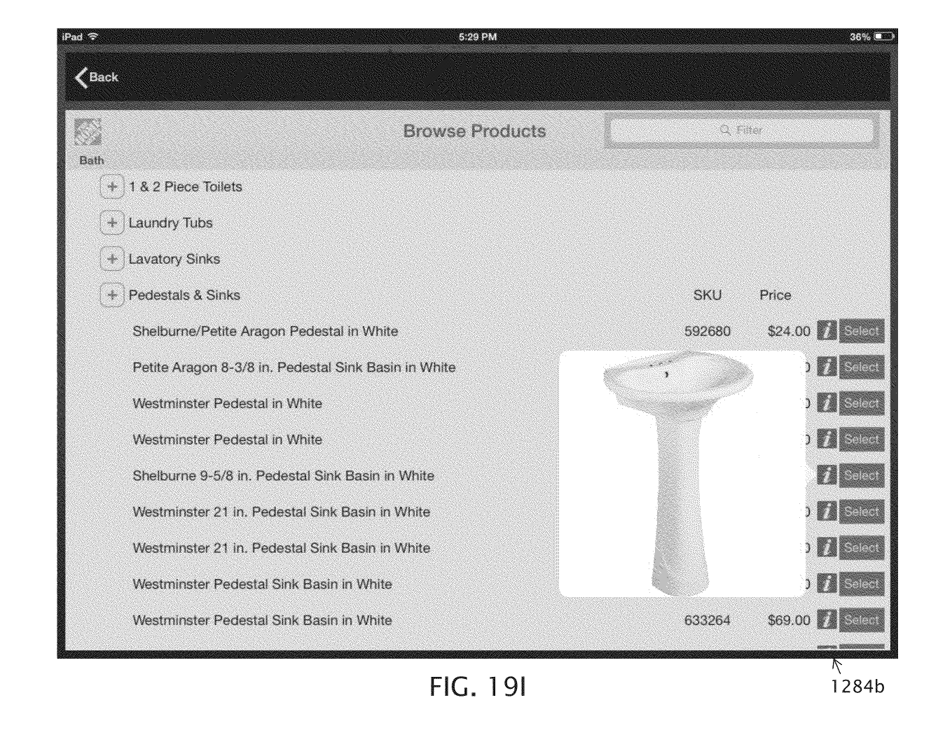

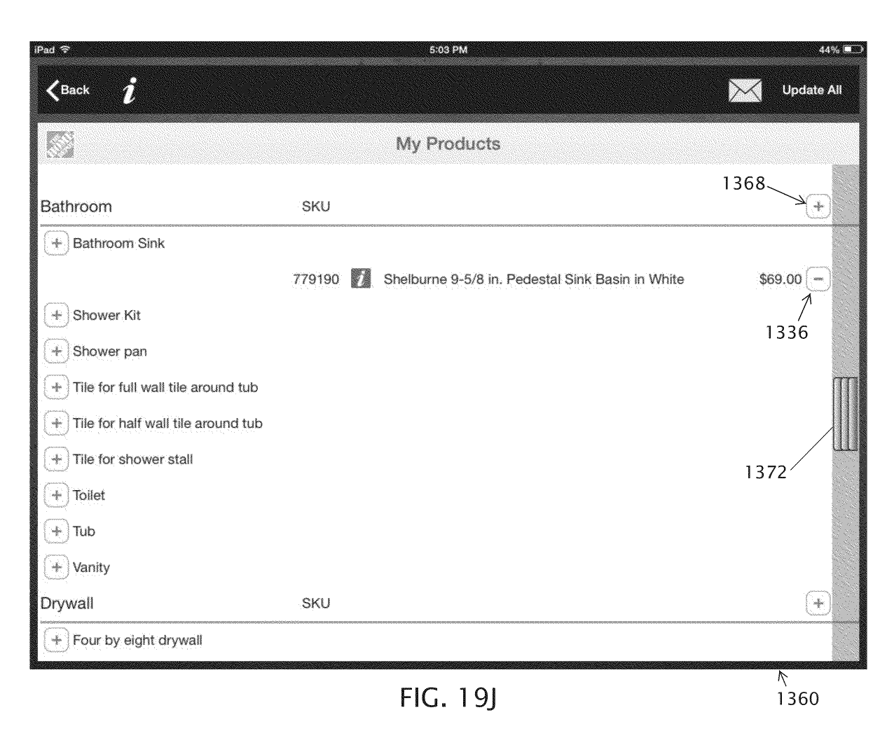

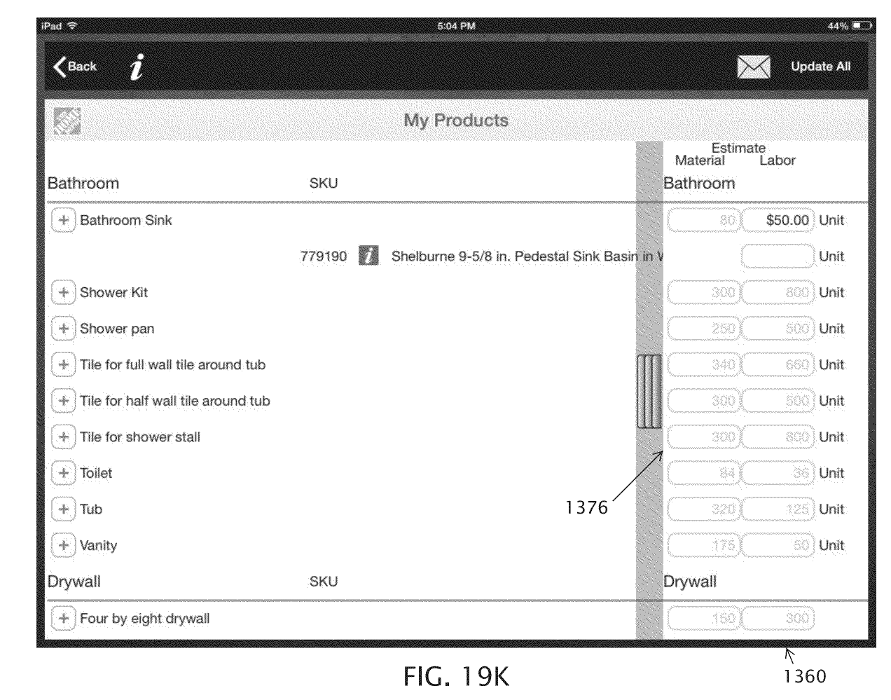

Referring now to FIGS. 5 and 19A-19K, FIG. 5 depicts a flowchart of sub-steps of one example of step 404 of editing and/or creating one or more user profiles, and FIGS. 19A-19K depict various profile-editing screens for a streamlined walk flow of one of the present end-user applications that can be presented to a user via device 350. Most sub-steps depicted in FIG. 5 of step 404 are described above with reference to FIG. 5; however, the description above is for a profile in which, at sub-step 512, the detailed walk flow option was selected. In contrast, FIGS. 19A-19D and 19F depict profile-editing screen 1004 in which “Detail Walk Flow” check box 1066 is not selected and certain additional options are therefore presented on screen 1004. An overlay 1008g is depicted in FIG. 19A that provides indicators of various icons and functions of profile-editing screen 1004, as shown in more-detail in FIGS. 19B-19D and 19F. For example, when check box 1066 is not selected, screen 1004 includes a section 1328 for “Default Order Items” at the lower portion of screen 1004 (as shown in FIGS. 19C, 19D, and 19F) for listing products that are, by default, selected for each property with which the profile is associated. For example, if masking tape and caulk are added to the profile as default product, then masking tape and caulk will automatically be selected for any property that is associated with the profile (and will have to be manually de-selected if they are not desired). Section 1328 thus provides an input region to facilitate sub-step 520 of selecting adding default order products.

In the embodiment shown, section 1328 includes a “+” icon 1332 that is selectable to add additional rows for default products, and each row for a default product includes text boxes for quantity, SKU, description, and price, as well as a “−” icon 1336 that is selectable to remove the default product. In the embodiment shown, when a user selects text box 1340 to enter a SKU for a default product (FIG. 19D), an additional browse button 1344 is presented that is selectable by a user to cause the end-user application to present a browse-products screen 1284a (FIG. 19E) that is similar to screen 1284 described above. As with screen 1284, screen 1284a can present a hierarchical display of available products by group or structure portion (e.g., Lighting), product category (e.g., Ceiling Fans), and sub-categories (e.g., Brushed Nickel), each of which can be expanded by selecting the “+” icons on the left, as shown in FIG. 19E. Once a user has expanded a desired sub-category, the products in the sub-category are presented in rows, as shown, along with “i” icons that are selectable by a user to see an image 1348 of or otherwise associated with each product and “Select” buttons that are selectable by a user to designate a product as a default order item, as indicated in FIG. 19F, such that the text boxes in section 1328 are automatically populated with the SKU, description, and price associated with the product. In the embodiment shown, section 1328 also includes a button 1352 that is selectable by a user to cause the end-user application to search for and download SKU lists for default products from other users of system that are nearby (e.g., that have designated the same preferred store). Once the desired default products, if any, have been added, a user can select “My Products” icon 1356 to proceed to a my-products screen 1360 (FIGS. 19G-19H and 19J-19K) to complete sub-step 524 of adding and/or editing available products and/or tasks.

FIGS. 19G-19H AND 19J-19K depict a my-products screen 1360 that is configured to facilitate performance of sub-step 524 of adding and/or editing available products that can be selected by an end user during a streamlined walk flow. An overlay 1008h is depicted in FIG. 19G that provides indicators of various icons and functions of my-products screen 1360, as shown in more-detail in FIGS. 19H and 19J-19K. In the embodiment shown, screen 1360 can present a hierarchical display of available products by group or structure portion (e.g., Bathroom, Kitchen, Drywall), and item or product category (e.g., Bathroom Sink) each of which items or product categories can be expanded by selecting the “+” icons on the left, as shown in FIG. 19H. Once a user has expanded a desired product category, the products in the category are presented in rows, as shown, that include text boxes for quantity, description, and SKU. As shown, when a user selects text box 1364 to enter a SKU for a product, an additional browse button 1368 is presented that is selectable by a user to cause the end-user application to present a browse-products screen 1284b (FIG. 19I) that is similar to screen 1284a described above. As with screen 1284a, screen 1284b can present a hierarchical display of available products by group or structure portion (e.g., Bath), product category (e.g., Fixtures), and sub-categories (e.g., Pedestals & Sinks), each of which can be expanded by selecting the “+” icons on the left, as shown in FIG. 19I. Once a user has expanded a desired sub-category, the products in the sub-category are presented in rows, as shown, along with “i” icons that are selectable by a user to see an image 1348 of or otherwise associated with each product and “Select” buttons that are selectable by a user to designate a product as an available product for the my-products screen, as indicated in FIG. 19J, such that the text boxes associated with the product on the my-products screen are automatically populated with the SKU, description, and price associated with the product. In the embodiment shown, screen 1360 includes a “+” icon 1368 that is selectable to add additional rows for available products, and each row for an available product includes a “−” icon 1336 that is selectable to remove the default product. While only a few groups or structure portions are shown (e.g., Bathroom and Drywall), screen 1360 can include any of numerous other groups or structure portions (e.g., Bathroom, Drywall, Electrical, Exterior, Exterior Paint, Flooring, HVAC, Interior Paint, Kitchen, Plumbing, Roofing, Windows and Doors, and/or the like).

In the embodiment shown, my-products screen 1360 also includes a tab 1372 that is configured to be dragged from left to right by a user to open or present an input portion 1376 for entering material and/or labor costs associated with items or product categories (e.g., tasks) and/or individual products within each item or product category, as shown in FIG. 19K. Portion 1376 includes text boxes for material and labor costs associated with each item or product category (e.g., bathroom sink, shower kit, shower pan, tile for full wall tile around tub, tile for half wall tile around tub, tile for shower stall, toilet, tub, vanity, and/or the like) and with each available product associated with a product category (e.g., SKU 779190 associated with the Bathroom sink product category).

As shown, labor costs can be entered for each individual products (which may be summed at the product category level) or can be entered for the product category level. For example, the product category “tile for full wall tile around tub” may include tiles, grout, backer board, and/or other products, but it may be more efficient and/or more accurate to estimate the labor cost for the entire product category or task of installing full wall tile around the tub. In contrast, the “tub” product category may include a bathtub and plumbing components and it may be more efficient and/or more accurate to separately enter labor costs for installing the bathtub and for installing the plumbing components (e.g., because those tasks may be performed by different sub-contractors). As shown, each material and labor text box may be pre-populated with default values that are shown in gray, and which, in the absence of user-defined values, will be used to estimate the material and labor costs for each product category and/or task selected in the streamlined walk flow that will be described with reference to FIGS. 20A-20M. Thus, my-products screen enables a user to define product categories or tasks that can be selected in the streamlined walk flow at the item or product category level to include both products needed for a task (e.g., replace sink) as well as labor cost associated with the task, without having to select individual products during the walk flow. This functionality can be particularly helpful for investment companies, contractors, and/or others that may repeat rehabilitations and/or renovations and have a preferred subset (e.g., certain sink models, certain paint colors, and/or the like) of the products that are offered by a supplier to which the streamlined walk flow can be limited to improve efficiency.

Referring now to FIGS. 7 and 20A-20M, FIG. 7 depicts a flowchart of sub-steps of one example of step 412 of selecting products and/or tasks, and FIGS. 20A-20M depict various features of a product-selection screen through which step 412 of selecting products can be completed. As depicted in the embodiment of FIG. 7, step 412 can comprise a sub-step 700 of determining whether the user profile associated with the property requires a detailed walk flow. An example of a detailed walk flow is described above with reference to FIGS. 16A-16P. If a detailed walk flow is not required by the user profile associated with a property, then the method proceeds to sub-step 736 of selecting a group or structure portion, a sub-step 740 of adding and/or editing photos, a sub-step 744 of selecting and/or editing general product categories and/or tasks, a sub-step 748 of adding and/or editing group or structure portion information, a sub-step 752 of selecting products and/or tasks, a sub-step 756 of incrementing the running total cost estimate with the estimated costs associated with the products and/or tasks selected in sub-steps 744, 748, and 752, and then proceeding to a sub-step 760 from which the method loops back to sub-step 736 if additional products are desired (the user has not yet finished evaluating the property).

FIGS. 20A-20M depict a product-selection screen 1400 in various states. An overlay 1008i is depicted in FIG. 20A that provides indicators of various icons and functions of product-selection screen 1400, as shown in more-detail in FIGS. 20B-20M. An example of sub-step 736 of selecting groups or structure portions is illustrated in FIGS. 20B-20C. More particularly, in the depicted embodiment, screen 1400 includes a group menu section 1404 that includes a list of available groups or structure portions (e.g., roofing, doors & windows, paint & siding, and the like). In this embodiment, screen 1400 also includes buttons 1408 that can be selected by a user to display exterior groups or interior groups in roof menu 1404 as well as other input options related to interior or exterior groups, examples of which are described below. For example, FIG. 20f depicts the interior one of buttons 1408 having been selected and group menu 1404 presenting interior groups or structure portions (e.g., kitchen, bathroom, paint, flooring, plumbing, HVAC, electrical, and/or the like). Referring again to FIGS. 20B-20C, a user can select desired groups or structure portions by dragging and dropping the icon corresponding to a desired group from group menu section 1404 to a group management section 1412. For example, FIG. 20C depicts the roofing icon having been dragged and dropped to group management section 1412, and shows an input portion 1416 corresponding to the roofing group.

In the embodiment shown, input portion 1416 associated with the roofing group (as well as other input portions each associated with other groups) includes a camera icon 1164 (described above with reference to FIG. 13C) that is selectable to open a pop-up window 1244 (e.g., as shown in FIG. 20K) that is substantially identical in function and components to photo-management section 1184 of property-management screen 1072, as described above with reference to FIGS. 14A-14B and 15A-15C. Camera icon 1164 and pop-up window 1244 thereby provide features to facilitate completion of sub-step 740 of adding and/or editing photos.

In the embodiment shown, screen 1400 and input portion 1416 associated with the roofing group also include input features configured to facilitate completion of sub-step 744 of selecting and/or editing general product categories and/or tasks, sub-step 748 of adding and/or editing group or structure portion information, sub-step 752 of selecting products and/or tasks, and a sub-step 756 of incrementing the running total cost estimate with the estimated costs associated with the products and/or tasks selected in sub-steps 744, 748, and 752. For example, screen 1400 includes a input portion 1420 (associated with and presented when the exterior one of buttons 1408 is selected) for selecting and/or editing general products (sub-step 740) having an icon corresponding to an exterior fixture (e.g., a porch light) and a text box indicating a quantity of the fixture that has been selected for the property. In this embodiment, user selection of the icon will increase the quantity by one and/or a user may select the text box and type in a desired quantity.

Within input portion 1416, a number of text boxes (e.g., roof pitch, current number of layers, have estimate, soffit, gutters), check boxes (e.g., replace all, repair, re-deck, paint tile roof), and drop-down menus (e.g., roofing material) are provided that permit a user to select the items or product category tasks that are desired to be completed for the property. In this embodiment, most if not all of the text boxes (including the text box of general input portion 1420), check boxes, and/or drop-down menu selections are associated with product categories like those described above with reference to FIGS. 19G-19K (e.g., each associated with one or more products, material costs, and/or labor costs) such that the end user application can calculate and increment (e.g., in substantially real-time) a running cost total, both at the group level (as presented next to the roofing icon in group management section 1412 and at the property level (as presented at area 1424). Rather than inviting selecting of individual products, input portion 1416 associated with the roofing group includes task (e.g., replace roof) selections and group information (e.g., current number of layers) selections (that may be associated with one or more individual products) rather than selections that invite a user to select individual products. In contrast, FIG. 20D depicts an input portion 1416a associated with the doors & windows (exterior) group, in which a user is invited to indicate the type of windows (e.g., vinyl or wood via a drop-down menu) and the number of each type of door or window (each associated with individual product(s), material costs, and/or labor costs via the my-products screen described above and/or the back-end application described below) that are needed. Alternatively, a user can select the check box to indicate that an estimate has already been obtained, in which case an additional text box is presented for the user to enter the amount of the estimate such that the amount can be included in the running total for doors & windows depicted with the doors & windows icon in menu 1412 and in the running property total shown at area 1424.

FIG. 20E depicts an input portion 1416b associated with the paint & siding (exterior) group, in which a user is invited only to indicate via a slider the percentage of the exterior of the property to be painted, whether to include the soffit, whether to replace siding with vinyl siding or fiber cement board, and whether an estimate for exterior pain & siding has already been obtained, in which case an additional text box is presented for the user to enter the amount of the estimate such that the amount can be included in the running total for exterior paint & siding depicted with the paint & siding icon in menu 1412 and in the running property total shown at area 1424.

FIG. 20F depicts an input portion 1416c associated with the kitchen (interior) group. As shown, the interior one of buttons 1408 has been selected such that an interior general input portion 1420a is presented with multiple interior products (interior doors, interior light fixtures, and interior ceiling fans). The form and function for each of the presented general interior products in portion 1420a is similar to that described above for general input portion 1420. In the embodiment shown, input portion 1416c invites a user to indicate whether to paint or replace cabinets and, if so, the linear feet (LF) of cabinets, and whether an estimate for cabinets has already been obtained, in which case an additional text box is presented for the user to enter the amount of the estimate such that the amount can be included in the running total for the kitchen group depicted with the kitchen icon in menu 1412 and in the running property total shown at area 1424. In this embodiment, input portion 1416c also invites a user to indicate whether counter tops should be upgrade and, if so, the linear feet (LF) of countertops, as well as to select any appliances or kitchen fixtures that should be replaced (e.g., sink, refrigerator, range, stove top, range hood, dishwasher).

FIG. 20G depicts an input portion 1416d associated with the flooring (interior) group, which invites a user to indicate whether an estimate for flooring has already been obtained, in which case an additional text box is presented for the user to enter the amount of the estimate such that the amount can be included in the running total for the flooring group depicted with the flooring icon in menu 1412 and in the running property total shown at area 1424. If an estimate has not been obtained, input portion 1416d invites a user to indicate whether all flooring should be replaced and, if so, via a slider the percentage that is carpet versus the percentage that is tile or hardwood, as well as via a slider the percentage of the tile/hardwood portion that is tile versus the percentage that is hardwood and whether the hardwood portion should be new or refinished.

FIG. 20H depicts an input portion 1416e associated with the bathroom (interior) group, which invites a user to indicate whether an estimate for bathrooms has already been obtained, in which case an additional text box is presented for the user to enter the amount of the estimate such that the amount can be included in the running total for the bathroom group depicted with the bathroom icon in menu 1412 and in the running property total shown at area 1424. If an estimate has not been obtained, input portion 1416e invites a user to indicate the number of each type of bathroom item or product category (each associated with individual product(s), material costs, and/or labor costs via the my-products screen described above and/or the back-end application described below) that are needed. For example, in the configuration shown, input portion 1416e requests invites a user to enter a quantity for vanities, sinks, toilets, shower kits, bath tubs, shower pans, tile stalls, half-wall tile, and full-wall tile.

FIG. 20I depicts an input portion 1416f associated with the electrical (interior) group, which invites a user to indicate whether the property should be rewired, whether the service should be upgraded, and whether an estimate for electrical has already been obtained, in which case an additional text box is presented for the user to enter the amount of the estimate such that the amount can be included in the running total for the electrical group depicted with the electrical icon in menu 1412 and in the running property total shown at area 1424. Input portion 1416f further invites a user to indicate the number of each type of electrical item or product category (each associated with individual product(s), material costs, and/or labor costs via the my-products screen described above and/or the back-end application described below) that are needed. For example, in the configuration shown, input portion 1416f requests invites a user to enter a quantity for carbon-monoxide detectors, smoke detectors, plugs, GFI plugs, switches, and plug/switch plates.

FIG. 20J depicts an input portion 1416g associated with the bedroom (interior) group, which invites a user to indicate enter notes associated with each bedroom, and/or add photos associated with each bedroom. FIG. 20K illustrates pop-up window 1244 that is presented responsive to user-selection of the camera icon and that is substantially identical in function and components to photo-management section 1184 of property-management screen 1072, as described above with reference to FIGS. 14A-14B and 15A-15C.

FIG. 20L depicts an input portion 1416h associated with the plumbing (interior) group, which invites a user to indicate whether an estimate for plumbing has already been obtained, in which case an additional text box is presented for the user to enter the amount of the estimate such that the amount can be included in the running total for the plumbing group depicted with the plumbing icon in menu 1412 and in the running property total shown at area 1424. If an estimate has not been obtained, input portion 1416h invites a user to indicate whether all pipes should be replaced and whether a 40 gallon hot water heater should be installed/replaced (and, if so, whether the hot water heater is gas or electric).

FIG. 20M depicts an input portion 1416i associated with the interior paint group, which invites a user to indicate whether the all of the interior should be repainted and, if so, whether the trim should be painted a separate color, whether doors should be repainted, whether closet doors should be repainted, whether ceilings should be retextured, whether walls should be retextured, whether the windows are painted wood that should be repainted. In this configuration, input portion 1416i further invites a user to indicate whether drywall should be replaced and, if so, whether drywall should be replaced in the entire house or only in a designated number of rooms. In this configuration, input portion 1416i also invites the user to indicate whether an estimate for interior paint has already been obtained, in which case an additional text box is presented for the user to enter the amount of the estimate such that the amount can be included in the running total for the interior paint group depicted with the interior paint icon in menu 1412 and in the running property total shown at area 1424.

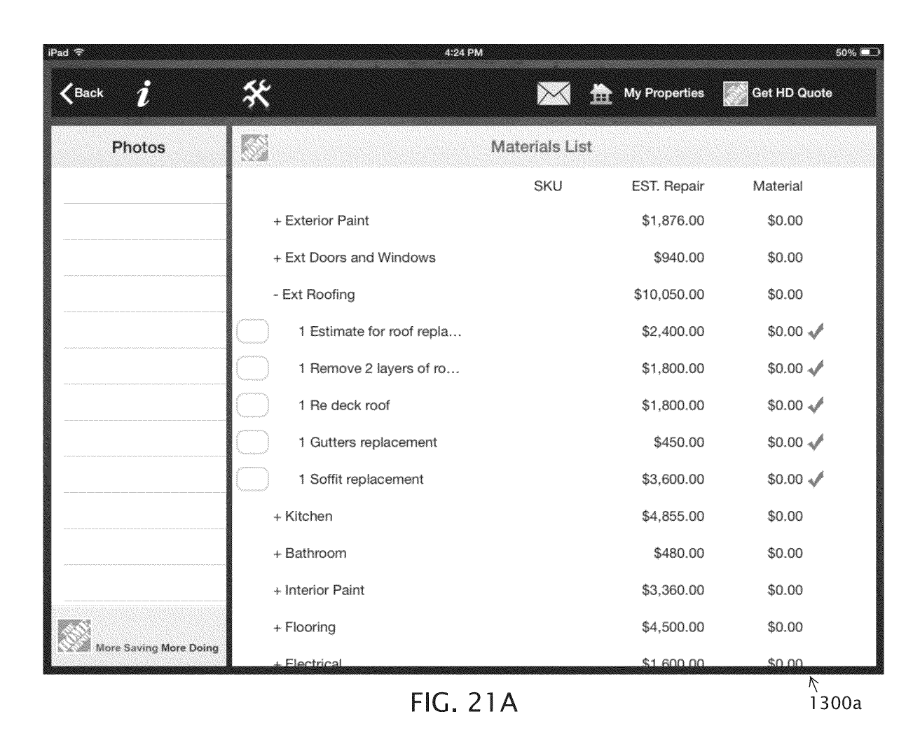

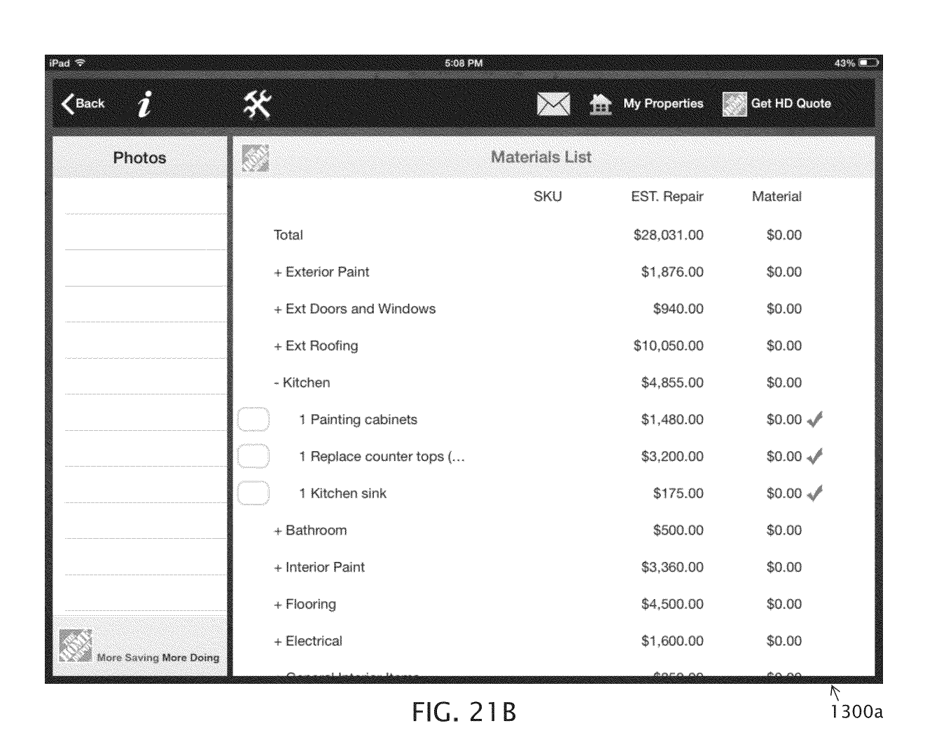

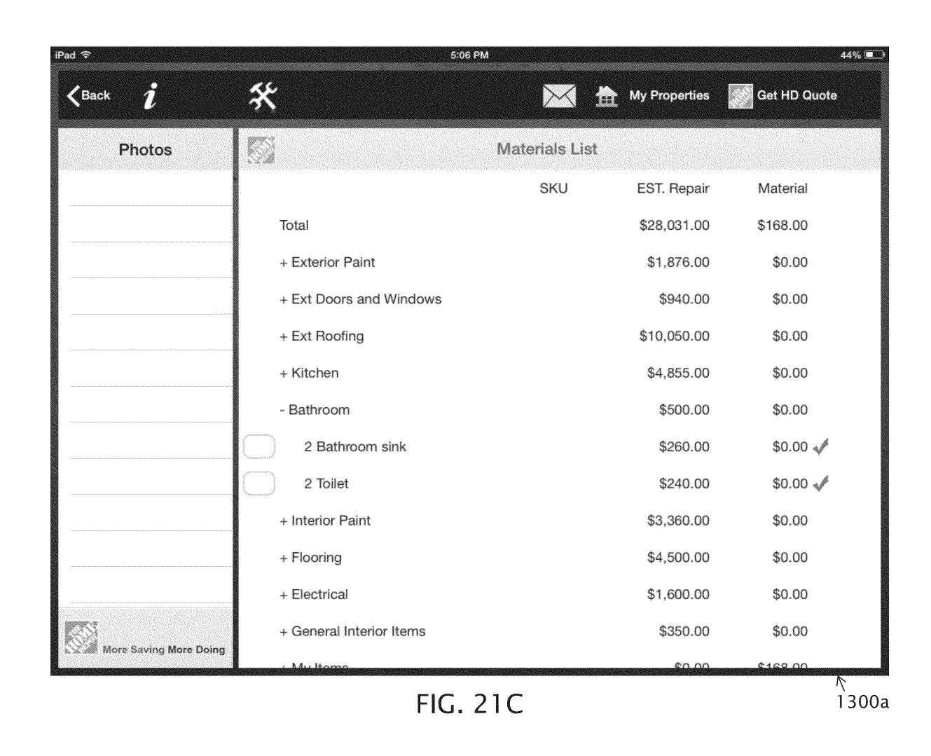

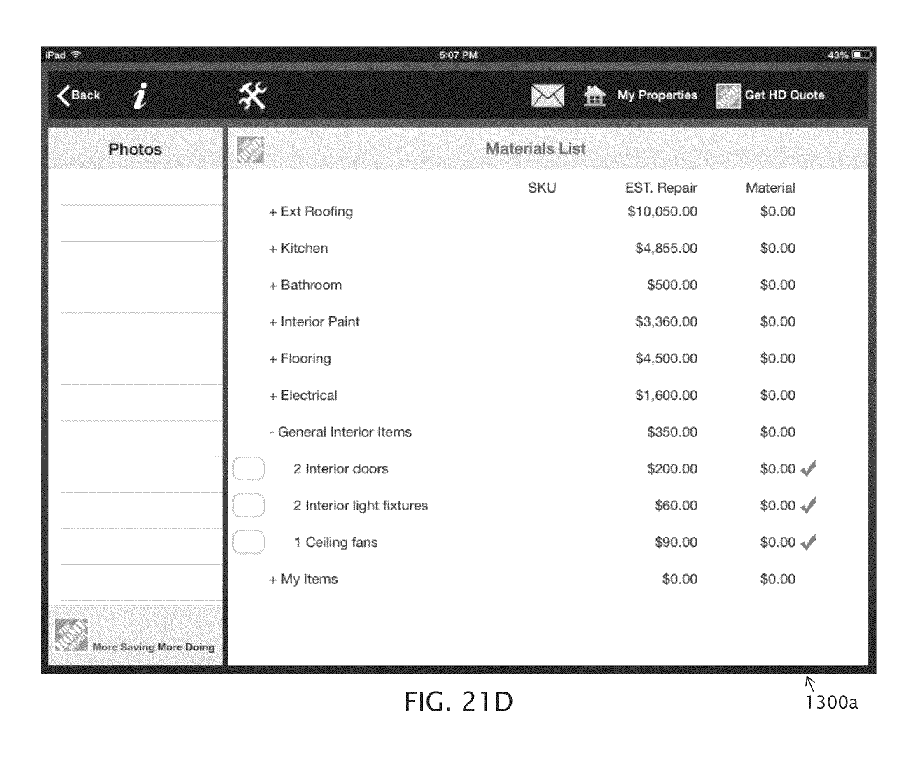

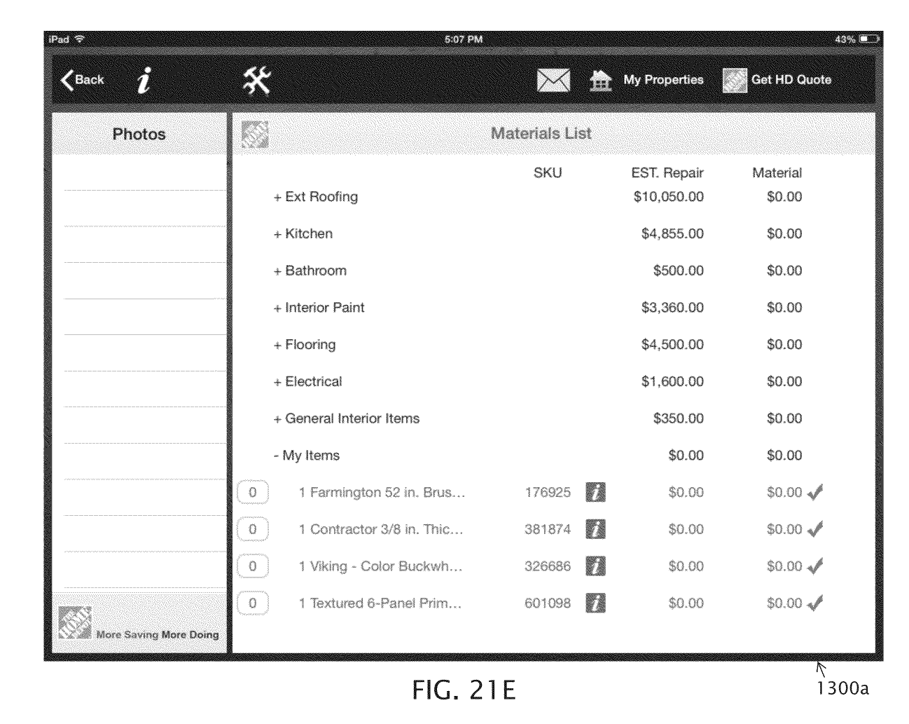

In most instances, during a typical “walk” of a property, a user may also select products and/or tasks associated with different groups or structure portions, as indicated in FIGS. 20A-20L. Once evaluation (the streamlined “walk”) of the property is complete and no additional products are desired (the user has completed evaluating the property), such that step 412 exits at 732, as depicted in FIG. 7, method 400 can proceed to step 416 of generating and/or editing a materials list for a property. More particularly, in the depicted embodiment, the user can select arrow “>” icon 1428 to proceed to materials list screen 1300 of FIGS. 21A-21E.

FIGS. 21A-21E illustrate an example of a materials-list screen 1300a through which step 416 of generating and/or editing a materials list can be completed. Materials list screen 1300a is substantially similar in form and function to materials screen 1300 with the primary exception that the groups or structure portions, items or product categories, and products are organized to correspond to those of streamlined “walk” configuration described with reference to FIGS. 20A-20M. Materials list output (e.g., via email) and/or quote submission for materials-list screen 1300a can proceed as described above for materials-list screen 1300.

As an example to illustrate the correlation between materials-list screen 1300a and product selection screen 1400, in FIG. 21A, the Exterior Roofing group has been expanded to show the product categories or tasks within the group that correspond to the selections in FIG. 20C and the associated product and material costs designated in my-product screen 1360 (e.g., in the manner described with reference to FIG. 19K) and/or associated product and material costs designated in a back-end application (e.g., in the manner described below with reference to FIGS. 26A-26C). More particularly, in FIG. 21A, the Exterior Roofing group includes estimated costs for: roof replacement (included responsive to the “replace all” check box of exterior roof input portion 1416 having been checked (FIG. 20C)), removing 2 layers of existing roofing (included responsive to “2” having been entered in the “current number of layers” text box of exterior roof input portion 1416 (FIG. 20C)), re-decking the roof (included responsive to the “re-deck” check box of exterior roof input portion 1416 having been checked (FIG. 20C)), gutter replacement (included responsive to “100” having been entered in the “Gutters” text box of exterior roof input portion 1416 (FIG. 20C)), and soffit replacement (included responsive to “180” having been entered in the “Soffit” text box of exterior roof input portion 1416 (FIG. 20C)). In the configuration shown, each of the selected Exterior Roofing items includes general cost estimates rather than any specific products (materials) such that the material costs are shown as zero, even if some materials will still be needed. In such an instance, the materials may be purchased by a sub-contractor such that the user of the system views the expense as corresponding to the overall task without need to identify the particular material cost. In contrast, if the system were configured to include particular products (e.g., three-tab roofing, tar paper, roofing nails, and/or the like) for purchase by the user of the system, then the material cost would include the cost associated with such products.

By way of further example, in FIG. 21B, the Kitchen group has been expanded to show the product categories or tasks within the group that correspond to the selections in FIG. 20F and the associated product and material costs. More particularly, in FIG. 21B, the Kitchen group includes estimated costs for: painting cabinets (included responsive to the “paint” check box of kitchen input portion 1416c having been checked, and “40” having been entered in the corresponding text box (FIG. 20F)), replacing counter tops (included responsive to the “upgrade countertops” check box of kitchen input portion 1416c having been checked, and “40” having been entered in the corresponding text box (FIG. 20F)), and installing a new kitchen sink (included responsive to the “sink” icon of kitchen input portion 1416c having been selected (FIG. 20F)).

By way of further example, in FIG. 21C, the Bathroom group has been expanded to show the product categories or tasks within the group that correspond to the selections in FIG. 20H and the associated product and material costs. More particularly, in FIG. 21C, the Bathroom group includes estimated costs for: installing two bathroom sinks (included responsive to “2” having been entered into the sink quantity text box input portion 1416e (FIG. 20H)), and installing two toilets (included responsive to “2” having been entered into the toilet quantity text box input portion 1416e (FIG. 20H)).

By way of further example, in FIG. 21D, the General Interior Items group has been expanded to show the product categories or tasks within the group that correspond to the general product selections in input section 1420a of screen 1400 shown in FIGS. 20E-20L. More particularly, in FIG. 21D, the General Interior Items group includes estimated costs for: installing two interior doors (included responsive to “2” having been entered into the door quantity text box of input portion 1420a), installing two interior light fixtures (included responsive to “2” having been entered into the fixture quantity text box of input portion 1420a), and installing one ceiling fan (included responsive to “1” having been entered into the fan quantity text box of input portion 1420a).

Finally, as yet another example, in FIG. 21E, the My Items group has been expanded to show the product categories or tasks within the group that correspond to the Default Order Items selected in input section 1328 of profile-editing screen 1004 (FIG. 19F). More particularly, in FIG. 21D, the My Items group includes estimated costs for four products, each having a SKU and an “i” icon that are selectable by a user to see an image of or otherwise associated with each product. Because these products are specifically identified and associated with a SKU corresponding to the supplier's system, the default presentation of the Materials list will include in the Material cost column the price associated with each product (or a multiple of each product, according to the default quantity entered in input section 1328 of profile-editing screen 1004 (FIG. 19F)). However, each individual product is also presented with a quantity text box (e.g., 1432) to the left of the product into which a non-default quantity can be entered and the material cost updated (e.g., in substantially real-time). For example, in the configuration shown in FIG. 21E, a zero value has been entered into each quantity text box 1432 to indicate that none of the default order products are desired and the corresponding Material costs are therefore $0.00.

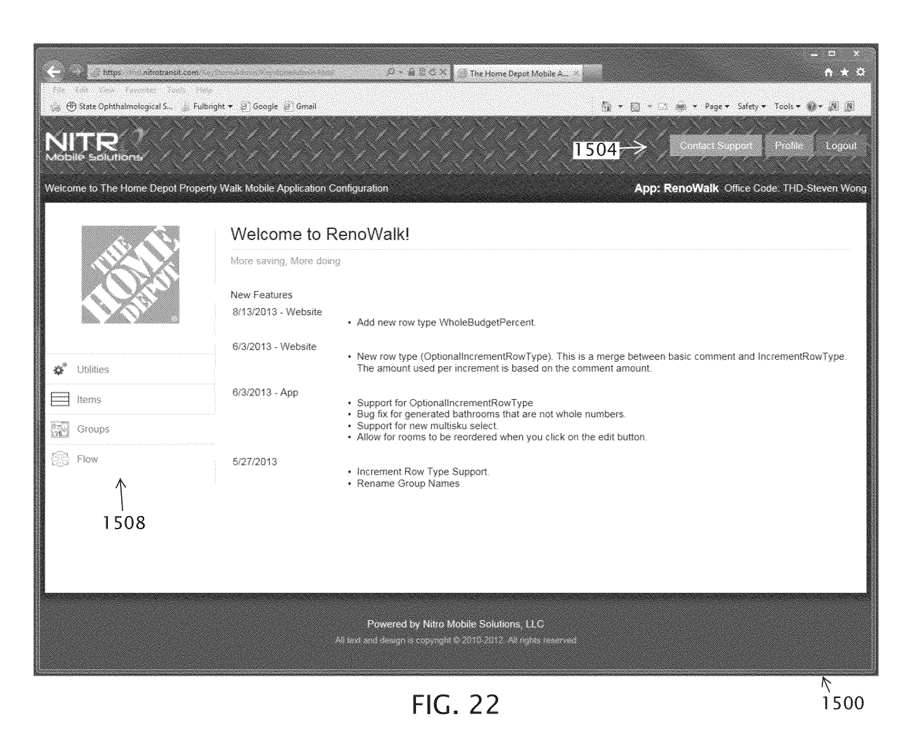

Referring now to FIGS. 4 and 22-26C, FIG. 4 depicts a high-level flowchart of certain functionality of method 400 including certain aspects that may be implemented by a back-end application executable by a processor of a server (e.g., server 102), and FIGS. 22-26C depict various webpages of a website through which on example of a back-end application of the present systems can be accessed via a web browser (e.g., of computer system 300 and/or mobile computing device 350).

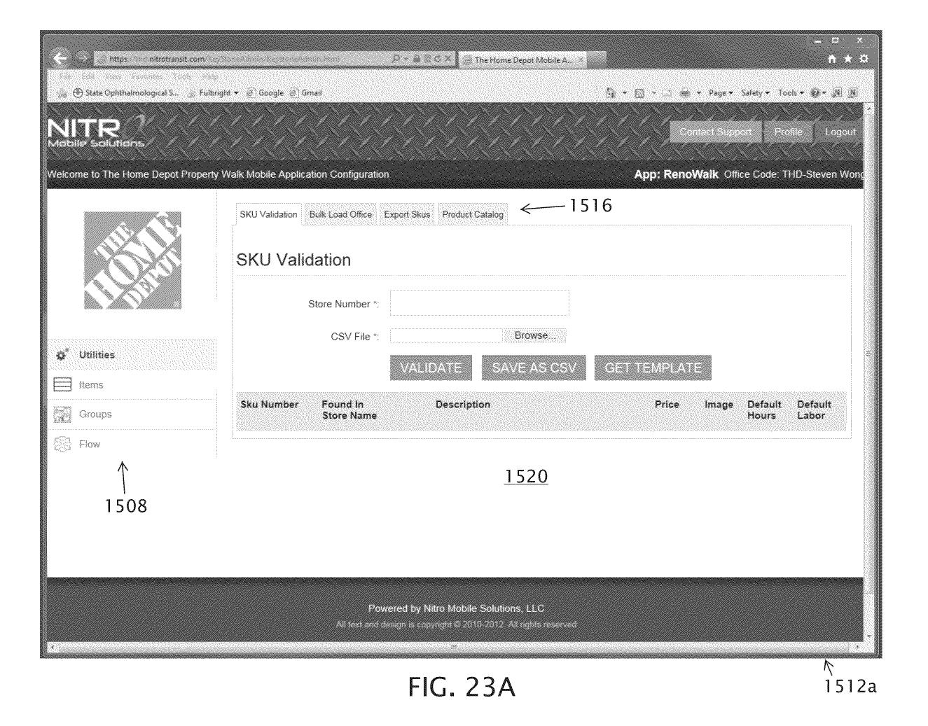

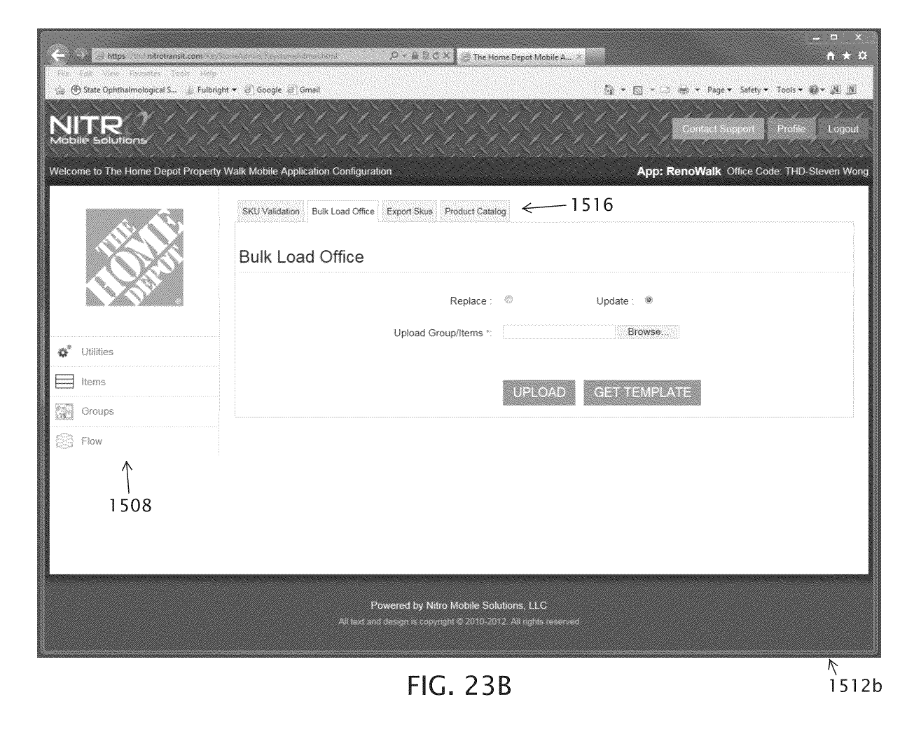

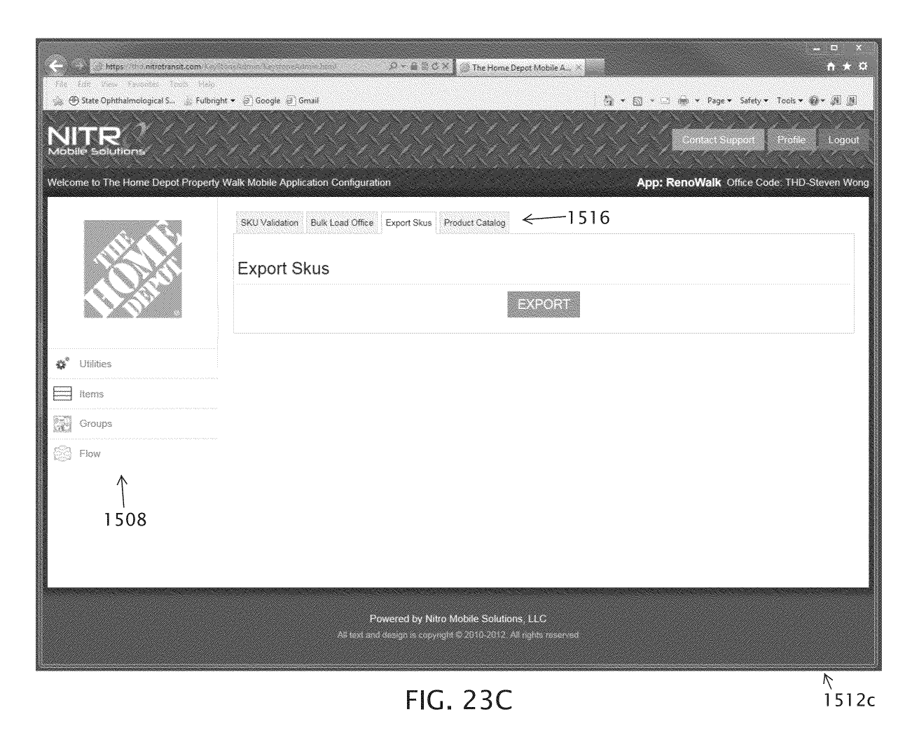

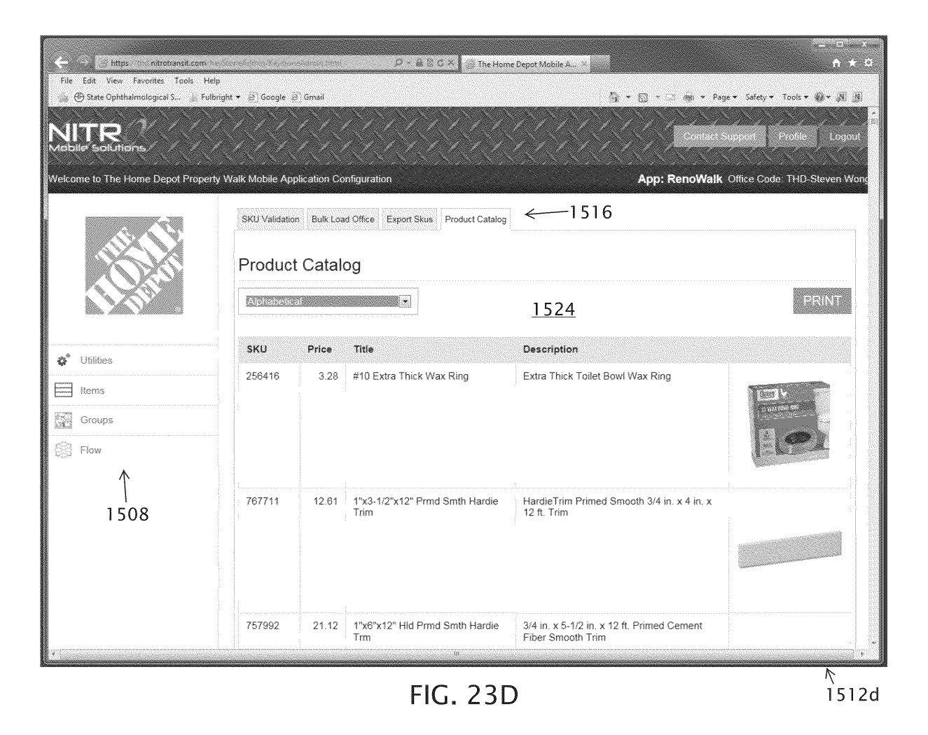

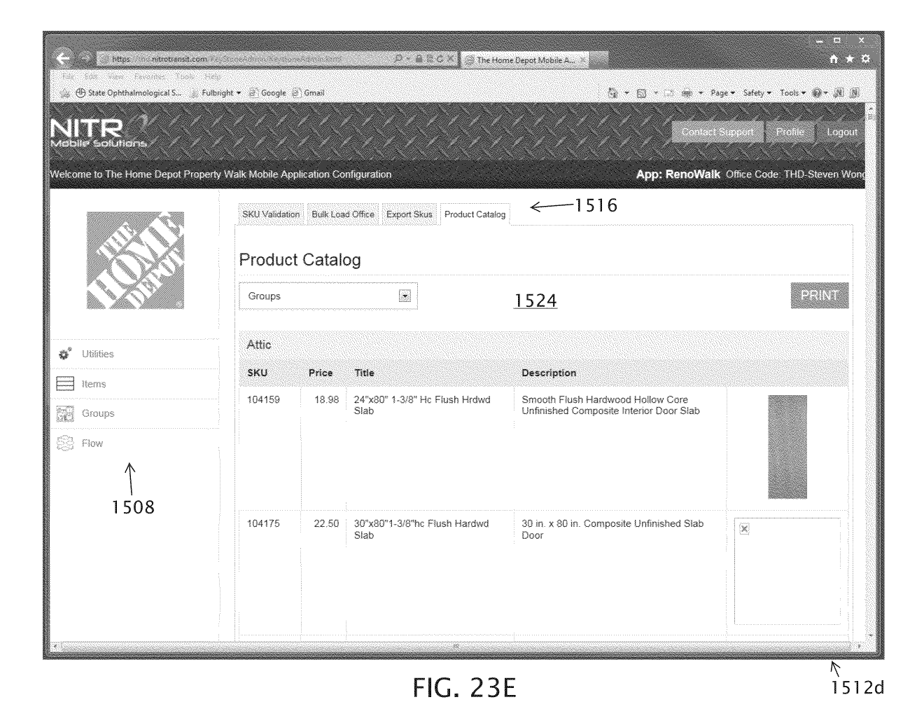

FIG. 22 depicts a homepage 1500 of a website through which a back-end application of the present systems can be accessed via web browser. In the embodiment shown, homepage 1500 includes a menu 1508 that includes buttons or links which are selectable to contact support personnel for the system (e.g., via email or a form), access and/or edit an administrative profile for the website, or logout of the website, respectively. In this embodiment, homepage 1500 also comprises a site menu 1508 including buttons or links that are selectable to access various portions of the website. For example, selecting “Utilities” in menu 1508 directs the web browser to a first utility webpage 1512a shown in FIG. 23A. Webpage 1512a includes a plurality of tabs 1516 (“SKU Validation,” “Bulk Load Office,” “Export SKUs,” and “Product Catalog”) that can be selected to direct the web browser to utility webpages (FIGS. 23A-23E) associated with different utilities. In webpage 1512a, the SKU Validation tab is selected and inputs are presented to invite a user to engage a SKU Validation tool to compare a list of SKUs that are available from one store (e.g., Atlanta, Ga.) against SKUs available from a second store (e.g., Charlotte, N.C.), and generate an exception report showing SKU numbers, description, and images of products that are not available from the second store. More particularly, in this embodiment, webpage 1512a includes a text box for a user to enter the store number of the target store with which a SKU list is to be compared, a “Browse” button to facilitate the upload of a .csv file with the SKU list, a “VALIDATE” button to initiate a comparison and generate an exception report to be displayed at section 1520, a “SAVE AS CSV” button to save the generated exception report to the user's device as a .csv file, and a “GET TEMPLATE” button to initiate a download to the user's device of a template .csv file to facilitate the user's creation of the SKU list .csv file that must be uploaded to the tool.

Selection of the Bulk Load Office one of tabs 1516 will direct the web browser to utility webpage 1512b, as shown in FIG. 23B, which includes a Bulk Load tool to facilitate a user's upload of a .csv file with the user's preferred products that will be available in an associated end-user application. More particularly, in this embodiment, webpage 1512b includes radio buttons to select whether an uploaded .csv file should update or wholly replace an existing product list, a “Browse” button to facilitate the upload of a .csv file with the product list, a “UPLOAD” button to initiate uploading of the product list, and a “GET TEMPLATE” button to initiate a download to the user's device of a template .csv file to facilitate the user's creation of the product list .csv file that must be uploaded to the tool.

Selection of the Export SKUs one of tabs 1516 will direct the web browser to utility webpage 1512c, as shown in FIG. 23C, which includes an Export SKUs tool to facilitate a user's download of a .csv file with the user's preferred products. More particularly, in this embodiment, webpage 1512c includes an “EXPORT” button to initiate downloading of the product list.

Selection of the Product Catalog one of tabs 1516 will direct the web browser to utility webpage 1512d, as shown in FIGS. 23D and 23E, which includes a Product Catalog tool to facilitate a user's viewing of the user's preferred products. More particularly, in this embodiment, webpage 1512d includes a display portion 1524 having a drop-down menu to allow sorting of the preferred products in alphabetical order (FIG. 23D) or by group (FIG. 23D), and a “PRINT” button to initiate printing of the product list.

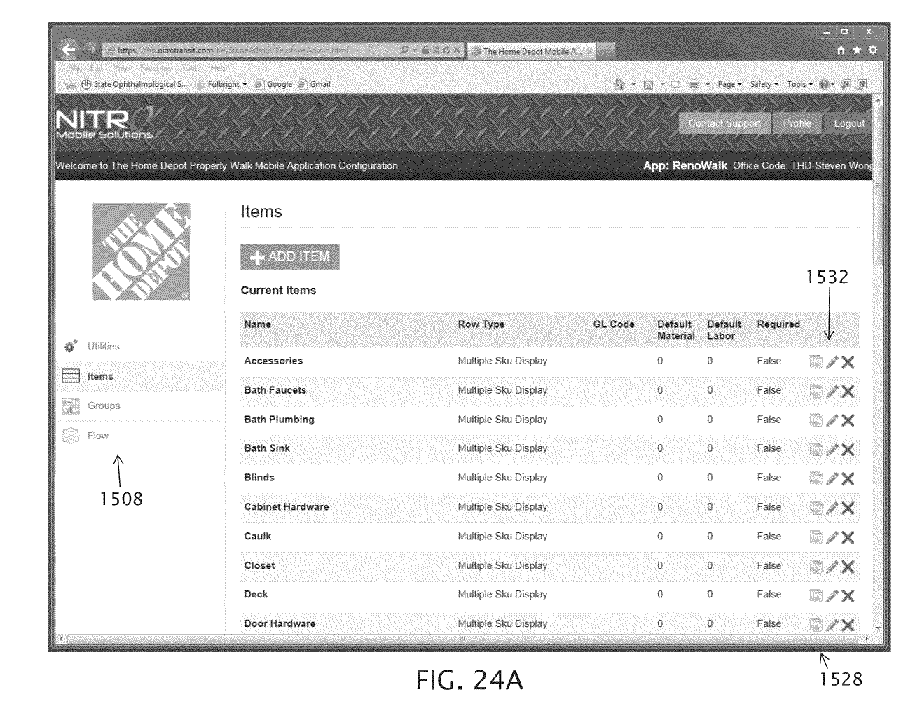

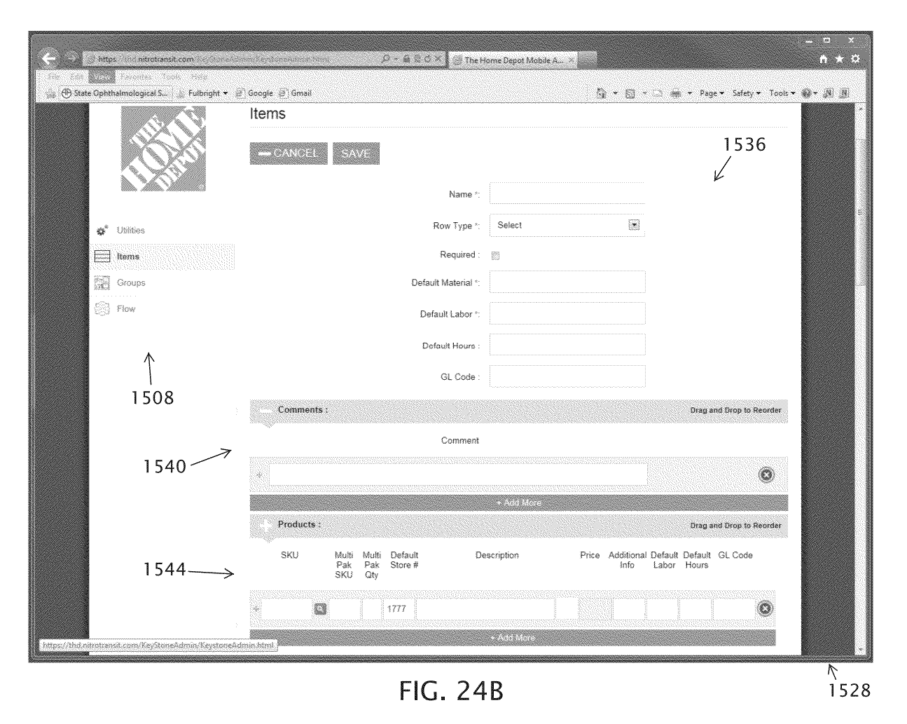

Selecting “Items” in menu 1508 directs the web browser to an item or product webpage 1528 as shown in FIGS. 24A-24B. In the embodiment shown, webpage 1528 includes a list of current items or product categories, with each displayed in a row with a Row Type option that determines how the item will be displayed in the end-user application, a default material cost, default labor cost, whether the item is required in the end-user application (e.g., whether the item must be completed for all properties), and icons 1532 that are selectable by a user to initiate duplication (page icon), editing (pen icon), or deletion (“X” icon) of the item in the row. In this embodiment, webpage 1528 also includes an “ADD ITEM” button that is selectable to create a new item or product category. Selection of the “ADD ITEM” button expands an item-creation portion 1536 that includes text boxes for an item name, Default Material cost, Default Labor cost, Default Labor hours, and a General Ledger Code (GL Code), as well as a check box that is selectable to indicate whether the item is required. The ability to assign a GL code to a product or group of products may, for example, facilitate faster and more accurate bookkeeping. For an investor that may use the present embodiments for rehabilitating an investment property, costs generally must be assigned as capital cost or expense costs and, within expense costs, one may want to track expenses related to utilities or common areas. The GL code can allow or facilitate a product or service cost to be easily moved from the app to the bookkeeping or tax records of the investor.

In this embodiment, the portion 1536 also includes a Row Type drop-down menu with various options that are selectable to determine how the item is presented in the end-user application and the options available for the item. Options for the Row Type menu may, for example, include: Always Added (a group of products that is added to every material list without input from the front-end user), Basic Comment (which allows a front-end user to add an item for product or service not included in the data feed, such as, for example, if roof repair is needed, a Basic Comment item can be included that says roof repair and the cost of the repair can be entered from a quote received or a default amount can be associated with a predefined comment option such that the amount can be included in the total budget for the property), Default Package Kit (allows for the setup of products to be part of a kit, such as, for example, if a user wants to order basket strainers, cut off valves, and supply lines with every kitchen sink, a user can define a Package Kit that includes a kitchen sink, basket strainers, cut off valves, and supply lines with default quantities so those items can be ordered together, while permitting an end user to adjust those default quantities in the field), Increment Row Type (with predefined products that are ordered in linear feet, such as, for example, base board molding), Multiple SKU Display (which shows all of the product SKUs associated with an item for selection by a user), Optional Increment (which is similar to Increment, but multiple options are available for selection and each option is associated with its own unit price, such as, for example, oak baseboard in 4 inch, 6 inch, or 8 inch heights), Package (which is similar to Default Package Kit, but the end user is not given the option to adjust quantities in the field), and Whole House SqFT (which permits a user to enter costs that are calculated based on the total square footage of the structure, such as, for example, for cleaning which may be budgeted at $0.50 per square foot). Depending on the Row Type selected, portion 1536 can also include a section 1540 configured to enable a user to add, edit, and re-order comments associated with the item, and/or a section 1544 to enable a user to add, edit, and re-order individual products that are associated with the item (e.g., including default labor costs and/or default labor hours associated with each individual product). Selection of the editing (pen) one of icons 1532 (FIG. 24A) will open a nearly identical input portion 1536 that is pre-populated with whatever options are already associated with the item for which editing is selected.

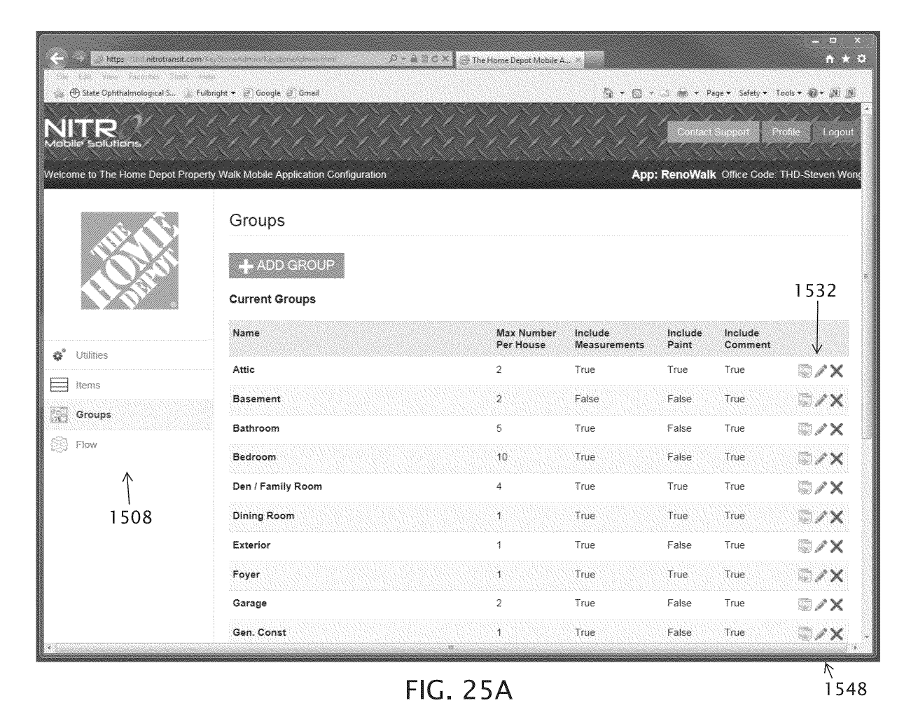

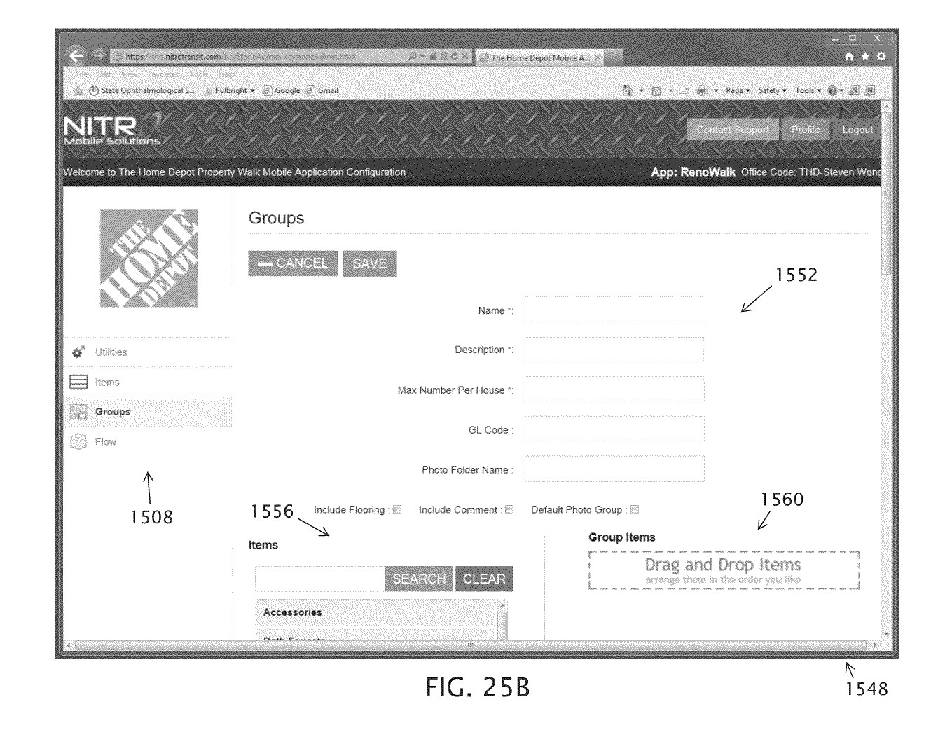

Selecting “Groups” in menu 1508 directs the web browser to an group or structure-portion webpage 1548 as shown in FIGS. 25A-25B. In the embodiment shown, webpage 1548 includes a list of current groups or structure portions, with each displayed in a row with a maximum number of the group that is permitted for each property, whether measurements should be included (whether the end-user application should prompt a user to enter measurements when the group is presented to an end user), whether to include comments (whether the end-user application should prompt a user to enter comments when the group is presented to an end user), and icons 1532 as described above. In this embodiment, webpage 1548 also includes an “ADD GROUP” button that is selectable to create a new group or structure portion. Selection of the “ADD GROUP” button expands an group-creation portion 1552 that includes text boxes for a group name, a description, the maximum number permitted for a single structure, a GL Code, and a photo folder name, as well as check boxes that are selectable to indicate whether to include flooring (e.g., whether to display input portion 1252 as shown in FIG. 16B), whether to include comments, and whether the Group is the default photo group. The default photo group is the Group from which a photo will be displayed for a corresponding property in the displays of FIGS. 11B and 11C. For example, if Default Photo Group is selected for Exterior, then the first photo associated with the Exterior group for each property will be displayed for the property in the screens of FIGS. 11B and 11C. In the embodiment shown, webpage 1548 also includes an available item column 1556 that includes the items or product categories that are available but not yet included in the group, and a group column 1560 that includes the items already included in the group. In this embodiment, each item appears as a rectangle and can be dragged and dropped from column 1556 to column 1560 to add the item to the group, can be dragged and dropped from column 1560 to column 1556 to remove the item from the group, and can be dragged and dropped within either column (e.g., 1560) to change the order in which the items are presented within the group. Selection of the editing (pen) one of icons 1532 (FIG. 25A) will open a nearly identical input portion 1552 that is pre-populated with whatever options are already associated with the group for which editing is selected.

Selecting “Flow” in menu 1508 directs the web browser to an group or structure-portion webpage 1564 as shown in FIGS. 26A-26C. In the embodiment shown, webpage 1564 includes a list of current walk “flows,” with each displayed in a row with an identifying Office Code, and “EXPORT” button that is selectable by a user to initiate a download of the flow, and icons 1532 as described above. In this embodiment, webpage 1564 also an input section 1568 that is configured to enable a user to browse their computer or device for a locally-saved flow-definition file (via the “browse button”) and upload it to the back-end system (via the “IMPORT JSON” button). In the embodiment, shown webpage 1564 also includes an “ADD FLOW” button that is selectable to create a new group or structure portion. Selection of the “ADD ITEM” button expands a flow-creation portion 1572 (FIGS. 26B-26C) that includes text boxes for a flow name, description, and hourly labor rate, as well as a matrix 1576 of text boxes for each of a plurality of generally applicable items such as flooring types and paint. For example, matrix 1576 includes text boxes for material cost, store number from which the material can be sourced, SKU for the material, coverage per SKU, labor hours, a waste factor, and a removal cost. With this information, the back-end application can calculate the material and labor costs, and generate a SKU-specific material list, when a generally applicable item like flooring (e.g., in input portion 1452 of FIG. 16B) or paint is input into the end-user application during a walk flow. In the embodiment shown, webpage 1564 also includes an available group column 1580 that includes the groups that are available but not yet included in the flow, and a flow column 1584 that includes the groups already included in the flow. In this embodiment, each group appears as a rectangle and can be dragged and dropped from column 1580 to column 1584 to add the group to the flow, can be dragged and dropped from column 1584 to column 1580 to remove the group from the flow, and can be dragged and dropped within either column (e.g., 1584) to change the order in which the groups are presented with the flow (e.g., during a walk of a property). Selection of the editing (pen) one of icons 1532 (FIG. 26B) will open a nearly identical input portion 1572 that is pre-populated with whatever options are already associated with the flow for which editing is selected.

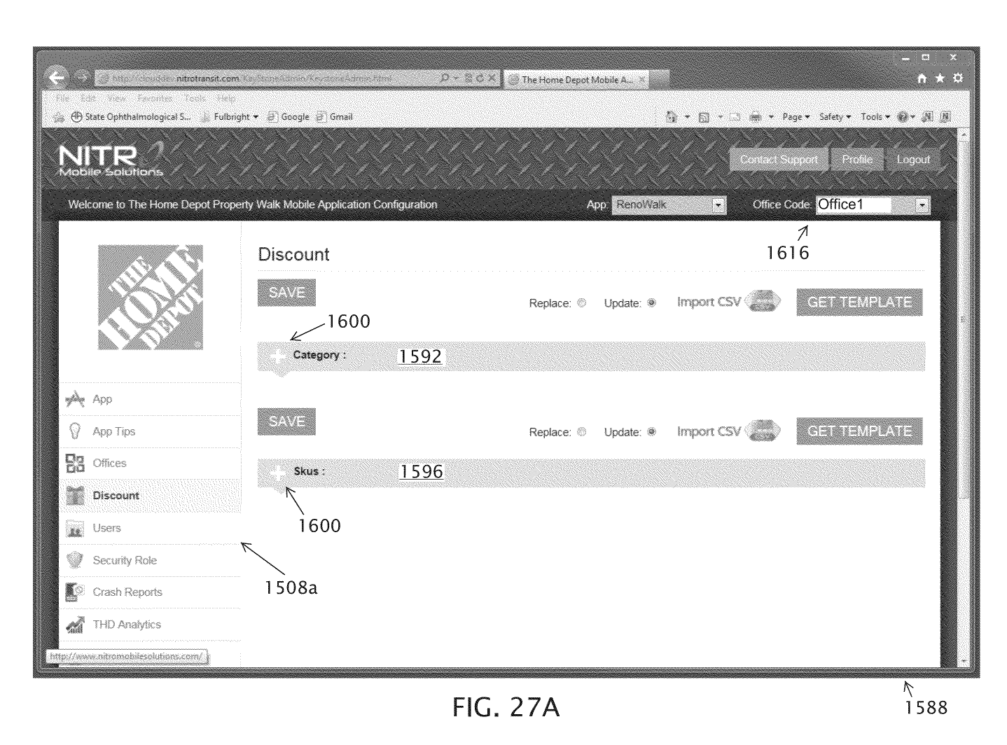

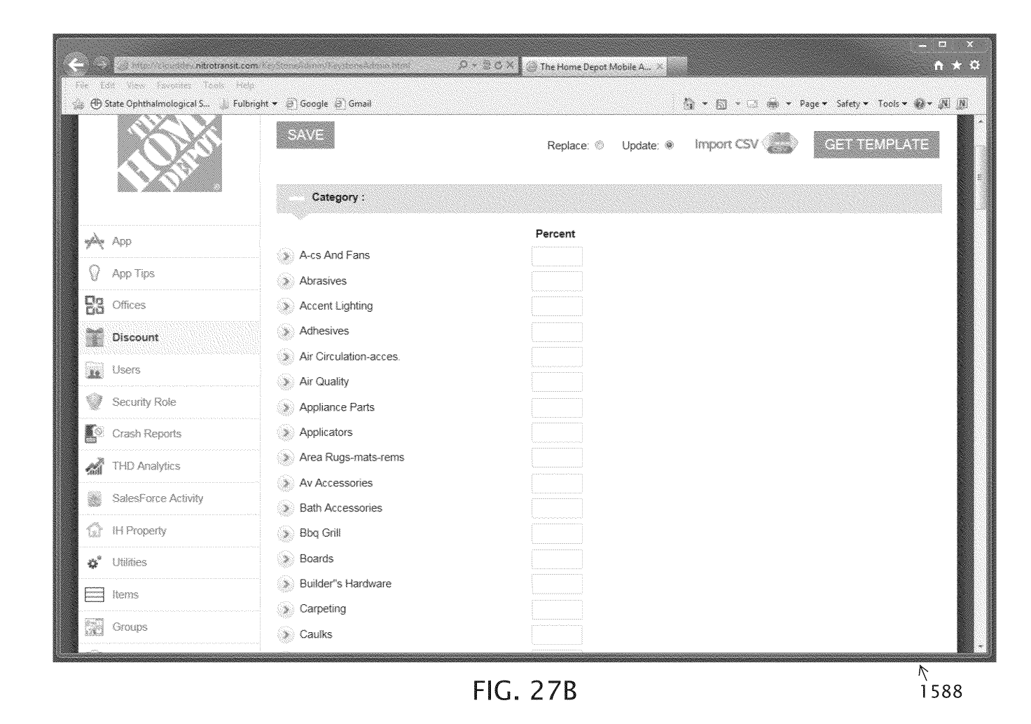

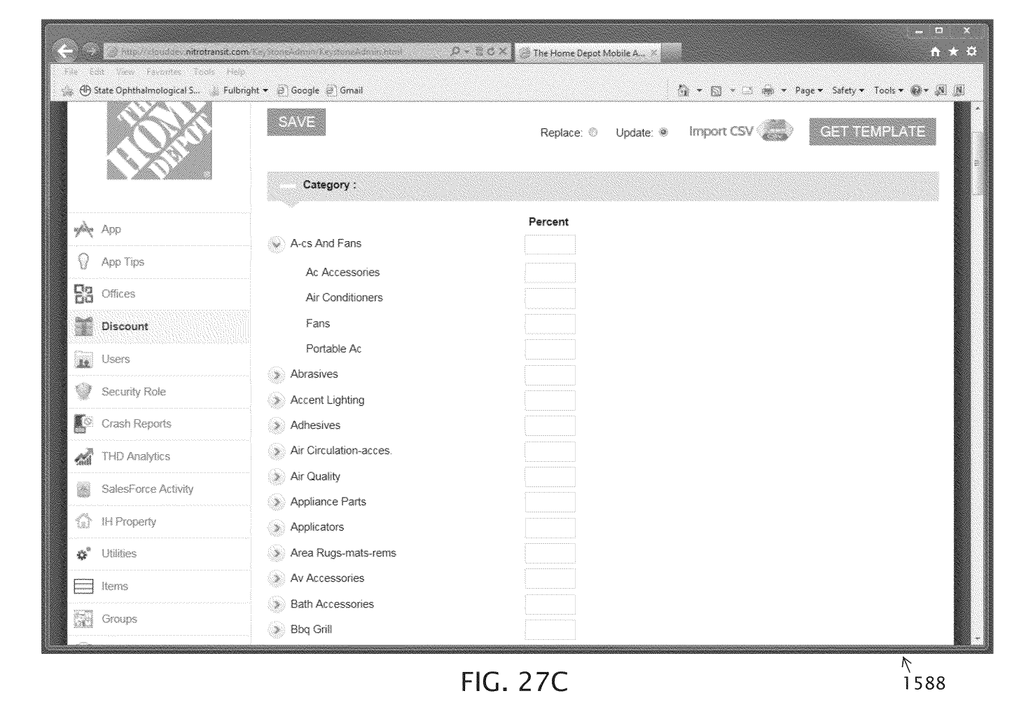

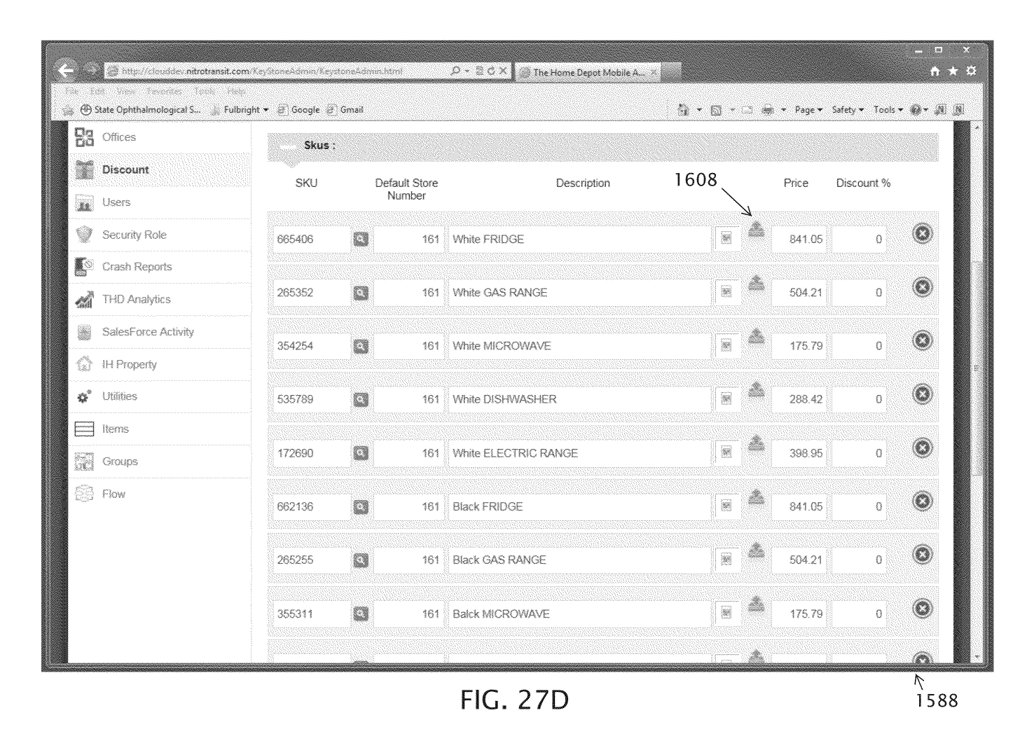

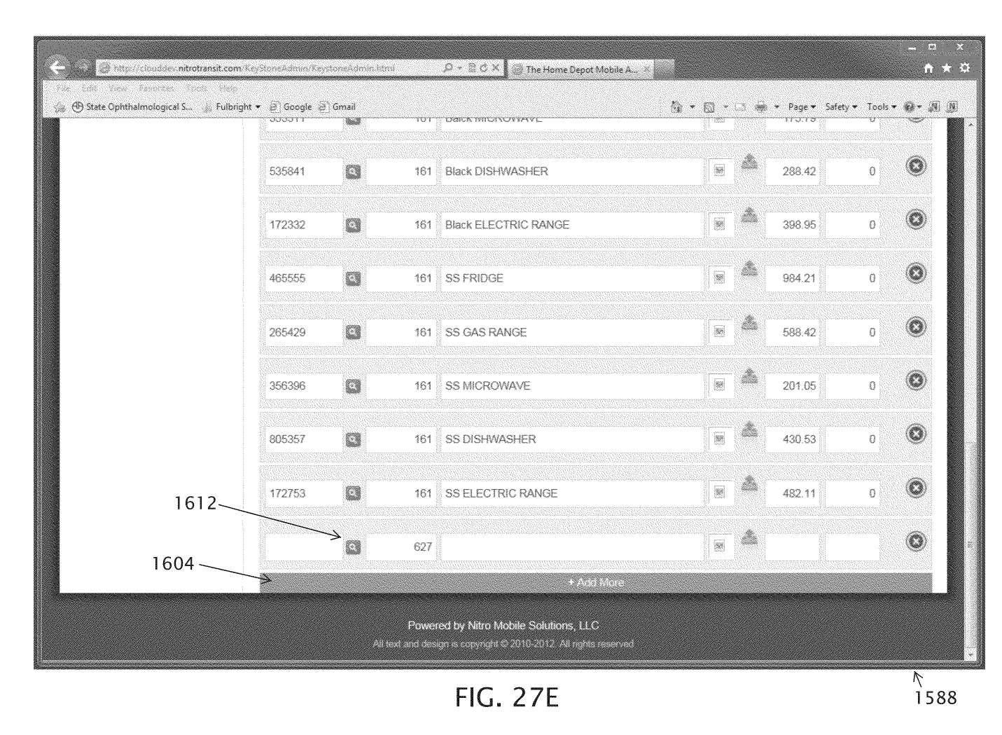

If a user logs into the website of the back-end system as a system administrator, the website can display a webpage that includes a menu 1508a. Selecting “Discount” in menu 1508a directs the web browser to a webpage 1588 as shown in FIGS. 27A-27E. Webpage 1588 Webpage includes two input sections for defining discounts, a first input section 1592 for defining discounts by Group or Item, and a second input section 1596. In the embodiment shown, each input portion includes a “+” icon 1600 that is selectable by a user to expand the respective input portion. For example, a user can select the icon 1600 of the first input portion 1592 to expand the first input portion to display all available Groups, as shown in FIG. 27B, and each Group is then expandable (by selecting the “>” button next to a Group) to show the individual product categories or tasks within each Group, as shown in FIG. 27C. As shown in FIGS. 27B and 27C, a user can then enter a percentage discount for each Group or product category within the Group.

As an alternative to entering group-level discounts in input portion 1592, a user can select the “+” icon (1600) of second input portion 1596 to expand the second input portion and display individual products for which discounts are defined, as shown in FIGS. 27D and 27E, and/or to add individual products for which to define discounts (by selecting “+Add More” button 1604 as shown in FIG. 27E). In the embodiment shown, the individual products can be either selected from stocked products (by entering a SKU corresponding to a product that is typically stocked) or by entering a custom SKU. For example, in FIG. 27D, all of the SKUs are custom SKUs for special-order products that have been individually defined and negotiated prices entered in the Price column (e.g., here, no Discount % is entered because the custom prices are already discounted). For each custom products, a picture of the product can be uploaded by selecting the corresponding upload button 1608. Alternatively, if a new SKU is added by selecting button 1604, a user can select search button 1612 to search for a SKU corresponding to a desired product and, if a stocked product is selected, the Description and Price fields, and a product picture (if available) will be automatically populated. As a further alternative, a user can populate first input portion 1692 and/or second input portion 1696 in bulk fashion by importing a .csv file with the relevant information, as indicated in FIG. 27A. In some embodiments, discounts may be entered globally for all users of the system. In other embodiments, such as the one shown, discounts can be defined for each of a plurality of offices or customers. For example, a user can select a desired office from menu 1616 for which to enter discounts.

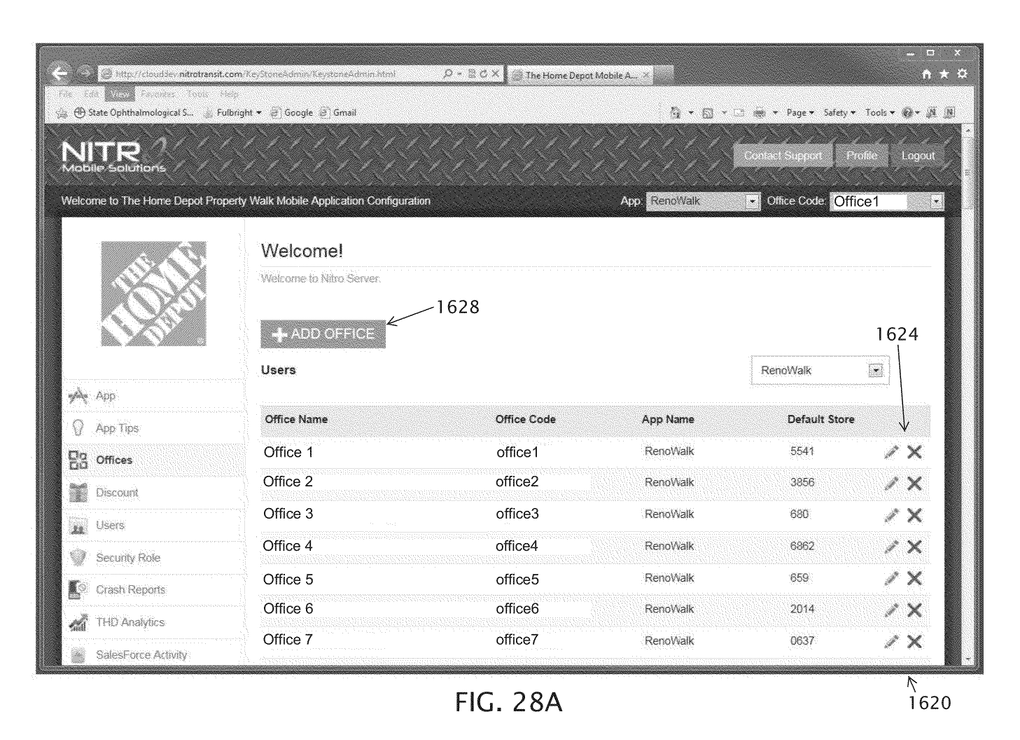

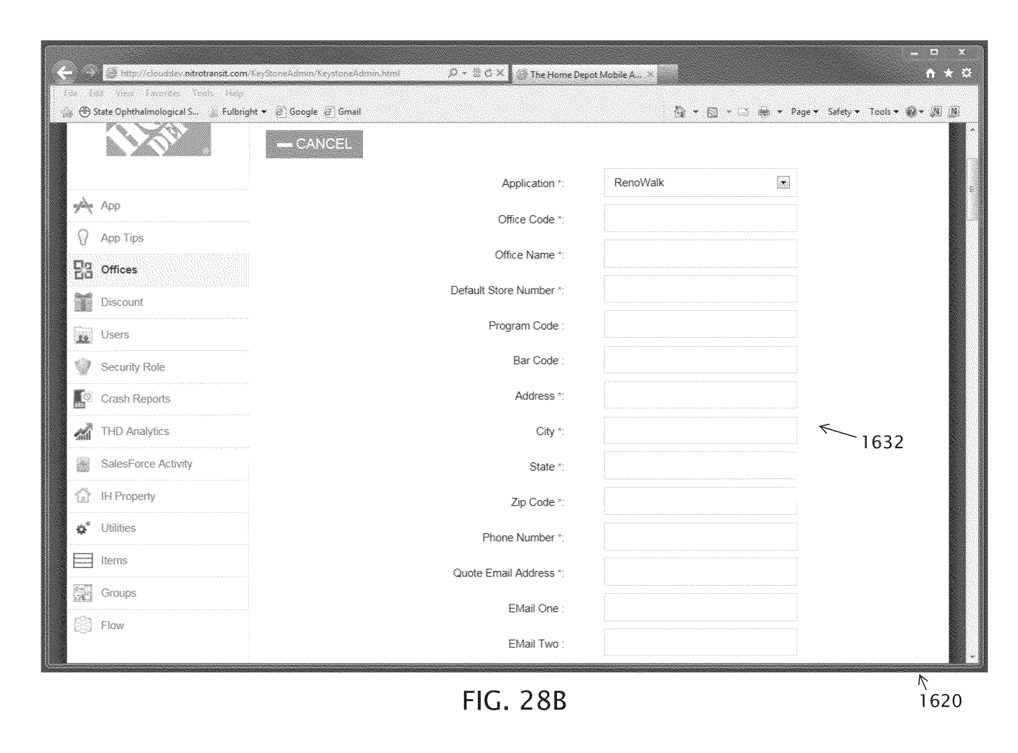

Selecting “Offices” in menu 1508a directs the web browser to a webpage 1620 as shown in FIGS. 28A-28B through which an system-administrator user can define and/or edit offices or customers. Webpage 1620 include a list of offices, if any, that are already defined, with icons 1624 that are selectable by a user to initiate editing (pen icon) or deletion (“X” icon) of the office in the row. Webpage 1620 also includes an “+ADD OFFICE” button 1628 that is selectable to expand an input portion 1632 through which a user can enter information about the new office, as shown in FIG. 28B.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, steps and/or modules may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A portable computing device comprising:
a processor;
an input device;
a display; and
memory storing an end-user application having instructions executable by the processor to:
present via the display an input interface having a plurality of input portions each associated with a different portion of a structure;
receive via the input device user selections of products from among available products that are available from a supplier, at least some of the available products associated with a portion of the structure; and
generate an compilation of information associated with the selected products, the compilation including for each of the selected products a unique identifier corresponding to a product record of the supplier.

2. The device of claim 1, where the instructions of the end-user application are further executable by the processor to:
receive indications of labor costs and/or time associated with at least some of the products.

3. The device of claim 1, where the instructions of the end-user application are further executable by the processor to:
receive indications of labor costs and/or time associated with at least one task that can be performed on a portion of the structure.

4. The device of claim 1, where the instructions of the end-user application are further executable by the processor to:
receive in substantially real-time from a system of the supplier product information about each of the available products.

5. The device of claim 4, where the product information includes for each of the available products two or more of: current availability from a selected location of the supplier, price, description, and/or an image associated with the product.

6. The device of claim 4, where the instructions of the end-user application are further executable by the processor to:
save the product information to the memory such that the processor can access the saved product information in the absence of a data connection to the system of the supplier.

7. The device of claim 1, where the instructions of the end-user application are further executable by the processor to:
receive via the input device a user selection of an input portion; and
present via the display one or more product categories associated with the selected input portion.

8. The device of claim 7, where the instructions of the end-user application are further executable by the processor to:
receive via the input device a user selection of a product category associated with the selected input portion; and
present via the display one or more of the available products that are associated with the selected product category.

9. The device of claim 1, where the instructions of the end-user application are further executable by the processor to:
receive via the input device a list of available products that are available from a single location of the supplier at the time the list is received.

10. The device of claim 9, where the single location of the supplier includes a single location that is selected by a user or that is closest to the location of the structure.

11. The device of claim 1, where the instructions of the end-user application are further executable by the processor to:
transmit the compilation to the supplier.

12. The device of claim 1, further comprising;
a camera coupled to the processor;
where the instructions of the end-user application are further executable by the processor to:
receive a signal from the camera indicative of an image;
present via the display the image; and
present via the display simultaneously with the image one or more lines angled to correspond to possible roof pitches such that a user can identify the line most closely corresponding to the pitch of a roof, if any, depicted in the image.

13. A system comprising:
a device of claim 1; and
a server configured to communicate with the device, the server comprising:
a processor; and
memory storing a back-end application with instructions executable by the processor to:
receive user selections of at least one of:
portions of a structure with which input portions are associated on the device;
available products that can be selected on the device from among the products that are available from a supplier; and/or
indications of labor time and/or costs associated with at least some of the available products that can be selected on the device.

14. The system of claim 13, where the instructions of the back-end application are further executable by the processor to:
receive user selections of at least one of:
associations of product categories with input portions; and/or
associations of available products with product categories.

15. The system of claim 14, where the instructions of the back-end application are further executable by the processor to:
receive user selections of at least one of:
the order in which input portions are presented in the input interface on the device;
the order in which product categories associated with an input portion are presented in the input portion on the device; and/or
the order in which available products associated with a product category are presented in the product category on the device.

16. The system of claim 13, where a first user profile is authorized to modify user selections via the server, and a second user profile is authorized to modify user selections via the device but not via the server.

17. The system of claim 13, where the device is a first device and the system further comprises:
a second device of claim 1;
where user selections received by the server control the end-user applications of the first device and the second device.

18. The system of claim 13, where the instructions of the back-end application are further executable by the processor to:
receive indications of labor costs and/or time associated with at least one task that can be performed on a portion of the structure.

19. The system of claim 13, where the instructions of the back-end application are further executable by the processor to:
receive at least one of:
an indication of a discount associated with a category of products;
an indication of a discount associated with an individual product;
an indication of a custom price associated with an individual product.
